(19) United States
(12) Patent Application Publication
(10) Pub. No.: US 2009/0257338 A1
(43) Pub. Date: Oct. 15, 2009

(54) Optical pickup objective lens, optical pickup apparatus and optical disc apparatus

(75) Inventors: Naofumi Ueda, Ibaraki-shi (JP); Yasuyuki Sugi, Ibaraki-shi (JP); Yutaka Makino, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-Shi (JP)

(21) Appl. No.: 12/382,741

(22) Filed: Mar. 23, 2009

(30) Foreign Application Priority Data
Apr. 10, 2008 (JP) 2008-102882
Aug. 25, 2008 (JP) 2008-215400
Jan. 30, 2009 (JP) 2009-019176

(51) Int. Cl. G11B 7/135; G02B 3/08

(52) U.S. Cl. 369/112.23; 359/742; G9B/7.112

(57) ABSTRACT

A pickup lens has a plurality of ring zones on at least one surface, and steps are formed respectively between the plurality of ring zones. The plurality of steps have step differences causing laser light to have a phase difference to reduce aberration occurring in the pickup lens due to a change in ambient temperature. Further, when a numerical aperture of the pickup lens is NA, a focal length is f (mm) and a working distance is WD (mm), the pickup lens is fabricated to satisfy NA=0.85, 1.1=f=1.8 and WD=0.3.

### BACKGROUND OF THE INVENTION

1. Field of the Invention

The present invention relates to an optical pickup objective lens, an optical pickup apparatus and an optical disc apparatus used for Blu-ray or the like.

2. Description of Related Art

As a material of an objective lens (optical pickup objective lens) used for an optical disc apparatus, glass or plastic is used. An objective lens is manufactured by molding.

The wavelength of laser light changes as the ambient temperature changes. Further, the refractive index of glass and plastic changes as the wavelength of laser light changes. Accordingly, if the ambient temperature changes, the refractive index of the materials changes. Due to a change in the refractive index of the objective lens, the wavefront aberration that occurs in the objective lens increases. FIG. 69 shows examples of the refractive index of the materials, and FIG. 70 shows the rate of change in the refractive index of the materials. Further, the table of FIG. 71 shows the RMS wavefront aberration of a single aspherical lens made of plastic at 20° C., 35° C. and 50° C. In FIG. 71, the focal length is 1.4 mm. As shown in FIG. 71, when the temperature changes by ±15° C. from the design temperature of 35° C., the RMS wavefront aberration increases beyond the Marechal Criterion (70 mλrms).

On the other hand, an increase in the wavefront aberration occurring in the objective lens made of glass due to a change in refractive index is smaller than an increase in the wavefront aberration occurring in the objective lens made of plastic due to a change in refractive index. However, because glass is harder than plastic and has a higher melting point and softening point, the mold manufacturing cost and the molding cost are high. Specifically, because a superhard material is used as a mold of the objective lens made of glass, the manufacturing cost of the mold of the glass objective lens is high. Further, in the molding of the glass objective lens, it is necessary to increase the mold temperature to the melting point and the softening point of glass, and it takes time to make the mold temperature up and down.

Therefore, it is desirable to develop an optical pickup lens made of plastic in which the wavefront aberration that increases with a change in ambient temperature is below the Marechal Criterion.

Heretofore, two methods are widely used as an aberration correction method for an objective lens. One is a method to correct aberration by means of a collimator lens. The other is a method to correct aberration by means of the objective lens itself.

In the case of correcting aberration by means of a collimator lens, a diffraction structure is provided on one surface of the collimator lens. Then, aberration is corrected using diffraction by the diffraction structure.

In the case of correcting aberration by means of the objective lens itself, a plurality of diffraction structures are provided on one surface of the objective lens. Then, aberration is corrected using diffraction by the diffraction structures.

Further, Japanese Unexamined Patent Publication No. 2004-252135 discloses a technique that provides a plurality of diffraction structures on an objective lens, thereby fabricating the objective lens in which the wavefront aberration does not exceed the Marechal Criterion in spite of a change in ambient temperature.

However, in the case of correcting aberration by means of a collimator lens, it is necessary to design a dedicated collimator lens for one objective lens. Therefore, it is necessary to alter the collimator lens when altering the objective lens, thus causing a waste.

Further, in the case of correcting aberration by providing a plurality of diffraction structures on the objective lens, the number of steps on the objective lens increases. If the number of steps increases, the area of the sloping portion between the steps becomes larger. As a result, stray light increases, causing a decrease in the light use efficiency of the objective lens.

Further, the objective lens disclosed in Japanese Unexamined Patent Publication No. 2004-252135 has a short focal length. It thus fails to maintain a sufficient working distance (WD≧0.30 mm).

### SUMMARY OF THE INVENTION

The present invention has been accomplished to solve the above problems and an object of the present invention is thus to provide an optical pickup objective lens, an optical pickup apparatus and an optical disc apparatus capable of maintaining a sufficient working distance and reducing the aberration occurring with a change in ambient temperature.

According to an embodiment of the present invention, there is provided an optical pickup objective lens made of plastic for focusing light beam emitted from a laser light source on a Blu-ray disc (BD). The optical pickup objective lens includes a plurality of ring zones on at least one surface, and a plurality of steps are formed respectively between the plurality of ring zones. Further, the plurality of steps have step differences causing incident light to have a phase difference to reduce aberration occurring in the optical pickup objective lens due to a change in ambient temperature. If a numerical aperture of the optical pickup objective lens is NA, a focal length is f (mm), a working distance is WD (mm) and fifth-order spherical aberration is SA5 (λrms), when focusing light beam emitted from the laser light source on a multilayer optical disc by the optical pickup objective lens, following expressions (1) to (4) are satisfied upon correcting third-order spherical aberration occurring based on a difference in substrate thickness between recording layers of the multilayer optical disc:

NA≧0.85 (1),

1.1≦f≦1.8 (2),

WD≧0.3 (3), and

|SA51≦0.020 (4).

In this embodiment, the pickup lens has a plurality of ring zones on at least one surface, and steps are formed respectively between the plurality of ring zones. Further, the plurality of steps have step differences causing incident light to have a phase difference to reduce aberration occurring in the optical pickup objective lens due to a change in ambient temperature. Thus, when an ambient temperature changes, a phase difference that reduces aberration occurring due to a change in ambient temperature is generated in the light beam having passed through the adjacent ring zones. By the phase difference, the aberration occurring due to a change in ambient temperature is reduced.

When the focal length is shorter than 1.1 mm, it is difficult to maintain a sufficient working distance (WD). Further, when the focal length is longer than 1.8 mm, the aberration occurring due to a change in ambient temperature becomes large, and it is therefore difficult to correct the aberration only by the steps formed on the optical pickup objective lens. Accordingly, by setting the range of the focal length from 1.1 mm to 1.8 mm, it is possible to maintain a sufficient working distance (WD) and sufficiently reduce the aberration occurring due to a change in ambient temperature.

Further, by satisfying the expression (4), it is possible to suitably focus light on the respective recording layers of the multilayer optical disc.

It is further preferred to satisfy the following expression (10):

|SA5|≦0.010 (10).

SA5 is the fifth-order spherical aberration defined by the following expression (11):

$$SA 5 = \frac{A 15}{\sqrt{7}} . \qquad ( 11 )$$

In the expression (11), A15 is a coefficient of Zernike polynomials, and if the beam height is h (mm), A15=20 h⁶−30 h⁴+12 h²−1.

Further, if a tangential angle at a portion where a marginal ray is incident is θ_{M}(°), a lens minimum thickness at a portion where a marginal ray is incident is t_{M}(mm) and a refractive index of the optical pickup objective lens is N, it is preferred to satisfy the following expressions (5) to (7):

73≦θ_{M}≦75 (5)

1.5≦N≦11.55 (6), and

t_{M}≧0.35 (7).

When the tangential angle θ_{M} at the portion on which the marginal ray is incident is smaller than 73°, if the steps are formed on the optical pickup objective lens, the characteristics of the optical pickup objective lens with respect to oblique incidence on the optical pickup objective lens from off the optical axis (which is referred to hereinafter as off-axis characteristics) are deteriorated. Further, if the focal length becomes longer, the deterioration of the off-axis characteristics becomes significant. In other words, when the tangential angle θ_{M} at the portion on which the marginal ray is incident is smaller than 73°, if the steps that correct the deterioration of the wavefront aberration due to a change in ambient temperature are formed on the optical pickup objective lens while maintaining a sufficient working distance, the off-axis characteristics are deteriorated. Further, if the tangential angle θ_{M} is larger than 75°, it is difficult to manufacture the optical pickup objective lens. Therefore, by satisfying 73≦θ_{M}≦75, it is possible to prevent the deterioration of the off-axis characteristics caused by forming the steps on the optical pickup objective lens while maintaining a sufficient working distance and facilitate the manufacture of the optical pickup objective lens. The marginal ray is a light ray that passes through the outermost part within the effective diameter of the optical pickup objective lens.

Further, if the lens minimum thickness t_{M} is thinner than 0.35 mm, the edge thickness of the optical pickup objective lens becomes too thin. This makes it difficult to manufacture the optical pickup objective lens. Therefore, by setting the lens minimum thickness t_{M} to be equal to or thicker than 0.35 mm, it is possible to easily manufacture the optical pickup objective lens.

Furthermore, by satisfying the expressions (5) to (7), it is possible to easily manufacture the pickup objective lens that satisfies the expression (4).

If the plurality of ring zones described above are formed on at least one surface of the optical pickup objective lens, the on-axis characteristics when focusing light on the respective recording layers of the multilayer optical disc are deteriorated. However, by satisfying the expressions (5) to (7), SA5, which is one of the indicators indicating the on-axis characteristics, is not deteriorated even when the third-order spherical aberration that occurs based on a difference in substrate thickness between the recording layers of the multilayer optical disc is corrected in the case of focusing the light beam emitted from the laser light source on the multilayer optical disc using the optical pickup objective lens. It is thereby possible to suppress the deterioration of the on-axis characteristics when focusing light on the respective recording layers of the multilayer optical disc.

Further, if fifth-order coma aberration is COMA5, an absolute value of COMA5 at an angle view of 0.3° is preferably equal to or smaller than 0.025 rms. More preferably, an absolute value of COMA5 at an angle view of 0.3° is equal to or smaller than 0.010λrms. COMA 5 is represented by the following expression (12):

$$COMA 5 = \frac{\sqrt{A {13}^{2} + A {14}^{2}}}{\sqrt{12}} . \qquad ( 12 )$$

In the expression (12), A13 and A14 are coefficients of Zernike polynomials. Specifically, A13=(10 h⁵-12 h³+3 h)cos α, A14=(10 h⁵-12 h³+3 h)sin α. Further, h indicates a beam height (mm).

When the absolute value of COMA5 is larger than 0.025λrms, if the steps that correct the deterioration of the wavefront aberration due to a change in ambient temperature are formed on the optical pickup objective lens while maintaining a sufficient working distance, the off-axis characteristics are deteriorated. Therefore, by setting the absolute value of COMA5 to be equal to or smaller than 0.025λrms, it is possible to prevent the deterioration of the off-axis characteristics caused by forming the steps on the optical pickup objective lens while maintaining a sufficient working distance.

Further, if the number of the ring zones formed on the optical pickup objective lens is n (n is a positive integer satisfying n≧3), it is preferred to form the steps in such a way that a lens thickness of the optical pickup objective lens gradually decreases in a range of the first to the i-th (i=2, 3, . . . , n−1) ring zones from an optical axis of the optical pickup objective lens and a lens thickness of the optical pickup objective lens gradually increases in a range of the (i+1)th (i+1=3, 4, . . . , n) to the n-th ring zones from the optical axis of the optical-pickup objective lens.

In other words, it is preferred to form the steps in such a way that the lens thickness becomes thinner from the optical axis of the optical pickup objective lens to a given radius position and becomes thicker from the given radius position to the outer edge.

Further, it is preferred that an absolute value of an offense against sine condition at all beam heights is equal to or smaller than 0.01. The offense against sine condition (SC) is represented by the following expression (13):

SC=(h/sin θ−f)/f (13).

In the expression (13), h indicates the beam height (mm), θ indicates the angle (tangential angle) between the normal to the optical axis and the tangent to the incidence surface of the optical pickup objective lens, and f indicates the focal length (mm).

If the steps are formed on the optical pickup objective lens when the absolute value of the offense against sine condition (SC) is larger than 0.01, the off-axis characteristics of the optical pickup objective lens are deteriorated. Further, the deterioration of the off-axis characteristics becomes significant if the focal length is longer. In other words, when the absolute value of the offense against sine condition at all beam heights is larger than 0.01, if the steps that correct the deterioration of the wavefront aberration occurring due to a change in ambient temperature are formed on the optical pickup objective lens while maintaining a sufficient working distance, the off-axis characteristics are deteriorated. Therefore, by setting the absolute value of the offense against sine condition at all beam heights to be equal to or smaller than 0.01, it is possible to prevent the deterioration of the off-axis characteristics caused by forming the steps on the optical pickup objective lens while maintaining a sufficient working distance.

Further, a design wavelength of the optical pickup objective lens is preferably equal to or shorter than 500 nm.

Further, the steps preferably have step differences, where a phase of incident light is different between the ring zones at approximately an integral multiple of a wavelength, causing light beam to have a phase difference to reduce aberration occurring in the optical pickup objective lens due to a change in ambient temperature.

In this structure, when an ambient temperature changes, the phase difference that reduces the aberration occurring due to a change in ambient temperature is generated in the light beam.

If an adjacent step difference of the steps is d (mm), a wavelength is λ(mm) and a refractive index of the optical pickup objective lens is N, it is preferred to satisfy the following expression (8):

4≦(N−1)*d/λ≦28 (8).

In other words, the adjacent step difference is preferably from four times to twenty-eight times the wavelength. If the adjacent step difference is smaller than four times the wavelength, it is necessary to increase the number of ring zones formed on the optical pickup objective lens in order to sufficiently correct the aberration. This reduces the light use efficiency. On the other hand, if the adjacent step difference is larger than twenty-eight times the wavelength, the step difference becomes too large, making it difficult to manufacture the optical pickup objective lens. Thus, by forming the steps so as to satisfy the expression (8), it is possible to prevent a decrease in light use efficiency and facilitate the manufacture of the optical pickup objective lens.

It is further preferred to satisfy the following expression (9) if the on-axis step difference of the step of the optical pickup objective lens is d₀ (mm), the wavelength is λ (mm), and the refractive index of the optical pickup objective lens is N:

4≦(N−1)*d₀/λ—14 (9).

In other words, the on-axis step difference is preferably from four times to fourteen times the wavelength. If the on-axis step difference is smaller than four times the wavelength, it is necessary to increase the number of ring zones formed on the optical pickup objective lens in order to sufficiently correct the aberration. This reduces the light use efficiency. On the other hand, if the on-axis step difference is larger than fourteen times the wavelength, the step difference becomes too large, making it difficult to manufacture the optical pickup objective lens. Thus, by forming the steps so as to satisfy the expression (9), it is possible to prevent a decrease in light use efficiency and facilitate the manufacture of the optical pickup objective lens.

Further, if an adjacent step difference of the steps is d (mm), a difference between a maximum value and a minimum value of a cumulative value Σd of the adjacent step difference is preferably equal to or larger than 60λ and equal to or smaller than 180λ.

If a difference between the maximum value and the minimum value of the cumulative value Σd of the adjacent step difference is smaller than 60λ, it is difficult to sufficiently reduce the wavefront aberration occurring due to a change in ambient temperature. On the other hand, if a difference between the maximum value and the minimum value of the cumulative value Σd of the adjacent step difference is larger than 180λ, the wavefront aberration occurring due to a change in ambient temperature is corrected excessively, which results in the degradation of wavefront aberration. Further, the step difference becomes too large, which makes it difficult to manufacture the optical pickup objective lens.

It is more preferred that a difference between the maximum value and the minimum value of the cumulative value Σd of the adjacent step difference is equal to or larger than 70λ and equal to or smaller than 180λ.

It is thereby possible to reduce the wavefront aberration that occurs when the temperature of the optical pickup objective lens itself changes.

Furthermore, if an on-axis step difference of the steps is d₀ (mm), a difference between a maximum value and a minimum value of a cumulative value Σd₀ of the on-axis step difference is preferably equal to or larger than 30λ and equal to or smaller than 120λ.

If a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd₀ of the on-axis step difference is larger than 120λ, the wavefront aberration occurring due to a change in ambient temperature is corrected excessively, which results in the degradation of wavefront aberration. Further, the step difference becomes too large, which makes it difficult to manufacture the optical pickup objective lens.

It is more preferred that a difference between the maximum value and the minimum value of the cumulative value Σd₀ of the on-axis step difference is equal to or larger than 40λ and equal to or smaller than 120λ.

It is thereby possible to reduce the wavefront aberration that occurs when the temperature of the optical pickup objective lens itself changes.

According to another embodiment of the present invention, there is provided an optical pickup objective lens made of plastic for focusing light beam emitted from a laser light source on a Blu-ray disc (BD). The optical pickup objective lens includes a plurality of ring zones on at least one surface, and a plurality of steps are formed respectively between the plurality of ring zones. Further, the plurality of steps have step differences causing incident light to have a phase difference to reduce aberration occurring in the optical pickup objective lens due to a change in ambient temperature. If a numerical aperture of the optical pickup objective lens is NA and a focal length is f (mm), following expressions (1) to (3) are satisfied:

NA≧0.85 (1)

1.1≦f≦1.8 (2) and

WD≧0.3 (3).

In this embodiment, the pickup lens has a plurality of ring zones on at least one surface, and steps are formed respectively between the plurality of ring zones. Further, the plurality of steps have step differences causing incident light to have a phase difference to reduce aberration occurring in the optical pickup objective lens due to a change in ambient temperature. Thus, when an ambient temperature changes, a phase difference that reduces aberration occurring due to a change in ambient temperature is generated in the light beam having passed through the adjacent ring zones. By the phase difference, the aberration occurring due to a change in ambient temperature is reduced.

When the focal length is shorter than 1.1 mm, it is difficult to maintain a sufficient working distance (WD). Further, when the focal length is longer than 1.8 mm, the aberration occurring due to a change in ambient temperature becomes large, and it is therefore difficult to correct the aberration only by the steps formed on the optical pickup objective lens. Accordingly, by setting the range of the focal length from 1.1 mm to 1.8 mm, it is possible to maintain a sufficient working distance (WD) and sufficiently reduce the aberration occurring due to a change in ambient temperature.

Further, a design wavelength of the optical pickup objective lens is preferably equal to or shorter than 500 nm.

Furthermore, the steps preferably have step differences, where a phase of incident light is different between the ring zones at approximately an integral multiple of a wavelength, causing light beam to have a phase difference to reduce aberration occurring in the optical pickup objective lens due to a change in ambient temperature.

In this structure, when an ambient temperature changes, the phase difference that reduces the aberration occurring due to a change in ambient temperature is generated in the light beam.

Further, if an adjacent step difference of the steps is d (mm), a wavelength is λ (mm) and a refractive index of the optical pickup objective lens is N, it is preferred to satisfy the following expression (8):

4≦(N−1)*d/λ≦28 (8).

In other words, the adjacent step difference is preferably from four times to twenty-eight times the wavelength. If the adjacent step difference is smaller than four times the wavelength, it is necessary to increase the number of ring zones formed on the optical pickup objective lens in order to sufficiently correct the aberration. This reduces the light use efficiency. On the other hand, if the adjacent step difference is larger than twenty-eight times the wavelength, the step difference becomes too large, making it difficult to manufacture the optical pickup objective lens. Thus, by forming the steps so as to satisfy the expression (8), it is possible to prevent a decrease in light use efficiency and facilitate the manufacture of the optical pickup objective lens.

It is further preferred to satisfy the following expression (9) if the on-axis step difference of the step of the optical pickup objective lens is d₀ (mm), the wavelength is λ (mm), and the refractive index of the optical pickup objective lens is N:

4≦(N−1)*d₀/λ≦14 (9).

In other words, the on-axis step difference is preferably from four times to fourteen times the wavelength. If the on-axis step difference is smaller than four times the wavelength, it is necessary to increase the number of ring zones formed on the optical pickup objective lens in order to sufficiently correct the aberration. This reduces the light use efficiency. On the other hand, if the on-axis step difference is larger than fourteen times the wavelength, the step difference becomes too large, making it difficult to manufacture the optical pickup objective lens. Thus, by forming the steps so as to satisfy the expression (9), it is possible to prevent a decrease in light use efficiency and facilitate the manufacture of the optical pickup objective lens.

Further, if the number of the ring zones formed on the optical pickup objective lens is n (n is a positive integer), when n is an even number, the steps are preferably formed in such a way that a lens thickness of the optical pickup objective lens gradually decreases in a range of the 1st to the (n/2)th ring zones from an optical axis of the optical pickup objective lens and a lens thickness of the optical pickup objective lens gradually increases in a range of the ((n/2)+1)th to the n-th ring zones from the optical axis of the optical pickup objective lens, and when n is an odd number, the steps are preferably formed in such a way that a lens thickness of the optical pickup objective lens gradually decreases in a range of the 1st to the ((n+1)/2)th ring zones from the optical axis of the optical pickup objective lens and a lens thickness of the optical pickup objective lens gradually increases in a range of the ((n+1)/2)th to the n-th ring zones from the optical axis of the optical pickup objective lens.

In other words, the steps are formed in such a way that the lens thickness becomes thinner from the optical axis of the optical pickup objective lens to a given radius position and becomes thicker from the given radius position to the outer edge. By forming the steps on the optical pickup objective lens, the off-axis characteristics of the optical pickup objective lens are deteriorated. Further, the deterioration of the off-axis characteristics becomes significant if the focal length is longer. However, by forming the steps in such a way that the lens thickness of the optical pickup objective lens is the thinnest at the given radius position, it is possible to suppress the RMS wavefront aberration at off-axis of the optical pickup objective lens to be equal to or smaller than 0.035λ.

Further, by forming the steps in such a way that the lens thickness of the optical pickup objective lens is the thinnest at the given radius position, it is possible to maintain a sufficient working distance and prevent the deterioration of the off-axis characteristics caused by forming the steps that correct the aberration due to a change in ambient temperature on the optical pickup objective lens without satisfying the conditions of the expressions (5) to (7).

Furthermore, by forming the steps in such a way that the lens thickness of the optical pickup objective lens is the thinnest at the given radius position, it is possible to reduce a difference between the maximum value and the minimum value of the cumulative value Σd of the adjacent step difference and a difference between the maximum value and the minimum value of the cumulative value Σd₀ of the on-axis step difference. This further facilitates the manufacture of the optical pickup objective lens.

Further, if an adjacent step difference of the steps is d (mm), a difference between a maximum value and a minimum value of a cumulative value Σd of the adjacent step difference is preferably equal to or larger than 60λ and equal to or smaller than 90λ.

If a difference between the maximum value and the minimum value of the cumulative value Σd of the adjacent step difference is smaller than 60λ, it is difficult to sufficiently reduce the wavefront aberration occurring due to a change in ambient temperature. On the other hand, if a difference between the maximum value and the minimum value of the cumulative value Σd of the adjacent step difference is larger than 90λ, the wavefront aberration occurring due to a change in ambient temperature is corrected excessively, which results in the degradation of wavefront aberration. Further, the step difference becomes too large, which makes it difficult to manufacture the optical pickup objective lens.

It is more preferred that a difference between the maximum value and the minimum value of the cumulative value Σd of the adjacent step difference is equal to or larger than 70λ and equal to or smaller than 90λ.

It is thereby possible to reduce the wavefront aberration that occurs when the temperature of the optical pickup objective lens itself changes.

Further, if an on-axis step difference of the steps is d₀ (mm), a difference between a maximum value and a minimum value of a cumulative value Σd₀ of the on-axis step difference is preferably equal to or larger than 30λ and equal to or smaller than 60λ.

If a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd₀ of the on-axis step difference is larger than 60λ, the wavefront aberration occurring due to a change in ambient temperature is corrected excessively, which results in the degradation of wavefront aberration. Further, the step difference becomes too large, which makes it difficult to manufacture the optical pickup objective lens.

It is more preferred that a difference between the maximum value and the minimum value of the cumulative value sd₀ of the on-axis step difference is equal to or larger than 40λ and equal to or smaller than 60λ.

It is thereby possible to reduce the wavefront aberration that occurs when the temperature of the optical pickup objective lens itself changes.

According to the embodiments of the present invention described above, it is possible to maintain a sufficient working distance and reduce the aberration occurring with a change in ambient temperature.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a view showing an example of an optical pickup system according to an embodiment of the present invention;

FIG. 2A is a view showing the wavefront (phase) of laser light passing through a pickup lens according to the embodiment at a design wavelength and a design temperature;

FIG. 2B is a view showing the wavefront (phase) of laser light passing through the pickup lens according to the embodiment when the ambient temperature is lower than the design temperature and the wavelength of the laser light is shorter than the design wavelength;

FIG. 2C is a view showing the wavefront (phase) of laser light passing through the pickup lens according to the embodiment when the ambient temperature is higher than the design temperature and the wavelength of the laser light is longer than the design wavelength;

FIG. 3A is a view showing the wavefront aberration occurring in a pickup lens without ring zones when the ambient temperature is 20° C.;

FIG. 3B is a view showing wavefront aberration occurring in the pickup lens according to the embodiment when the ambient temperature is 20° C.;

FIG. 4A is a view showing wavefront aberration occurring in a pickup lens without ring zones when the ambient temperature is 50° C.;

FIG. 4B is a view showing wavefront aberration occurring in the pickup lens according to the embodiment when the ambient temperature is 50° C.;

FIG. 5 is a side view schematically showing the pickup lens according to the embodiment;

FIG. 6 is a side view schematically showing the pickup lens according to the embodiment;

FIG. 7 is a side view showing an example of the lens surface shape of the pickup lens according to the embodiment;

FIG. 8 is a table showing numbers of ring zones, positions of ring zones, on-axis step differences and adjacent step differences of a pickup lens according to an example 1;

FIG. 9 is a table showing numbers of ring zones, positions of ring zones, cumulative values of on-axis step differences and cumulative values of adjacent step differences of the pickup lens according to the example 1;

FIG. 10 is a table showing data of an optical pickup system according to the example 1;

FIG. 11 is a table showing coefficients specifying the shape of a surface (plane number 3) on the optical disc side of the pickup lens according to the example 1;

FIG. 12 is a table showing coefficients specifying the shape of a surface (plane number 2) on the light source side of the pickup lens according to the example 1;

FIG. 13 is a side view showing an example of the shape of the lens surface of a pickup lens;

FIG. 14 is a table showing numbers of ring zones, positions of ring zones, on-axis step differences and adjacent step differences of a pickup lens according to an example 2;

FIG. 15 is a table showing numbers of ring zones, positions of ring zones, cumulative values of on-axis step differences and cumulative values of adjacent step differences of the pickup lens according to the example 2;

FIG. 16 is a table showing data of an optical pickup system according to the example 2;

FIG. 17 is a table showing coefficients specifying the shape of a surface (plane number 3) on the optical disc side of the pickup lens according to the example 2;

FIG. 18 is a table showing coefficients specifying the shape of a surface (plane number 2) on the light source side of the pickup lens according to the example 2;

FIG. 19 is a table showing numbers of ring zones, positions of ring zones, on-axis step differences and adjacent step differences of a pickup lens according to an example 3;

FIG. 20 is a table showing numbers of ring zones, positions of ring zones, cumulative values of on-axis step differences and cumulative values of adjacent step differences of the pickup lens according to the example 3;

FIG. 21 is a table showing data of an optical pickup system according to the example 3;

FIG. 22 is a table showing coefficients specifying the shape of a surface (plane number 3) on the optical disc side of the pickup lens according to the example 3;

FIG. 23 is a table showing coefficients specifying the shape of a surface (plane number 2) on the light source side of the pickup lens according to the example 3;

FIG. 24 is a table showing numbers of ring zones, positions of ring zones, on-axis step differences and adjacent step differences of a pickup lens according to an example 4;

FIG. 25 is a table showing numbers of ring zones, positions of ring zones, cumulative values of on-axis step differences and cumulative values of adjacent step differences of the pickup lens according to the example 4;

FIG. 26 is a table showing data of an optical pickup system according to the example 4;

FIG. 27 is a table showing coefficients specifying the shape of a surface (plane number 3) on the optical disc side of the pickup lens according to the example 4;

FIG. 28 is a table showing coefficients specifying the shape of a surface (plane number 2) on the light source side of the pickup lens according to the example 4;

FIG. 29 is a table showing numbers of ring zones, positions of ring zones, on-axis step differences and adjacent step differences of a pickup lens according to an example 5;

FIG. 30 is a table showing numbers of ring zones, positions of ring zones, cumulative values of on-axis step differences and cumulative values of adjacent step differences of the pickup lens according to the example 5;

FIG. 31 is a table showing data of an optical pickup system according to the example 5;

FIG. 32 is a table showing coefficients specifying the shape of a surface (plane number 3) on the optical disc side of the pickup lens according to the example 5;

FIG. 33 is a table showing coefficients specifying the shape of a surface (plane number 2) on the light source side of the pickup lens according to the example 5;

FIG. 34 is a table showing numbers of ring zones, positions of ring zones, on-axis step differences and adjacent step differences of a pickup lens according to an example 6;

FIG. 35 is a table showing numbers of ring zones, positions of ring zones, cumulative values of on-axis step differences and cumulative values of adjacent step differences of the pickup lens according to the example 6;

FIG. 36 is a table showing data of an optical pickup system according to the example 6;

FIG. 37 is a table showing coefficients specifying the shape of a surface (plane number 3) on the optical disc side of the pickup lens according to the example 6;

FIG. 38 is a table showing coefficients specifying the shape of a surface (plane number 2) on the light source side of the pickup lens according to the example 6;

FIG. 39 is a table showing data of an optical pickup system according to a comparative example 1;

FIG. 40 is a table showing coefficients specifying the shapes of a surface (plane number 2) on the light source side and a surface (plane number 3) on the optical disc side of a pickup lens according to a comparative example 1;

FIG. 41A is a graph showing wavefront aberration occurring at an ambient temperature of 20° C. with use of the pickup lens according to the comparative example 1;

FIG. 41B is a graph showing wavefront aberration occurring at an ambient temperature of 35° C. with use of the pickup lens according to the comparative example 1;

FIG. 41C is a graph showing wavefront aberration occurring at an ambient temperature of 50° C. with use of the pickup lens according to the comparative example 1;

FIG. 42A is a graph showing wavefront aberration occurring at an ambient temperature of 20° C. with use of the pickup lens according to the example 1;

FIG. 42B is a graph showing wavefront aberration occurring at an ambient temperature of 35° C. with use of the pickup lens according to the example 1;

FIG. 42C is a graph showing wavefront aberration occurring at an ambient temperature of 50° C. with use of the pickup lens according to the example 1;

FIG. 43A is a graph showing wavefront aberration occurring at an ambient temperature of 20° C. with use of the pickup lens according to the example 2;

FIG. 43B is a graph showing wavefront aberration occurring at an ambient temperature of 35° C. with use of the pickup lens according to the example 2;

FIG. 43C is a graph showing wavefront aberration occurring at an ambient temperature of 50° C. with use of the pickup lens according to the example 2;

FIG. 44A is a graph showing wavefront aberration occurring at an ambient temperature of 20° C. with use of the pickup lens according to the example 3;

FIG. 44B is a graph showing wavefront aberration occurring at an ambient temperature of 35° C. with use of the pickup lens according to the example 3;

FIG. 44C is a graph showing wavefront aberration occurring at an ambient temperature of 50° C. with use of the pickup lens according to the example 3;

FIG. 45A is a graph showing wavefront aberration occurring at an ambient temperature of 20° C. with use of the pickup lens according to the example 4;

FIG. 45B is a graph showing wavefront aberration occurring at an ambient temperature of 35° C. with use of the pickup lens according to the example 4;

FIG. 45C is a graph showing wavefront aberration occurring at an ambient temperature of 50° C. with use of the pickup lens according to the example 4;

FIG. 46A is a graph showing wavefront aberration occurring at an ambient temperature of 20° C. with use of the pickup lens according to the example 5;

FIG. 46B is a graph showing wavefront aberration occurring at an ambient temperature of 35° C. with use of the pickup lens according to the example 5;

FIG. 46C is a graph showing wavefront aberration occurring at an ambient temperature of 50° C. with use of the pickup lens according to the example 5;

FIG. 47A is a graph showing wavefront aberration occurring at an ambient temperature of 20° C. with use of the pickup lens according to the example 6;

FIG. 47B is a graph showing wavefront aberration occurring at an ambient temperature of 35° C. with use of the pickup lens according to the example 6;

FIG. 47C is a graph showing wavefront aberration occurring at an ambient temperature of 50° C. with use of the pickup lens according to the example 6;

FIG. 48 is a table showing a tangential angle θ_{M}, a minimum thickness tₘ, aberration items in the range of the angle of view of 0°, and aberration items in the range of the angle of view of 0.3° in the pickup lenses according to the examples 1 to 6;

FIG. 49A is a graph showing wavefront aberration in the range of the angle of view of 0° of the pickup lens according to the example 1;

FIG. 49B is a graph showing wavefront aberration in the range of the angle of view of 0.3° of the pickup lens according to the example 1;

FIG. 50A is a graph showing wavefront aberration in the range of the angle of view of 0° of the pickup lens according to the example 2;

FIG. 50B is a graph showing wavefront aberration in the range of the angle of view of 0.3° of the pickup lens according to the example 2;

FIG. 51A is a graph showing wavefront aberration in the range of the angle of view of 0° of the pickup lens according to the example 3;

FIG. 51B is a graph showing wavefront aberration in the range of the angle of view of 0.3° of the pickup lens according to the example 3;

FIG. 52A is a graph showing wavefront aberration in the range of the angle of view of 0° of the pickup lens according to the example 4;

FIG. 52B is a graph showing wavefront aberration in the range of the angle of view of 0.3° of the pickup lens according to the example 4;

FIG. 53A is a graph showing wavefront aberration in the range of the angle of view of 0° of the pickup lens according to the example 5;

FIG. 53B is a graph showing wavefront aberration in the range of the angle of view of 0.3° of the pickup lens according to the example 5;

FIG. 54A is a graph showing wavefront aberration in the range of the angle of view of 0° of the pickup lens according to the example 6;

FIG. 54B is a graph showing wavefront aberration in the range of the angle of view of 0.3° of the pickup lens according to the example 6;

FIG. 55 is a table showing the offense against sine condition of the pickup lenses according to the examples 1 to 6;

FIG. 56 is a graph showing the offense against sine condition of the pickup lens according to the example 1;

FIG. 57 is a graph showing the offense against sine condition of the pickup lens according to the example 2;

FIG. 58 is a graph showing the offense against sine condition of the pickup lens according to the example 3;

FIG. 59 is a graph showing the offense against sine condition of the pickup lens according to the example 4;

FIG. 60 is a graph showing the offense against sine condition of the pickup lens according to the example 5;

FIG. 61 is a graph showing the offense against sine condition of the pickup lens according to the example 6;

FIG. 62A is a graph showing wavefront aberration when focusing laser light on the position with a transparent substrate thickness of 0.075 mm by the pickup lens according to the example 1;

FIG. 62B is a graph showing wavefront aberration when focusing laser light on the position with a transparent substrate thickness of 0.0875 mm by the pickup lens according to the example 1;

FIG. 62C is a graph showing wavefront aberration when focusing laser light on the position with a transparent substrate thickness of 0.100 mm by the pickup lens according to the example 1;

FIG. 63A is a graph showing wavefront aberration when focusing laser light on the position with a transparent substrate thickness of 0.075 mm by the pickup lens according to the example 2;

FIG. 63B is a graph showing wavefront aberration when focusing laser light on the position with a transparent substrate thickness of 0.0875 mm by the pickup lens according to the example 2;

FIG. 63C is a graph showing wavefront aberration when focusing laser light on the position with a transparent substrate thickness of 0.100 mm by the pickup lens according to the example 2;

FIG. 64A is a graph showing wavefront aberration when focusing laser light on the position with a transparent substrate thickness of 0.075 mm by the pickup lens according to the example 3;

FIG. 64B is a graph showing wavefront aberration when focusing laser light on the position with a transparent substrate thickness of 0.0875 mm by the pickup lens according to the example 3;

FIG. 64C is a graph showing wavefront aberration when focusing laser light on the position with a transparent substrate thickness of 0.100 mm by the pickup lens according to the example 3;

FIG. 65A is a graph showing wavefront aberration when focusing laser light on the position with a transparent substrate thickness of 0.075 mm by the pickup lens according to the example 4;

FIG. 65B is a graph showing wavefront aberration when focusing laser light on the position with a transparent substrate thickness of 0.0875 mm by the pickup lens according to the example 4;

FIG. 65C is a graph showing wavefront aberration when focusing laser light on the position with a transparent substrate thickness of 0.100 mm by the pickup lens according to the example 4;

FIG. 66A is a graph showing wavefront aberration when focusing laser light on the position with a transparent substrate thickness of 0.075 mm by the pickup lens according to the example 5;

FIG. 66B is a graph showing wavefront aberration when focusing laser light on the position with a transparent substrate thickness of 0.0875 mm by the pickup lens according to the example 5;

FIG. 66C is a graph showing wavefront aberration when focusing laser light on the position with a transparent substrate thickness of 0.100 mm by the pickup lens according to the example 5;

FIG. 67A is a graph showing wavefront aberration when focusing laser light on the position with a transparent substrate thickness of 0.075 mm by the pickup lens according to the example 6;

FIG. 67B is a graph showing wavefront aberration when focusing laser light on the position with a transparent substrate thickness of 0.0875 mm by the pickup lens according to the example 6;

FIG. 67C is a graph showing wavefront aberration when focusing laser light on the position with a transparent substrate thickness of 0.100 mm by the pickup lens according to the example 6;

FIG. 68A is a graph showing wavefront aberration when focusing laser light on the position with a transparent substrate thickness of 0.075 mm by the pickup lens according to the comparative example 1;

FIG. 68B is a graph showing wavefront aberration when focusing laser light on the position with a transparent substrate thickness of 0.0875 mm by the pickup lens according to the comparative example 1;

FIG. 68C is a graph showing wavefront aberration when focusing laser light on the position with a transparent substrate thickness of 0.100 mm by the pickup lens according to the comparative example 1;

FIG. 69 is a table showing the refractive index of materials;

FIG. 70 is a table showing the rate of change in the refractive index of materials; and

FIG. 71 is a table showing RMS wavefront aberration of a single aspherical lens made of plastic at 20° C., 35° C. and 50° C.

### DESCRIPTION OF THE PREFERRED EMBODIMENTS

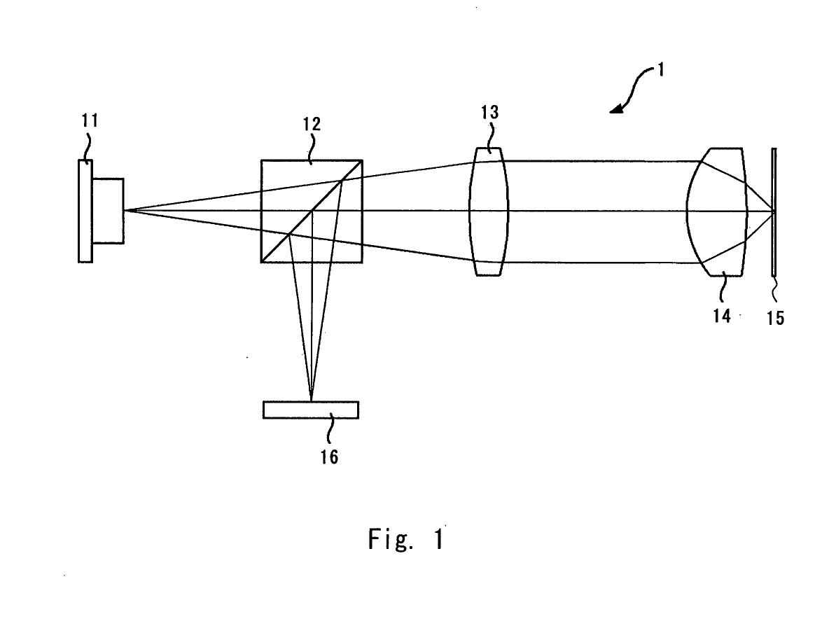

An exemplary embodiment of the present invention is described hereinafter in detail with reference to the drawings. The present invention is not limited to the embodiment below. FIG. 1 shows an example of an optical pickup system 1 according to an embodiment of the present invention. The optical pickup system 1 according to the embodiment is used for an optical pickup apparatus or an optical disc apparatus according to an embodiment of the present invention. The optical pickup system 1 includes a light source 11 (laser light source), a beam splitter 12, a collimator lens 13, a pickup lens 14 (optical pickup objective lens), a detection system 16 and so on. In this embodiment, a Blu-ray disc (BD) is used as an optical disc 15.

The light source 11 includes a blue laser diode or the like that is used for BD.

The beam splitter 12 is placed on the optical path of laser light (light beam) emitted from the light source 11.

The collimator lens 13 is placed on the optical path of the laser light output from the beam splitter 12. The collimator lens 13 adjusts the degree of divergence of the laser light output from the beam splitter 12 and outputs the laser light.

The pickup lens 14 is placed on the optical path of the laser light having passed through the collimator lens 13.

The pickup lens 14 has a function to focus the incident light on an information recording surface of the optical disc (BD) 15. Two types of BD are known: a single-layer BD having a single recording layer and a multilayer BD having a plurality of recording layers. The transparent substrate thickness of the single-layer BD is 0.100 mm. The transparent substrate thickness of each recording layer of a double-layer BD having two recording layers is 0.075 mm and 0.100 mm, respectively. When the pickup lens 14 focuses laser light on the recording layer of the double-layer BD, the spherical aberration of as large as about 0.25λrms occurs due to a difference in substrate thickness, 0.025 mm, between the recording layers. The spherical aberration is corrected generally by shifting the collimator lens 13 along the optical axis to thereby adjust the degree of divergence of the light beam to be incident on the pickup lens 14. The correction by shifting the collimator lens 13 along the optical axis means adjusting the degree of divergence of the laser light to be incident on the pickup lens 14. This is equivalent to adjust a virtual light-emitting position (the position of an object point) of the laser light to be incident on the pickup lens 14 so that the laser light is input to the pickup lens 14 from the virtual light-emitting position without passing through the collimator lens 13. In other words, the spherical aberration is corrected by adjusting the object distance of the pickup lens 14.

The pickup lens 14 according to the embodiment of the present invention is designed to suitably focus light at 0.0875 mm, which is an intermediate thickness between the transparent substrate thicknesses of the recording layers of the double-layer BD. It is thereby possible to reduce the spherical aberration that occurs due to a difference in substrate thickness between the recording layers.

In the embodiment of the present invention, the transparent substrate of the optical disc is made of polycarbonate (PC).

The pickup lens 14 further has a function to guide the laser light reflected by the information recording surface of the optical disc 15 to the detection system 16.

On at least one surface of the pickup lens 14, a plurality of ring zones arranged concentrically about the optical axis of the pickup lens 14 are formed. Further, a step is formed between the respective adjacent ring zones. In other words, at least one surface of the pickup lens 14 is divided into a plurality of ring zones concentrically about the optical axis of the pickup lens 14 by a plurality of steps. The pickup lens 14 is made of a plastic material.

As described later, the step differences of a plurality of steps formed on the pickup lens 14 are designed in such a way that the phase of laser light which is incident at the design wavelength and the design temperature (when the wavelength of the laser light is the design wavelength and the ambient temperature is the design temperature) is different between the adjacent ring zones by approximately an integral multiple of the wavelength.

Further, each of the plurality of steps formed on the pickup lens 14 has a step difference that causes the laser light to have a phase difference so as to reduce the aberration occurring due to a change in ambient temperature.

Approximately an integral multiple of the wavelength is preferably from (integer)*0.999 of the wavelength to (integer)*1.001 of the wavelength. For example, in this embodiment, approximately ten times the wavelength means 9.99 to 10.01 times the wavelength since 10*0.999=9.99 and 10*1.001=10.01. Approximately an integral multiple of the wavelength may be from (integer)*0.995 of the wavelength to (integer)*1.005 of the wavelength. In this case also, it is possible to sufficiently reduce the wavefront aberration that occurs when the ambient temperature changes by the steps formed on the pickup lens 14.

During focus servo or tracking servo, the pickup lens 14 is operated by an actuator, which is not shown.

Next, the behavior of the laser light which is emitted from the light source 11, reflected by the information recording surface of the optical disc 15 and detected by the detection system 16 is described hereinafter. The laser light emitted from the light source 11 passes through the beam splitter 12 and enters the collimator lens 13.

The collimator lens 13 adjusts the degree of divergence of the laser light output from the beam splitter 12 and outputs the adjusted laser light.

The laser light having passed through the collimator lens 13 is incident on the pickup lens 14. In this embodiment, when the ambient temperature changes, the plurality of steps formed on the pickup lens 14 correct the phase of the laser light so as to reduce aberration that occurs by the change in ambient temperature. Then, the pickup lens 14 focuses the corrected laser light on the information recording surface of the optical disc 15. The laser light reflected by the information recording surface of the optical disc 15 is input to the detection system 16 through the pickup lens 14 and detected. The detection system 16 detects the laser light and photoelectrically converts it, thereby generating a focus servo signal, a tracking servo signal, a reproduction signal and so on.

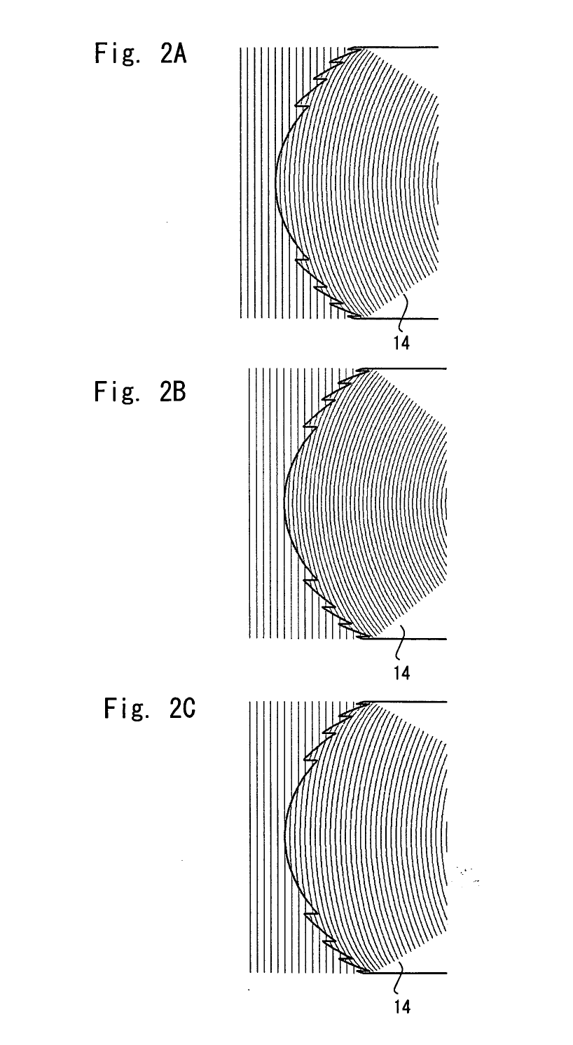

Hereinafter, the pickup lens 14 that is used in the optical pickup system 1 according to the embodiment of the present invention is described in detail. FIG. 2 is a view showing the pickup lens 14 in the optical pickup system 1 according to the embodiment. FIG. 2A shows the wavefront (phase) of laser light at a design wavelength and a design temperature, FIG. 2B shows the wavefront (phase) of laser light when the ambient temperature is lower than the design temperature and the wavelength of the laser light is shorter than the design wavelength, and FIG. 2C shows the wavefront (phase) of laser light when the ambient temperature is higher than the design temperature and the wavelength of the laser light is longer than the design wavelength. In this embodiment, the above-described plurality of steps are formed on the surface of the pickup lens 14 facing the light source 11. The step differences of the plurality of steps are designed in such a way that the phase of the laser light passed therethrough is different between the adjacent ring zones by approximately an integral multiple of the wavelength. Further, each step of the pickup lens 14 has a step difference that causes the laser light to have a phase difference so as to reduce the aberration occurring due to a change in ambient temperature.

Specifically, when the laser light is incident on the pickup lens 14 at the design wavelength and the design temperature, the phase of the laser light having passed through the respective ring zones is different from one another by approximately an integral multiple of the wavelength. Thus, at the design wavelength and the design temperature, a phase difference is not generated between the laser light having passed through different ring zones as shown in FIG. 2A. Therefore, the laser light input to the pickup lens 14 is output with the same phase. Accordingly, at the design wavelength and the design temperature, the aberration of the laser light focused by the pickup lens 14 is almost the same as that when the steps are not formed.

On the other hand, when the ambient temperature changes and the laser light with the changed wavelength is incident on the pickup lens 14, a difference in the phase of the laser light having passed through the respective ring zones is not an integral multiple of the wavelength as shown in FIGS. 2B and 2C. Thus, when the wavelength changes, a phase difference is generated between the laser light having passed through different ring zones as shown in FIGS. 2B and 2C. In this embodiment, the phase difference is designed so as to reduce the aberration occurring due to a change in ambient temperature. Accordingly, when the ambient temperature changes, although the aberration becomes larger by the pickup lens in related art, an increase in aberration due to a change in ambient temperature is suppressed by a phase difference in the laser light having passed through the respective ring zones of the pickup lens 14 in this embodiment. Then, the laser light output from the pickup lens 14 is suitably focused on the information recording surface of the optical disc 15.

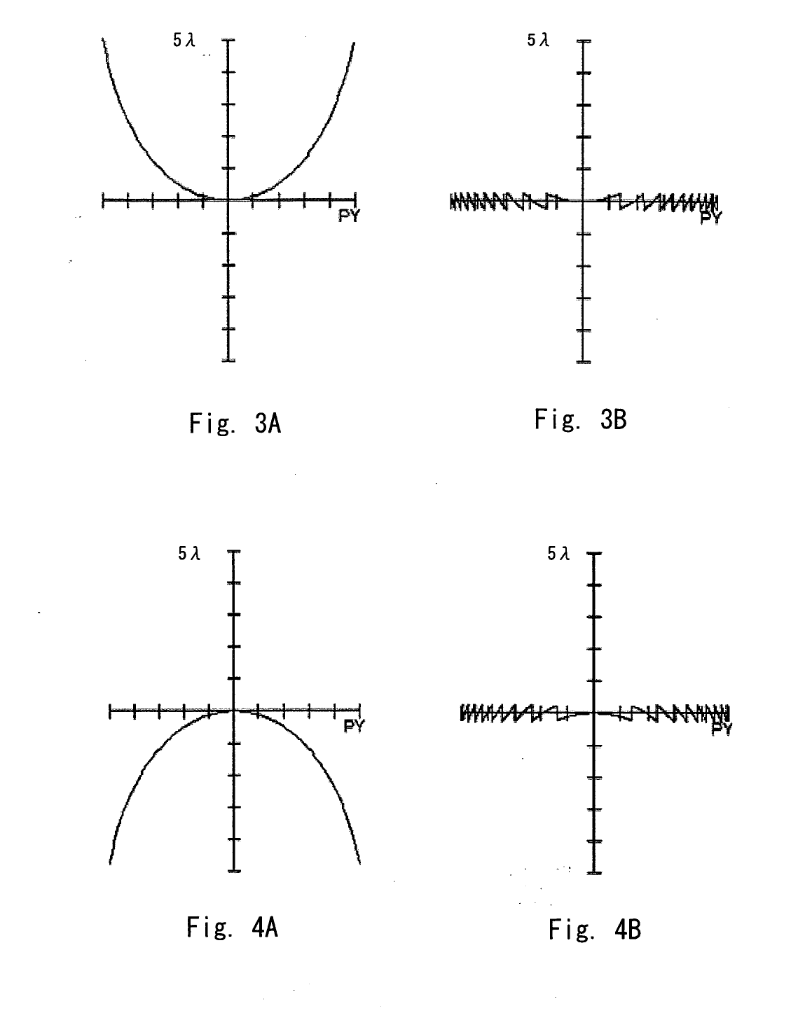

FIG. 3A shows the wavefront aberration occurring in the pickup lens on which the ring zones are not formed when the ambient temperature is 20° C. FIG. 4A shows the wavefront aberration occurring in the pickup lens on which the ring zones are not formed when the ambient temperature is 50° C. FIG. 3B shows the wavefront aberration occurring in the pickup lens 14 when the ambient temperature is 20° C. FIG. 4B shows the wavefront aberration occurring in the pickup lens 14 when the ambient temperature is 50° C. In FIGS. 3 and 4, the vertical axis indicates the amount of wavefront aberration, and the horizontal axis indicates the position in the diameter direction of the pickup lens. The design temperature of the pickup lens without the ring zones and the pickup lens 14 is 35° C.

As shown in FIGS. 3A and 4A, the wavefront aberration is extremely large in the pickup lens on which the ring zones are not formed when the ambient temperature is 20° C. and 50° C.

On the other hand, as shown in FIGS. 3B and 4B, the wavefront aberration stays small in the pickup lens 14 on which the ring zones are formed even when the ambient temperature is 20° C. and 50° C. Specifically, a phase difference occurs in the laser light having passed through the respective ring zones by the steps formed on the pickup lens 14. The phase difference reduces the aberration occurring in the pickup lens 14 due to a change in ambient temperature. Therefore, the laser light output from the pickup lens 14 is suitably focused on the information recording surface of the optical disc 15.

The pickup lens 14 is designed to satisfy the following expressions (1) to (3) where the numerical aperture of the pickup lens 14 is NA, the focal length is f (mm) and the working distance is WD (mm):

NA≧0.85 (1),

1.1≦f≦1.8 (2) and

WD≧0.3 (3).

Further, in the case of focusing laser light on the multilayer optical disc 15 using the pickup lens 14, the pickup lens 14 preferably satisfies the following expression (4) when correcting the third-order spherical aberration that occurs based on a difference in substrate thickness between the recording layers of the multilayer optical disc 15, where the fifth-order spherical aberration is SA5:

|SA5|≦0.020 (4).

More preferably, the pickup lens 14 satisfies the following expression (10):

|SA5|≦0.010 (10).

By satisfying the expression (4), it is possible to suppress the deterioration of the on-axis characteristics when focusing light on the respective recording layers of the multilayer optical disc 15. If the plurality of ring zones described above are formed on at least one surface of the pickup lens, the on-axis characteristics when focusing light on the respective recording layers of the multilayer optical disc 15 are generally deteriorated. However, by satisfying the expression (4), SA5 is not deteriorated even when the third-order spherical aberration that occurs based on a difference in substrate thickness between the recording layers of the multilayer optical disc 15 is corrected in the case of focusing the light beam emitted from the laser light source on the multilayer optical disc 15 using the pickup lens 14. It is thereby possible to suppress the deterioration of the on-axis characteristics when focusing light on the respective recording layers of the multilayer optical disc 15.

SA5 is the fifth-order spherical aberration defined by the following expression (11):

$$SA 5 = \frac{A 15}{\sqrt{7}} . \qquad ( 11 )$$

In the expression (11), A15 is a coefficient of Zernike polynomials, and if the beam height is h (mm), A15=20 h⁶−30 h⁴+12 h²−1.

Further, it is preferred to satisfy the following expressions (5) to (7) where the tangential angle at the portion on which a marginal ray is incident is θ_{M}(°), the minimum thickness of the lens at the portion on which a marginal ray is incident is tₘ(mm) and the refractive index of the pickup lens 14 is N:

73≦θ_{M}≦75 (5)

1.5≦N≦1.55 (6) and

t_{M}≧0.35 (7).

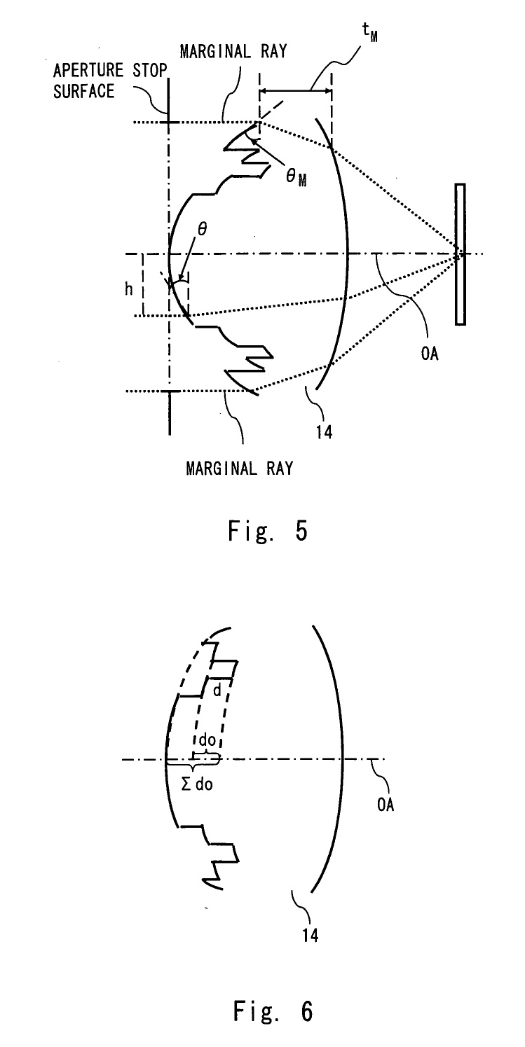

The marginal ray is a light ray that passes through the outermost part within the effective diameter of the pickup lens 14. The tangential angle θ(°) is described hereinafter with reference to FIG. 5. The tangential angle θ is an angle between the tangent to the incidence surface of the pickup lens 14 and the normal to an incident ray as shown in FIG. 5. The angle between the normal to the optical axis and the tangent to the incidence surface at the portion on which the marginal ray is incident is the tangential angle θ_{M}.

When the tangential angle θ_{M} at the portion on which the marginal ray is incident is smaller than 73°, if the steps are formed on the pickup lens 14, the characteristics of the pickup lens 14 with respect to oblique incidence on the pickup lens 14 from off the optical axis (which is referred to hereinafter as off-axis characteristics) are deteriorated. Further, if the focal length becomes longer, the deterioration of the off-axis characteristics becomes significant. In other words, when the tangential angle θ_{M} at the portion on which the marginal ray is incident is smaller than 73°, if the steps that correct the deterioration of the wavefront aberration due to a change in ambient temperature are formed on the pickup lens 14 while maintaining a sufficient working distance, the off-axis characteristics are deteriorated. Further, if the tangential angle θ_{M} is larger than 75°, it is difficult to manufacture the pickup lens 14. Therefore, by satisfying 73≦θ_{M}≦75, it is possible to prevent the deterioration of the off-axis characteristics caused by forming the steps on the pickup lens 14 while maintaining a sufficient working distance and facilitate the manufacture of the pickup lens 14.

Further, by satisfying the expressions (5) to (7), it is possible to easily manufacture the pickup objective lens that satisfies the expression (4).

The lens minimum thickness t_{M} is described hereinafter with reference to FIG. 5. The lens minimum thickness t_{M} is a distance along the optical axis between the intersection of the marginal ray and the incidence surface of the pickup lens 14 and the intersection of the marginal ray and the output surface of the pickup lens 14. If the lens minimum thickness t_{M} is thinner than 0.35 mm, the edge thickness of the pickup lens 14 becomes too thin. This makes it difficult to manufacture the pickup lens 14. Therefore, by setting the lens minimum thickness t_{M} to be equal to or thicker than 0.35 mm, it is possible to easily manufacture the pickup lens 14.

Further, when the fifth-order coma aberration is COMA5, the absolute value of COMA5 at the angle view of 0.3° is preferably equal to or smaller than 0.025λrms. More preferably, the absolute value of COMA5 at the angle view of 0.3° is equal to or smaller than 0.010λrms. COMA5 is represented by the following expression (12):

$$COMA 5 = \frac{\sqrt{A {13}^{2} + A {14}^{2}}}{\sqrt{12}} \qquad ( 12 )$$

In the expression (12), A13 and A14 are coefficients of Zernike polynomials. Specifically, A13=(10 h⁵−12 h³+3 h)cos α, A14=(1.0 h⁵−12 h³+3 h)sin α. Further, h indicates a beam height (mm).

When the absolute value of COMA5 is larger than 0.025λrms, if the steps that correct the deterioration of the wavefront aberration due to a change in ambient temperature are formed on the pickup lens 14 while maintaining a sufficient working distance, the off-axis characteristics are deteriorated. Therefore, by setting the absolute value of COMA5 to be equal to or smaller than 0.025λrms, it is possible to prevent the deterioration of the off-axis characteristics caused by forming the steps on the pickup lens 14 while maintaining a sufficient working distance.

Further, when the number of ring zones formed on the pickup lens 14 is n (n is a positive integer that satisfies n≧3), it is preferred to form the steps in such a way that the lens thickness of the pickup lens 14 gradually decreases in the range of the 1st to the i-th (i=2, 3, . . . , n−1) ring zones from the optical axis of the pickup lens 14 and the lens thickness of the pickup lens 14 gradually increases in the range of the (i+1)th (i+1=3, 4, . . . , n) to the n-th ring zones.

In other words, it is preferred to form the steps in such a way that the lens thickness of the pickup lens 14 becomes thinner from the optical axis to a given radius position and becomes thicker from the given radius position to the outer edge.

Furthermore, it is preferred that the absolute value of the offense against sine condition at all beam heights is equal to or smaller than 0.01. The offense against sine condition (SC) is represented by the following expression (13):

SC=(h/sin θ−f)/f (13)

In the expression (13), h indicates the beam height (mm), θ indicates the angle (tangential angle) between the normal to the optical axis and the tangent to the incidence surface of the pickup lens 14, and f indicates the focal length (mm).

If the steps are formed on the pickup lens 14 when the absolute value of the offense against sine condition (SC) is larger than 0.01, the off-axis characteristics of the pickup lens 14 are deteriorated. Further, the deterioration of the off-axis characteristics becomes significant if the focal length is longer. In other words, when the absolute value of the offense against sine condition at all beam heights is larger than 0.01, if the steps that correct the deterioration of the wavefront aberration occurring due to a change in ambient temperature are formed on the pickup lens 14 while maintaining a sufficient working distance, the off-axis characteristics are deteriorated. Therefore, by setting the absolute value of the offense against sine condition at all beam heights to be equal to or smaller than 0.01, it is possible to prevent the deterioration of the off-axis characteristics caused by forming the steps on the pickup lens 14 while maintaining a sufficient working distance.

Furthermore, it is preferred to satisfy the following expression (8) where the adjacent step difference of the steps of the pickup lens 14 is d (mm), the wavelength is λ (mm), and the refractive index of the pickup lens 14 is N:

4≦(N−1)*d/λ≦28 (8)

In other words, the adjacent step difference is preferably from four times to twenty-eight times the wavelength. FIG. 6 is a side view schematically showing the pickup lens 14. The adjacent step difference is the step difference of the step between the respective ring zones as shown in FIG. 6. If the adjacent step difference is smaller than four times the wavelength, it is necessary to increase the number of ring zones formed on the pickup lens 14 in order to sufficiently correct the aberration. This reduces the light use efficiency. On the other hand, if the adjacent step difference is larger than twenty-eight times the wavelength, the step difference becomes too large, making it difficult to manufacture the pickup lens 14.

It is further preferred to satisfy the following expression (9) where the on-axis step difference of the step of the pickup lens 14 is d₀ (mm), the wavelength is λ (mm), and the refractive index of the pickup lens 14 is N:

4≦(N−1)*d₀/λ≦14 (9)

In other words, the on-axis step difference is preferably from four times to fourteen times the wavelength. The on-axis step difference is, when virtually extending the surface shape of each ring zone toward the optical axis OA, the distance between the intersection where the surface shape virtually intersects with the optical axis and the intersection where the surface shape of the ring zone including the optical axis intersects with the optical axis OA as shown in FIG. 6. In other words, the on-axis step difference is the step difference of the step of the pickup lens 14 on the optical axis. If the on-axis step difference is smaller than four times the wavelength, it is necessary to increase the number of ring zones formed on the pickup lens 14 in order to sufficiently correct the aberration. This reduces the light use efficiency. On the other hand, if the on-axis step difference is larger than fourteen times the wavelength, the step difference becomes too large, making it difficult to manufacture the pickup lens 14.

Further, it is preferred that a difference between the maximum value and the minimum value of the cumulative value Σd of the adjacent step difference is from 60λ to 180λ, where the adjacent step difference of the steps is d (mm).

If a difference between the maximum value and the minimum value of the cumulative value Σd of the adjacent step difference is smaller than 60λ, it is difficult to sufficiently reduce the wavefront aberration occurring due to a change in ambient temperature. On the other hand, if a difference between the maximum value and the minimum value of the cumulative value Σd of the adjacent step difference is larger than 180λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd of the adjacent step difference is from 70λ to 180λ.

It is thereby possible to reduce the wavefront aberration that occurs when the temperature of the pickup lens 14 itself changes.

Further, it is preferred that a difference between the maximum value and the minimum value of the cumulative value Σd₀ of the on-axis step difference is from 30λ to 120λ when the on-axis step difference of the steps is d₀ (mm).

If a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd₀ of the on-axis step difference is larger than 120λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd₀ of the on-axis step difference is from 40λ to 120λ.

It is thereby possible to reduce the wavefront aberration that occurs when the temperature of the pickup lens 14 itself changes.

Further, when the number of ring zones formed on the pickup lens 14 is n (n is a positive integer), if n is an even number, it is preferred to form the steps in such a way that the lens thickness of the pickup lens 14 gradually decreases in the range of the 1st to the (n/2)th ring zones from the optical axis of the pickup lens 14 and the lens thickness of the pickup lens 14 gradually increases in the range of the ((n/2)+1)th to the n-th ring zones. Further, if n is an odd number, it is preferred to form the steps in such a way that the lens thickness of the pickup lens 14 gradually decreases in the range of the 1st to the ((n+1)/2)th ring zones from the optical axis of the pickup lens 14 and the lens thickness of the pickup lens 14 gradually increases in the range of the ((n+1)/2)th to the n-th ring zones.

In other words, it is preferred to form the steps in such a way that the lens thickness becomes thinner from the optical axis of the pickup lens 14 to a given radius position and the lens thickness becomes thicker from the given radius position to the outer edge. By forming the steps on the pickup lens 14, the off-axis characteristics of the pickup lens 14 are deteriorated. Further, the deterioration of the off-axis characteristics becomes significant if the focal length is longer. However, by forming the steps in such a way that the lens thickness of the pickup lens 14 is the thinnest at the given radius position, it is possible to suppress the RMS wavefront aberration at off-axis of the pickup lens 14 to be equal to or smaller than 0.035λ.

Further, by forming the steps in such a way that the lens thickness of the pickup lens 14 is the thinnest at the given radius position, it is possible to maintain a sufficient working distance and prevent the deterioration of the off-axis characteristics caused by forming the steps that correct the aberration due to a change in ambient temperature on the pickup lens 14 without satisfying the conditions of the expressions (5) to (7).

Furthermore, by forming the steps in such a way that the lens thickness of the pickup lens 14 is the thinnest at the given radius position, it is possible to reduce a difference between the maximum value and the minimum value of the cumulative value Σd of the adjacent step difference and a difference between the maximum value and the minimum value of the cumulative value Σd₀ of the on-axis step difference. This further facilitates the manufacture of the pickup lens 14.

Further, it is preferred that a difference between the maximum value and the minimum value of the cumulative value Σd of the adjacent step difference is from 60λ to 90λ where the adjacent step difference of the steps is d (mm).

If a difference between the maximum value and the minimum value of the cumulative value Σd of the adjacent step difference is smaller than 60λ, it is difficult to sufficiently reduce the wavefront aberration occurring due to a change in ambient temperature. On the other hand, if a difference between the maximum value and the minimum value of the cumulative value Σd of the adjacent step difference is larger than 90λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd of the adjacent step difference is from 70λ to 90λ.

It is thereby possible to reduce the wavefront aberration that occurs when the temperature of the pickup lens 14 itself changes.

Further, it is preferred that a difference between the maximum value and the minimum value of the cumulative value Σd₀ of the on-axis step difference is from 30λ to 60λ where the on-axis step difference of the steps is d₀ (mm).

If a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd₀ of the on-axis step difference is larger than 60λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd₀ of the on-axis step difference is from 40λ to 60λ.

It is thereby possible to reduce the wavefront aberration that occurs when the temperature of the pickup lens 14 itself changes.

In the pickup lens 14 and the optical pickup system 1 according to the embodiment having the above structure, a plurality of ring zones are formed on at least one surface of the pickup lens 14, and steps are formed respectively between the plurality of ring zones. Further, the plurality of ring zones have the step differences that cause laser light to have a phase difference so as to reduce the aberration occurring in the pickup lens 14 when the ambient temperature changes. Thus, when the ambient temperature changes, the phase difference that reduces the aberration caused by the change in ambient temperature is generated in the laser light having passed through the adjacent ring zones. By the phase difference, the aberration occurring due to a change in ambient temperature is reduced.

When the focal length is shorter than 1.1 mm, it is difficult to maintain a sufficient working distance (WD). Further, when the focal length is longer than 1.8 mm, the aberration occurring due to a change in ambient temperature becomes large, and it is therefore difficult to correct the aberration only by the steps formed on the pickup lens. Accordingly, by setting the range of the focal length from 1.1 mm to 1.8 mm, it is possible to maintain a sufficient working distance (WD) and sufficiently reduce the aberration occurring due to a change in ambient temperature.

Further, by satisfying the expression (4), it is possible to suitably focus light on the respective recording layers of the multilayer optical disc.

SA5 is the fifth-order spherical aberration defined by the following expression (11)

$$SA 5 = \frac{A 15}{\sqrt{7}} . \qquad ( 11 )$$

Further, if the plurality of ring zones described above are formed on at least one surface of the pickup lens, the on-axis characteristics when focusing light on the respective recording layers of the multilayer optical disc 15 are deteriorated. However, by satisfying the expressions (5) to (7), SA5, which is one of the indicators indicating the on-axis characteristics, is not deteriorated even when the third-order spherical aberration that occurs based on a difference in substrate thickness between the recording layers of the multilayer optical disc 15 is corrected in the case of focusing the light beam emitted from the laser light source on the multilayer optical disc 15 using the pickup lens 14. It is thereby possible to suppress the deterioration of the on-axis characteristics when focusing light on the respective recording layers of the multilayer optical disc 15.

Further, it is preferred to satisfy the following expressions (5) to (7) where the tangential angle at the portion on which a marginal ray is incident is θ_{M}(°), the minimum thickness of the lens at the portion on which a marginal ray is incident is t_{M}(mm) and the refractive index of the pickup lens 14 is N:

73≦θ_{M}≦75 (5),

1.5≦N≦1.55 (6) and

t_{M}≧0.35 (7).

By satisfying 73≦θ_{M}≦75, it is possible to prevent the deterioration of the off-axis characteristics caused by forming the steps on the pickup lens 14 while maintaining a sufficient working distance and facilitate the manufacture of the pickup lens 14.

Further, by setting the lens minimum thickness t_{M} to be equal to or thicker than 0.35 mm, it is possible to easily manufacture the pickup lens 14.

Furthermore, by satisfying the expressions (5) to (7), it is possible to easily manufacture the pickup objective lens that satisfies the expression (4).

Further, it is preferred that the absolute value of the offense against sine condition at all beam heights is equal to or smaller than 0.01.

By setting the absolute value of the offense against sine condition at all beam heights to be equal to or smaller than 0.01, it is possible to prevent the deterioration of the off-axis characteristics caused by forming the steps on the pickup lens 14 while maintaining a sufficient working distance.

Further, when the fifth-order coma aberration is COMA5, the absolute value of COMA5 at the angle view of 0.3° is preferably equal to or smaller than 0.025λrms. More preferably, the absolute value of COMA5 at the angle view of 0.3° is equal to or smaller than 0.010λrms. COMA5 is represented by the following expression (12):

$$COMA 5 = \frac{\sqrt{A {13}^{2} + A {14}^{2}}}{\sqrt{12}} \qquad ( 12 )$$

In the expression (12), A13 and A14 are coefficients of Zernike polynomials. Specifically, A13=(10 h⁵−12 h³+3 h)cos α, A14=(10 h⁵-12 h³+3 h)sin α. Further, h indicates a beam height (mm).

By setting the absolute value of COMA5 to be equal to or smaller than 0.025λms, it is possible to prevent the deterioration of the off-axis characteristics caused by forming the steps on the pickup lens 14 while maintaining a sufficient working distance.

Further, when the number of ring zones formed on the pickup lens 14 is n (n is a positive integer that satisfies n≧3), it is preferred to form the steps in such a way that the lens thickness of the pickup lens 14 gradually decreases in the range of the 1st to the i-th (i=2, 3, . . . , n−1) ring zones from the optical axis of the pickup lens 14 and the lens thickness of the pickup lens 14 gradually increases in the range of the (i+1)th (i+1=3, 4, . . . , n) to the n-th ring zones.

In other words, it is preferred to form the steps in such a way that the lens thickness becomes thinner from the optical axis of the optical pickup objective lens to a given radius position and becomes thicker from the given radius position to the outer edge.

The design wavelength of the pickup lens 14 is equal to or shorter than 500 nm.

Further, the steps have the step differences by which the phase of light passed therethrough is different between the ring zones at approximately an integral multiple of the wavelength and which cause laser light to have a phase difference so as to reduce the aberration occurring in the pickup lens 14 when the ambient temperature changes.

Thus, when the ambient temperature changes, the phase difference that reduces the aberration caused by the change in ambient temperature is generated in the laser light.

Furthermore, it is preferred to satisfy the following expression (8) where the adjacent step difference of the steps of the pickup lens 14 is d (mm), the wavelength is λ (mm), and the refractive index of the pickup lens 14 is N:

4≦(N−1)*d/λ≦28 (8)

It is further preferred to satisfy the following expression (9) where the on-axis step difference of the step of the pickup lens 14 is d₀ (mm), the wavelength is λ (mm), and the refractive index of the pickup lens 14 is N:

4≦(N−1)*d₀/λ≦14 (9)

If the adjacent step difference is smaller than four times the wavelength or if the on-axis step difference is smaller than four times the wavelength, it is necessary to increase the number of ring zones formed on the pickup lens 14 in order to sufficiently correct the aberration. This reduces the light use efficiency. On the other hand, if the adjacent step difference is larger than twenty-eight times the wavelength or if the on-axis step difference is larger than fourteen times the wavelength, the step difference becomes too large, making it difficult to manufacture the pickup lens 14. Thus, by forming the steps so as to satisfy the expression (8) or (9), it is possible to prevent a decrease in light use efficiency and facilitate the manufacture of the pickup lens 14.

Further, it is preferred that a difference between the maximum value and the minimum value of the cumulative value Σd of the adjacent step difference is from 60λ to 180λ where the adjacent step difference of the steps is d (mm).

Furthermore, it is preferred that a difference between the maximum value and the minimum value of the cumulative value Σd₀ of the on-axis step difference is from 30λ to 120λ where the on-axis step difference of the steps is d₀ (mm).

If a difference between the maximum value and the minimum value of the cumulative value Σd of the adjacent step difference is smaller than 60λ or if a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd of the adjacent step difference is larger than 180λ or if a difference between the maximum value and the minimum value of the cumulative value Σd₀ of the on-axis step difference is larger than 120λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd of the adjacent step difference is from 70λ to 180λ.

It is also preferred that a difference between the maximum value and the minimum value of the cumulative value Σd₀ of the on-axis step difference is from 40λ to 120λ.

It is thereby possible to reduce the wavefront aberration that occurs when the temperature of the pickup lens 14 itself changes.

Further, when the number of ring zones formed on the pickup lens 14 is n (n is a positive integer), if n is an even number, it is preferred to form the steps in such a way that the lens thickness of the pickup lens 14 gradually decreases in the range of the 1st to the (n/2)th ring zones from the optical axis of the pickup lens 14 and the lens thickness of the pickup lens 14 gradually increases in the range of the ((n/2)+1)th to the n-th ring zones. Further, if n is an odd number, it is preferred to form the steps in such a way that the lens thickness of the pickup lens 14 gradually decreases in the range of the 1st to the ((n+1)/2)th ring zones from the optical axis of the pickup lens 14 and the lens thickness of the pickup lens 14 gradually increases in the range of the ((n+1)/2)th to the n-th ring zones.

In other words, the steps are formed in such a way that the lens thickness becomes thinner from the optical axis of the pickup lens 14 to a given radius position and the lens thickness becomes thicker from the given radius position to the outer edge. It is thereby possible to suppress the RMS wavefront aberration at off-axis of the pickup lens 14 to be equal to or smaller than 0.035λ.

Further, by forming the steps in such a way that the lens thickness of the pickup lens 14 is the thinnest at the given radius position, it is possible to maintain a sufficient working distance and prevent the deterioration of the off-axis characteristics caused by forming the steps that correct the aberration due to a change in ambient temperature on the pickup lens 14 without satisfying the conditions of the expressions (5) to (7).

Furthermore, by forming the steps in such a way that the lens thickness of the pickup lens 14 is the thinnest at the given radius position, it is possible to reduce a difference between the maximum value and the minimum value of the cumulative value Σd of the adjacent step difference and a difference between the maximum value and the minimum value of the cumulative value Σd₀ of the on-axis step difference. This further facilitates the manufacture of the pickup lens 14.

Further, it is preferred that a difference between the maximum value and the minimum value of the cumulative value Σd of the adjacent step difference is from 60λ to 90λ.

Furthermore, it is preferred that a difference between the maximum value and the minimum value of the cumulative value Σd₀ of the on-axis step difference is from 30λ to 60λ.

If a difference between the maximum value and the minimum value of the cumulative value Σd of the adjacent step difference is smaller than 60λ or if a difference between the maximum value and the minimum value of the cumulative value Σd₀ of the on-axis step difference is smaller than 30λ, it is difficult to sufficiently reduce the wavefront aberration occurring due to a change in ambient temperature. On the other hand, if a difference between the maximum value and the minimum value of the cumulative value Σd of the adjacent step difference is larger than 90λ or if a difference between the maximum value and the minimum value of the cumulative value Σd₀ of the on-axis step difference is larger than 60λ, the wavefront aberration occurring due to a change in ambient temperature is corrected excessively, which results in the degradation of wavefront aberration. Further, the step difference becomes too large, which makes it difficult to manufacture the pickup lens 14.

It is more preferred that a difference between the maximum value and the minimum value of the cumulative value Σd of the adjacent step difference is from 70λ to 90λ.

It is also preferred that a difference between the maximum value and the minimum value of the cumulative value Σd₀ of the on-axis step difference is from 40λ to 60λ.

It is thereby possible to reduce the wavefront aberration that occurs when the temperature of the pickup lens 14 itself changes.

### Example 1

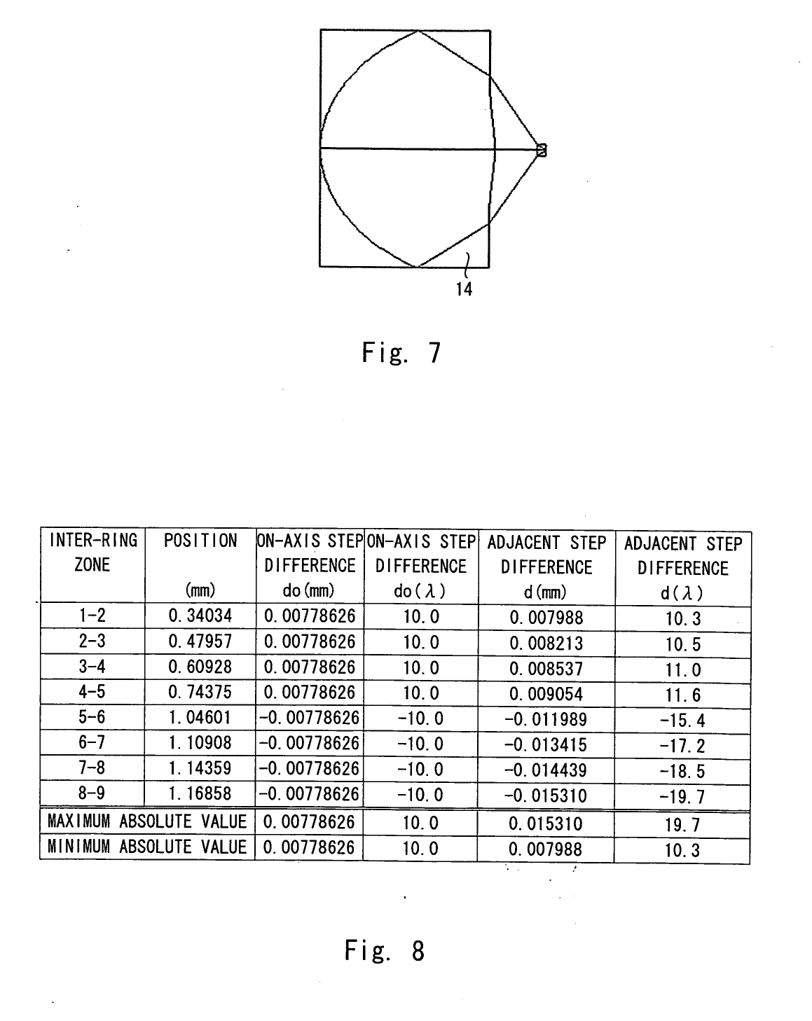

An example 1 according to an embodiment of the present invention is described hereinafter. FIG. 7 is a side view schematically showing the pickup lens 14 according to the example 1. The pickup lens 14 of the example 1 has a plurality of steps on the surface facing the light source 11 (not shown).

The table of FIG. 8 shows the numbers of the ring zones, the positions of the ring zones (the positions where the ring zones are formed in the direction perpendicular to the optical axis OA), the on-axis step differences and the adjacent step differences of the pickup lens 14 according to the example 1. In the table shown in FIG. 8, the numbers of the ring zones are assigned sequentially from the optical axis of the pickup lens 14 to the outer edge. Thus, the ring zone including the optical axis is the first ring zone.

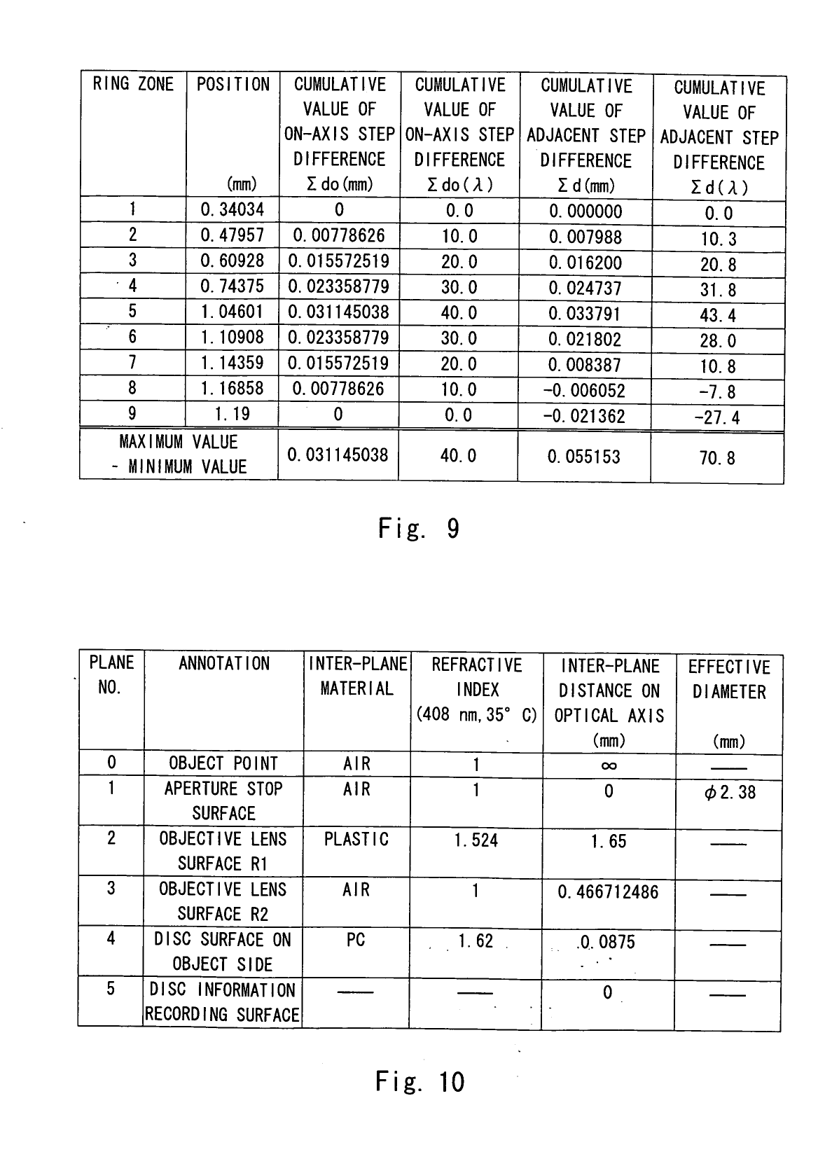

The table of FIG. 9 shows the numbers of the ring zones, the positions of the ring zones, the cumulative values of on-axis step differences and the cumulative values of adjacent step differences.

Because the curvature, the conic constant and the aspherical coefficient of each ring zone are different, the surface shape of each ring zone is slightly different from one another. Thus, the on-axis step difference and the adjacent step difference do not always coincide. When the on-axis step difference is a positive value, it means that the intersection where the surface shape of the ring zone virtually intersects with the optical axis is located on the optical disc 15 side of the pickup lens 14. On the other hand, when the on-axis step difference is a negative value, it means that the intersection is located on the light source 11 side of the pickup lens 14.

As shown in FIG. 8, nine ring zones are formed on the pickup lens 14 according to the example 1. Thus, the ring zone at the center is the fifth ring zone. The on-axis step difference increases by about 0.007786 mm each (about 10λ each) from the first ring zone to the fifth ring zone, and the on-axis step difference decreases by about 0.007786 mm each (about 10λ each) from the fifth ring zone to the ninth ring zone. Further, the adjacent step difference increases from the first ring zone to the fifth ring zone, and the adjacent step difference decreases from the fifth ring zone to the ninth ring zone. In other words, the steps are formed in such a way that the lens thickness of the pickup lens 14 gradually becomes thinner in the range from the first ring zone to the center ring zone, and the lens thickness of the pickup lens 14 gradually becomes thicker in the range from the center ring zone to the ninth ring zone.

Note that about 0.007786 mm=about 10λ, where λ indicates the wavelength. Thus, the on-axis step difference formed on the pickup lens 14 according to the example 1 is about ten times the design wavelength.

As shown in FIG. 9, the maximum value of the cumulative value of the on-axis step difference is 40.0λ, and the minimum value of the cumulative value of the on-axis step difference is 0.0λ. Accordingly, a difference between the maximum value and the minimum value of the on-axis step difference is 40.0λ.

Further, as shown in FIG. 9, the maximum value of the cumulative value of the adjacent step difference is 43.4λ, and the minimum value of the cumulative value of the adjacent step difference is −27.4λ. Accordingly, a difference between the maximum value and the minimum value of the adjacent step difference is 70.8λ.

The table of FIG. 10 shows the data of the optical pickup system 1 according to the example 1. In FIG. 10, the objective lens surface R1 is the surface of the pickup lens 14 facing the light source 11. The objective lens surface R2 is the surface of the pickup lens 14 facing the optical disc 15. As shown in FIG. 10, a plastic lens is used as the pickup lens 14 according to the example 1. The working distance (WD) is the distance between the surface of the pickup lens 14 facing the optical disc 15 (the objective lens surface R2) and the surface of the optical disc 15 facing the light source 11 (the object-side surface), and it is about 0.47 mm. The focal length is 1.4 mm.

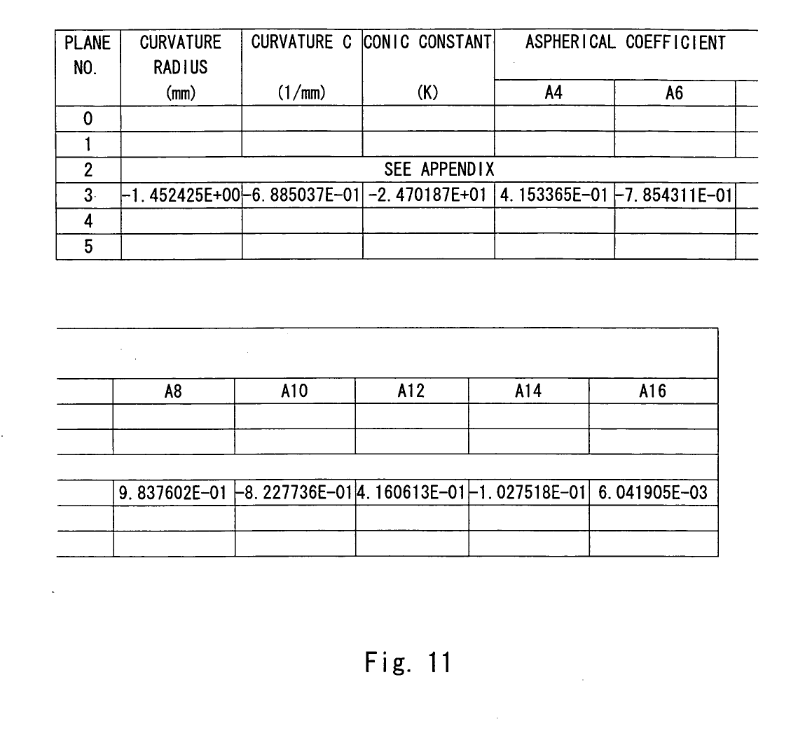

The table of FIG. 11 shows the coefficients that specify the shape of a surface (plane number 3) on the optical disc 15 side of the pickup lens 14 according to the example 1. The coefficients shown in FIG. 11 are used in the expression (14) described later. Thus, the surface shape on the optical disc 15 side of the pickup lens 14 according to the example 1 is specified by the coefficients shown in FIG. 11 and the expression (14). As shown in FIG. 11, the surface on the optical disc 15 side of the pickup lens 14 according to the example 1 has a single aspherical shape.

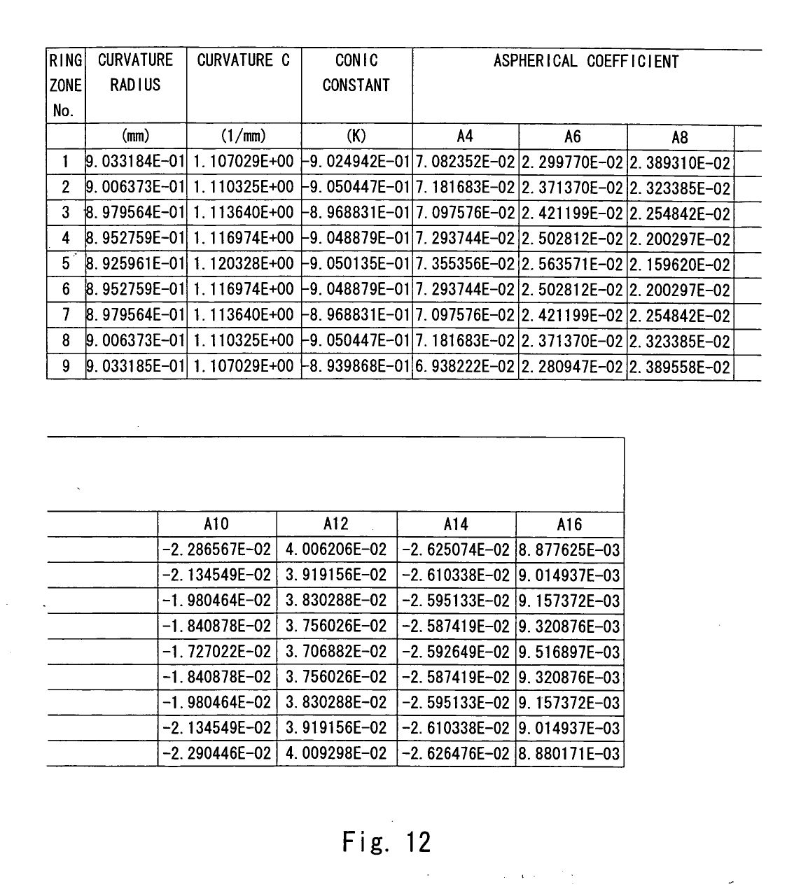

The table of FIG. 12 shows the coefficients that specify the shape of a surface (plane number 2) on the light source 11 side of the pickup lens 14 according to the example 1. The coefficients shown in FIG. 12 are used in the expression (15) described later. Thus, the surface shape on the light source 11 side of the pickup lens 14 according to the example 1 is specified by the coefficients shown in FIG. 12 and the expression (15). As shown in FIG. 12, the surface on the light source 11 side of the pickup lens 14 according to the example 1 has different aspherical shapes in the respective ring zones.

The expression (14) and the expression (15) are described with reference to FIG. 13. FIG. 13 is a side view showing an objective lens, which is an example of the pickup lens.

First, the surface shape of the light output surface R2 of the objective lens is described. Referring to FIG. 13, when the beam height is h (mm), the vertex of the light output surface R2 of the objective lens is e, the point at the beam height h on the tangent to the vertex e is c, and the point on the light output surface R2 shifted from the point c in the direction parallel to the optical axis OA is d, the surface shape of the light output surface R2 is formed in such a way that the distance Z_{B} (mm) between the points c and d at a given beam height h is represented by the following expression (14):

$${Z}_{B} = \frac{{Ch}^{2}}{1 + \sqrt{1 - ( K + 1 ) {C}^{2} \cdot {h}^{2}}} + {A}_{4} \cdot {h}^{4} + {A}_{6} \cdot {h}^{6} + {A}_{8} \cdot {h}^{8} + {A}_{10} \cdot {h}^{10} + {A}_{12} \cdot {h}^{12} + {A}_{14} \cdot {h}^{14} + {A}_{16} \cdot {h}^{16} \qquad ( 14 )$$

Then, the surface shape of the entire surface of the pickup lens 14 according to the example 1 facing the optical disc 15 is specified by the expression (14) and the values of the coefficients of the plane number 3 shown in FIG. 11.

If the distance Z_{B} (mm) at a given beam height h (mm) (≠0) is calculated by substituting the values of the coefficients C, K, A₄, A₆, A₈, A₁₀, A₁₂, A₁₄ and A₁₆ into the expression (14) and the calculated value is a negative value, it means that the point d is located on the light output surface side (on the left side in FIG. 13) with respect to the vertex e of the light output surface R2 where the optical axis OA passes. If the distance Z_{B} (mm) is a positive value, it means that the point d is located on the right side with respect to the vertex e.

Next, the surface shape of the light incidence surface R1 of the objective lens is described. Referring to FIG. 13, when the vertex of the light incidence surface R1 of the objective lens is f, the point at the beam height h on the tangent to the vertex f is a, and the point on the light incidence surface R1 shifted from the point a in the direction parallel to the optical axis OA is b, the surface shape of the light incidence surface R1 is formed in such a way that the distance Z_{A} (mm) between the points a and b at a given beam height h (mm) is represented by the following expression (15):

$${Z}_{A} = B + \frac{{Ch}^{2}}{1 + \sqrt{1 - ( K + 1 ) {C}^{2} \cdot {h}^{2}}} + {A}_{4} \cdot {h}^{4} + {A}_{6} \cdot {h}^{6} + {A}_{8} \cdot {h}^{8} + {A}_{10} \cdot {h}^{10} + {A}_{12} \cdot {h}^{12} + {A}_{14} \cdot {h}^{14} + {A}_{16} \cdot {h}^{16} \qquad ( 15 )$$

When specifying the surface shapes of the first ring zone, the second ring zone, . . . and the ninth ring zone of the pickup lens 14 according to the example 1, the values of the ring zone positions of the first ring zone, the second ring zone, . . . and the ninth ring zone shown in the table of FIG. 9 are respectively substituted into the beam height h of the expression (15). Further, when specifying the surface shapes of the first ring zone, the second ring zone, . . . and the ninth ring zone of the pickup lens 14 according to the example 1, the values of the on-axis step differences of the first ring zone, the second ring zone, . . . and the ninth ring zone shown in the table of FIG. 8 are respectively substituted into the coefficient B of the expression (15). Then, the surface shapes of the first ring zone to the ninth ring zone of the pickup lens 14 according to the example 1 are specified by the expression (15) and the values of the coefficients shown in FIG. 12.

### Example 2

An example 2 according to an embodiment of the present invention is described hereinafter. The pickup lens 14 according to the example 2 has a plurality of steps on the surface facing the light source 11 (not shown).

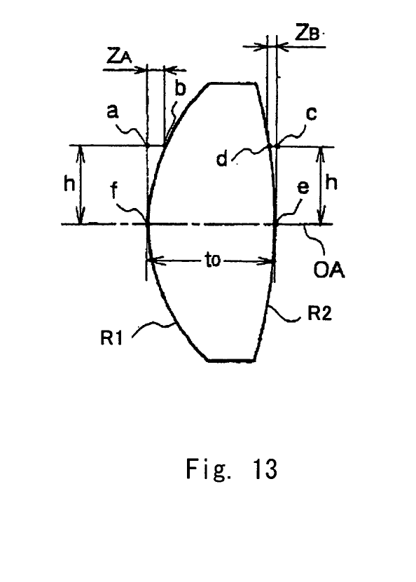

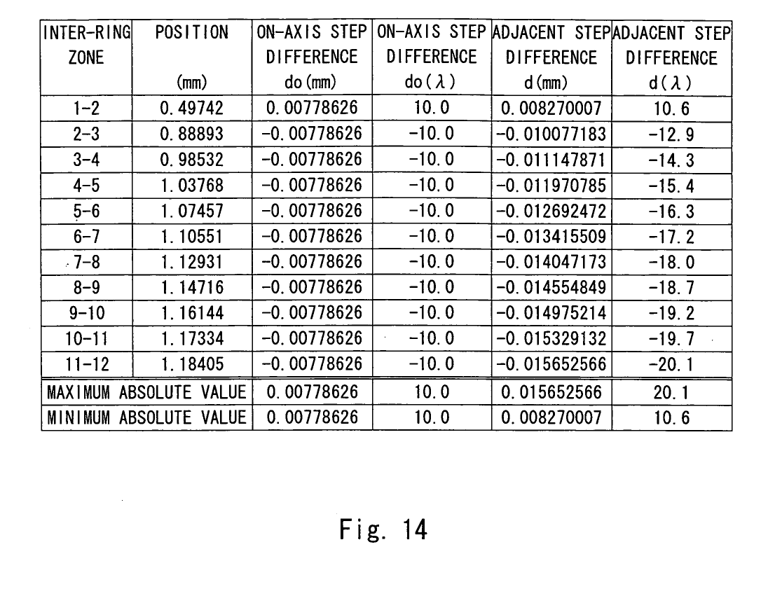

The table of FIG. 14 shows the numbers of the ring zones, the positions of the ring zones, the on-axis step differences and the adjacent step differences of the pickup lens 14 according to the example 2.

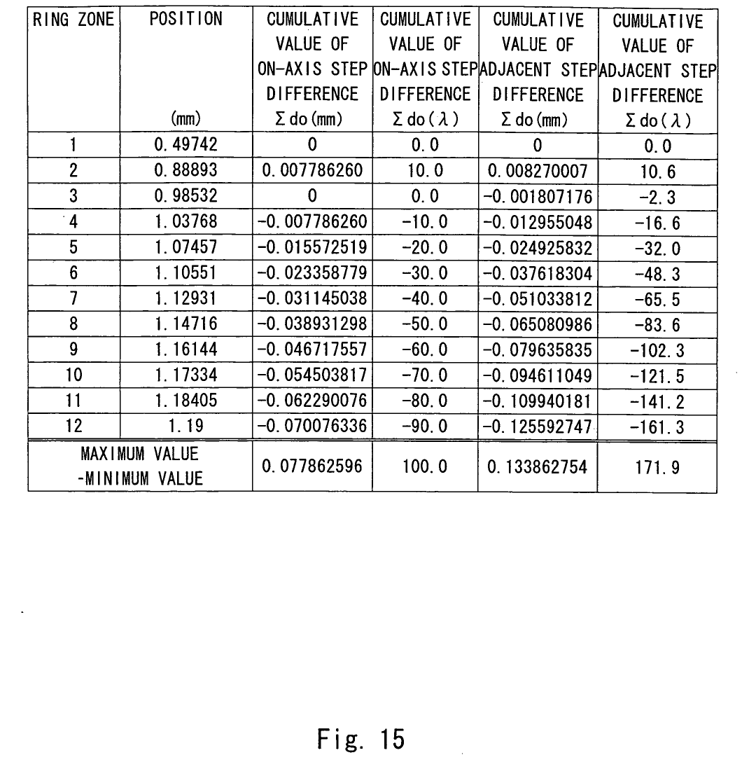

Further, the table of FIG. 15 shows the numbers of the ring zones, the positions of the ring zones, the cumulative values of on-axis step differences and the cumulative values of adjacent step differences.

As shown in FIG. 14, twelve ring zones are formed on the pickup lens 14 according to the example 2. Thus, the ring zone at the center is the sixth and the seventh ring zones. The on-axis step difference increases by about 0.007786 mm each (about 10λ each) from the first ring zone to the second ring zone, and the on-axis step difference decreases by about 0.007786 mm each (about 10λ each) from the second ring zone to the twelfth ring zone. Further, the adjacent step difference increases from the first ring zone to the second ring zone, and the adjacent step difference decreases from the second ring zone to the twelfth ring zone. In other words, the steps are formed in such a way that the lens thickness of the pickup lens 14 gradually becomes thinner in the range from the first ring zone to the second ring zone, and the lens thickness of the pickup lens 14 gradually becomes thicker in the range from the second ring zones to the twelfth ring zone.

Note that about 0.007786 mm=about 10λ, where λ indicates the wavelength. Thus, the on-axis step difference formed on the pickup lens 14 according to the example 2 is about ten times the design wavelength.

As shown in FIG. 15, the maximum value of the cumulative value of the on-axis step difference is 10.0λ, and the minimum value of the cumulative value of the on-axis step difference is −90.0λ. Accordingly, a difference between the maximum value and the minimum value of the on-axis step difference is 100.0λ.

Further, as shown in FIG. 15, the maximum value of the cumulative value of the adjacent step difference is 10.6λ, and the minimum value of the cumulative value of the adjacent step difference is −161.3λ. Accordingly, a difference between the maximum value and the minimum value of the adjacent step difference is 171.9λ.

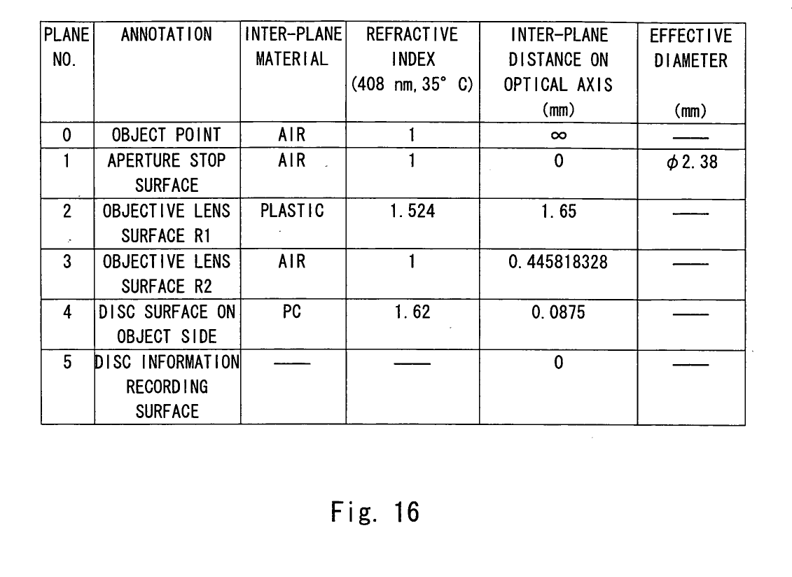

The table of FIG. 16 shows the data of the optical pickup system 1 according to the example 2. As shown in FIG. 16, a plastic lens is used as the pickup lens 14 according to the example 2. The working distance (WD) is the distance between the surface of the pickup lens 14 facing the optical disc 15 (the objective lens surface R2) and the surface of the optical disc 15 facing the light source 11 (the object-side surface), and it is about 0.46 mm. The focal length is 1.4 mm.

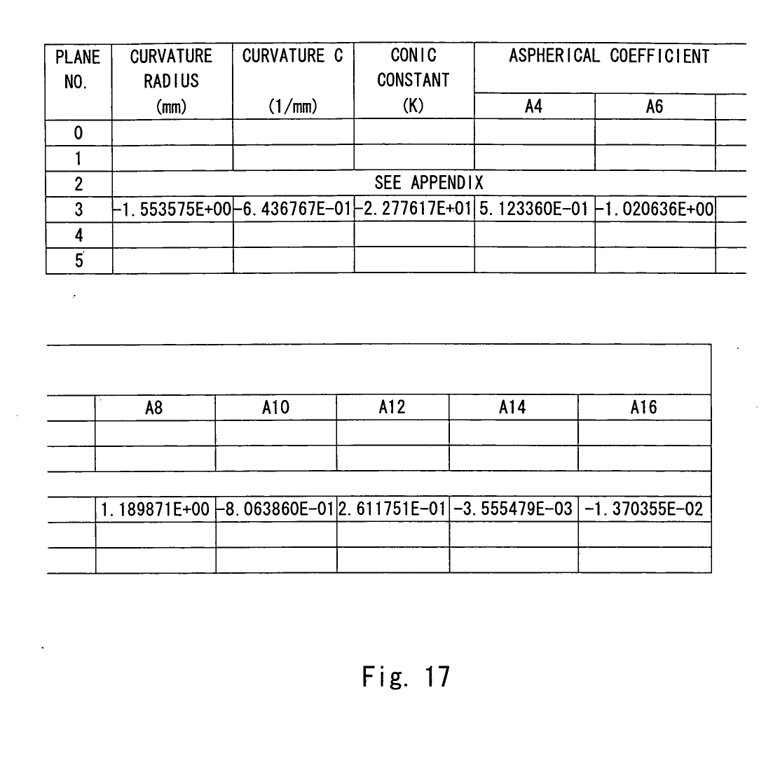

The table of FIG. 17 shows the coefficients that specify the shape of a surface (plane number 3) on the optical disc 15 side of the pickup lens 14 according to the example 2. The coefficients shown in FIG. 17 are used in the expression (14). Thus, the surface shape on the optical disc 15 side of the pickup lens 14 according to the example 2 is specified by the coefficients shown in FIG. 17 and the expression (14). As shown in FIG. 17, the surface on the optical disc 15 side of the pickup lens 14 according to the example 2 has a single aspherical shape.

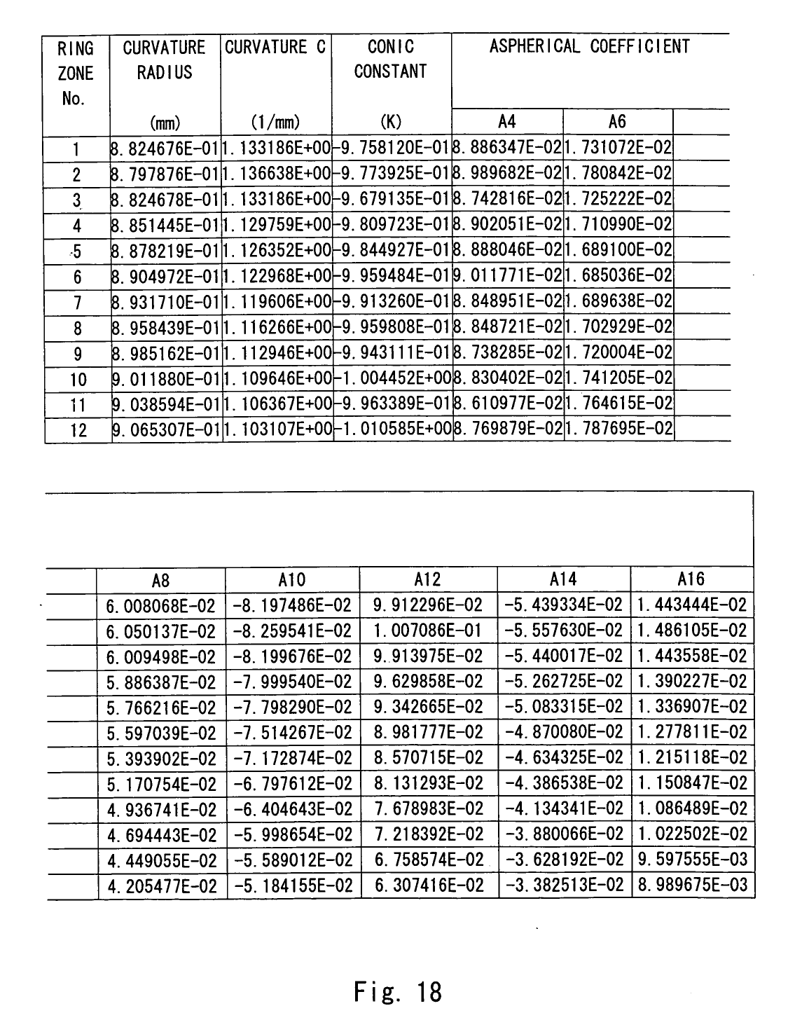

The table of FIG. 18 shows the coefficients that specify the shape of a surface (plane number 2) on the light source 11 side of the pickup lens 14 according to the example 2. The coefficients shown in FIG. 18 are used in the expression (15). Thus, the surface shape on the light source 11 side of the pickup lens 14 according to the example 2 is specified by the coefficients shown in FIG. 18 and the expression (15). As shown in FIG. 18, the surface on the light source 11 side of the pickup lens 14 according to the example 2 has different aspherical shapes in the respective ring zones.

### Example 3

An example 3 according to an embodiment of the present invention is described hereinafter. The pickup lens 14 according to the example 3 has a plurality of steps on the surface facing the light source 11 (not shown).

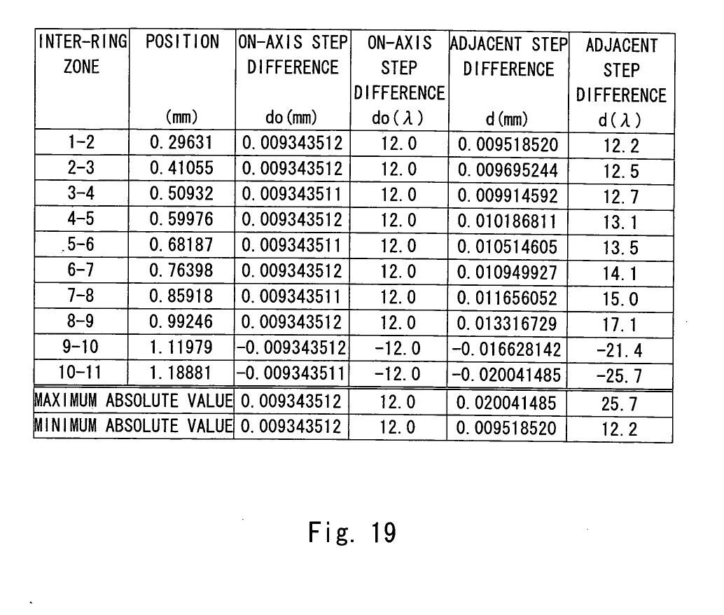

The table of FIG. 19 shows the numbers of the ring zones, the positions of the ring zones, the on-axis step differences and the adjacent step differences of the pickup lens 14 according to the example 3.

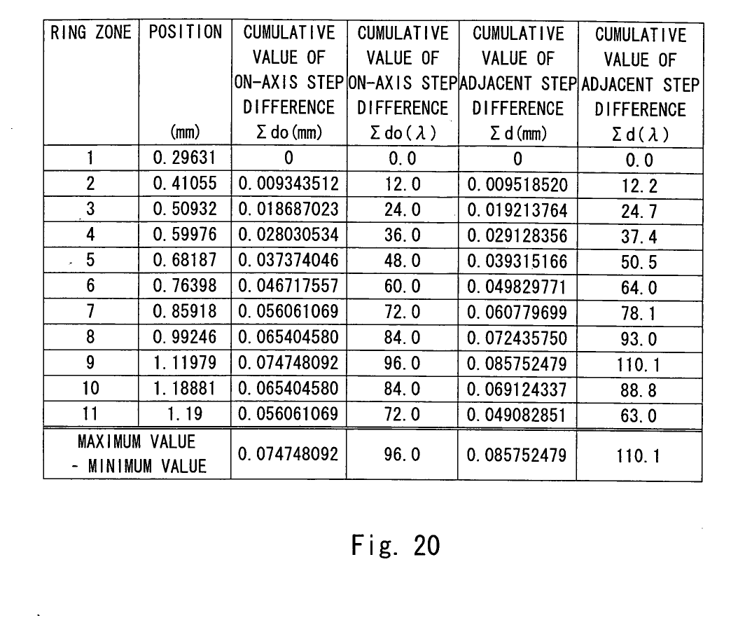

Further, the table of FIG. 20 shows the numbers of the ring zones, the positions of the ring zones, the cumulative values of on-axis step differences and the cumulative values of adjacent step differences.

As shown in FIG. 19, eleven ring zones are formed on the pickup lens 14 according to the example 3. Thus, the ring zone at the center is the fifth ring zone. The on-axis step difference increases by about 0.009343 mm each (about 12λ each) from the first ring zone to the ninth ring zone, and the on-axis step difference decreases by about 0.009343 mm each (about 12λ each) from the ninth ring zone to the eleventh ring zone. Further, the adjacent step difference increases from the first ring zone to the ninth ring zone, and the adjacent step difference decreases from the ninth ring zone to the eleventh ring zone. In other words, the steps are formed in such a way that the lens thickness of the pickup lens 14 gradually becomes thinner in the range from the first ring zone to the ninth ring zone, and the lens thickness of the pickup lens 14 gradually becomes thicker in the range from the ninth ring zones to the eleventh ring zone.

Note that about 0.009343 mm=about 12λ, where λ indicates the wavelength. Thus, the on-axis step difference formed on the pickup lens 14 according to the example 3 is about twelve times the design wavelength.

As shown in FIG. 20, the maximum value of the cumulative value of the on-axis step difference is 96.0λ, and the minimum value of the cumulative value of the on-axis step difference is 0.0λ. Accordingly, a difference between the maximum value and the minimum value of the on-axis step difference is 96.0λ.

Further, as shown in FIG. 20, the maximum value of the cumulative value of the adjacent step difference is 110.1λ, and the minimum value of the cumulative value of the adjacent step difference is 0.0λ. Accordingly, a difference between the maximum value and the minimum value of the adjacent step difference is 110.1λ.

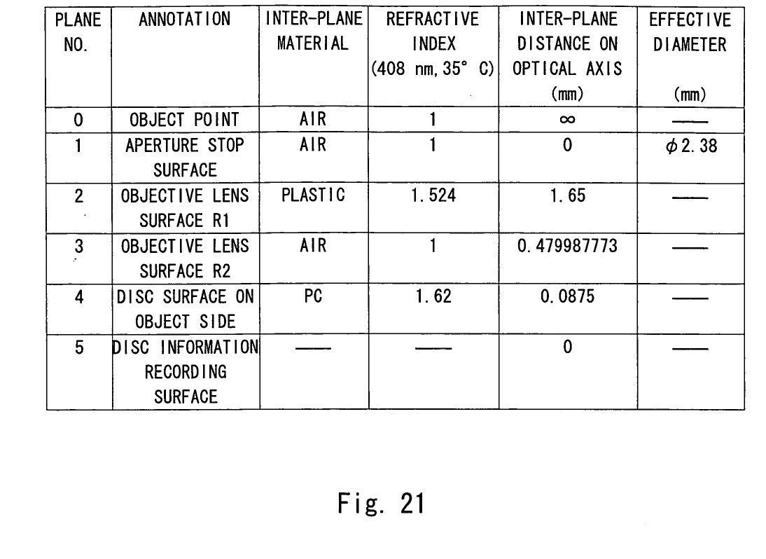

The table of FIG. 21 shows the data of the optical pickup system 1 according to the example 3. As shown in FIG. 21, a plastic lens is used as the pickup lens 14 according to the example 3. The working distance (WD) is the distance between the surface of the pickup lens 14 facing the optical disc 15 (the objective lens surface R2) and the surface of the optical disc 15 facing the light source 11 (the object-side surface), and it is about 0.48 mm. The focal length is 1.4 mm.

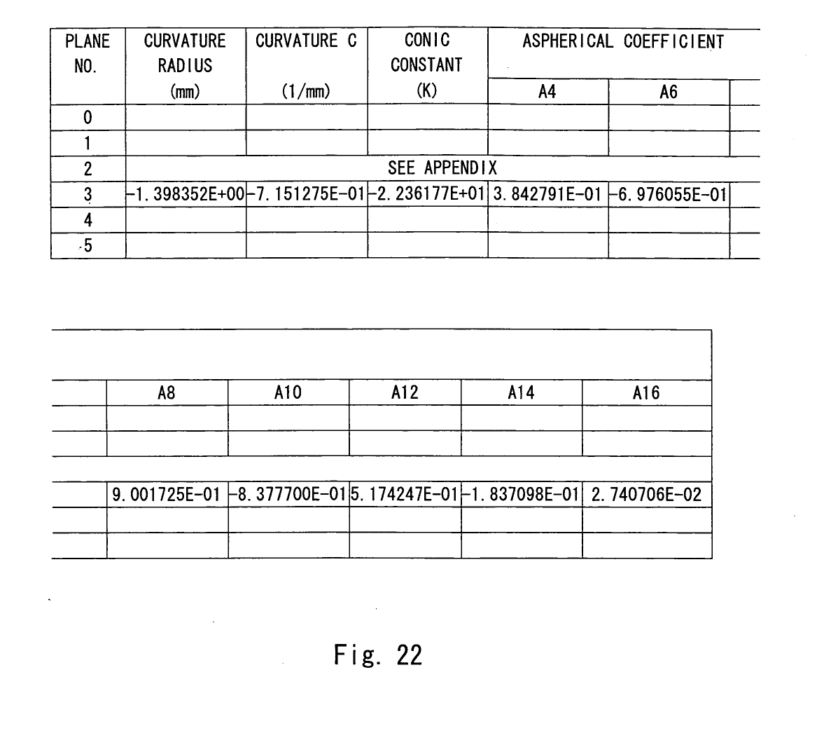

The table of FIG. 22 shows the coefficients that specify the shape of a surface (plane number 3) on the optical disc 15 side of the pickup lens 14 according to the example 3. The coefficients shown in FIG. 22 are used in the expression (14). Thus, the surface shape on the optical disc 15 side of the pickup lens 14 according to the example 3 is specified by the coefficients shown in FIG. 22 and the expression (14). As shown in FIG. 22, the surface on the optical disc 15 side of the pickup lens 14 according to the example 3 has a single aspherical shape.

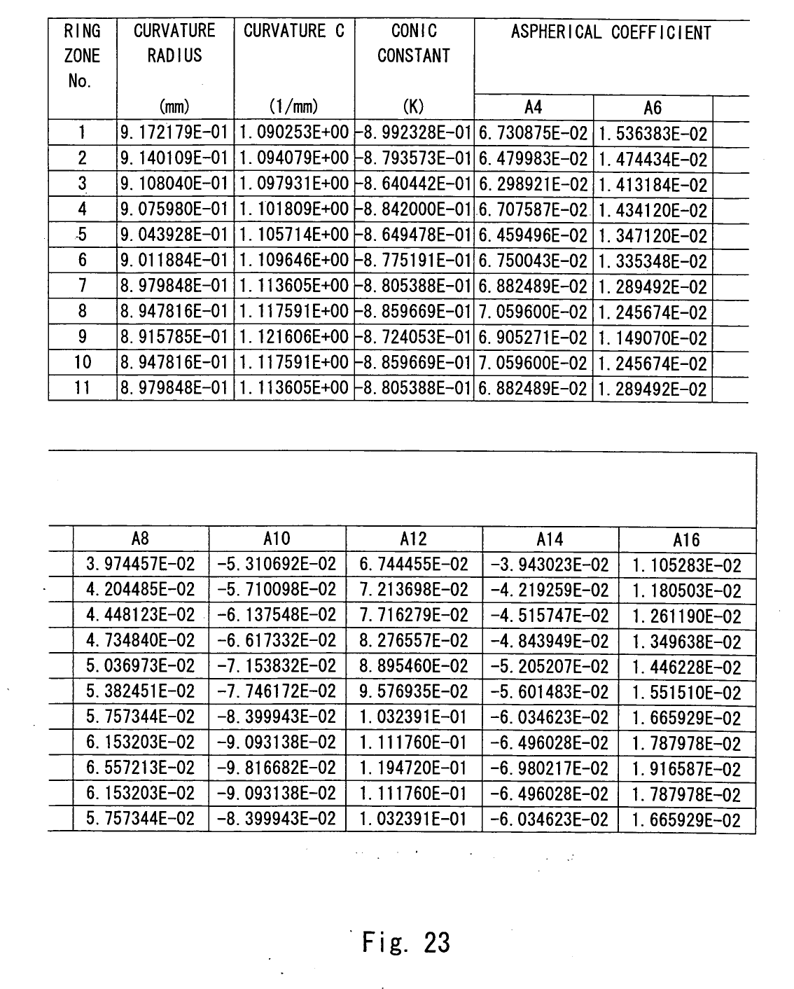

The table of FIG. 23 shows the coefficients that specify the shape of a surface (plane number 2) on the light source 11 side of the pickup lens 14 according to the example 3. The coefficients shown in FIG. 23 are used in the expression (15). Thus, the surface shape on the light source 11 side of the pickup lens 14 according to the example 3 is specified by the coefficients shown in FIG. 23 and the expression (15). As shown in FIG. 23, the surface on the light source 11 side of the pickup lens 14 according to the example 3 has different aspherical shapes in the respective ring zones.

### Example 4

An example 4 according to an embodiment of the present invention is described hereinafter. The pickup lens 14 according to the example 4 has a plurality of steps on the surface facing the light source 11 (not shown).

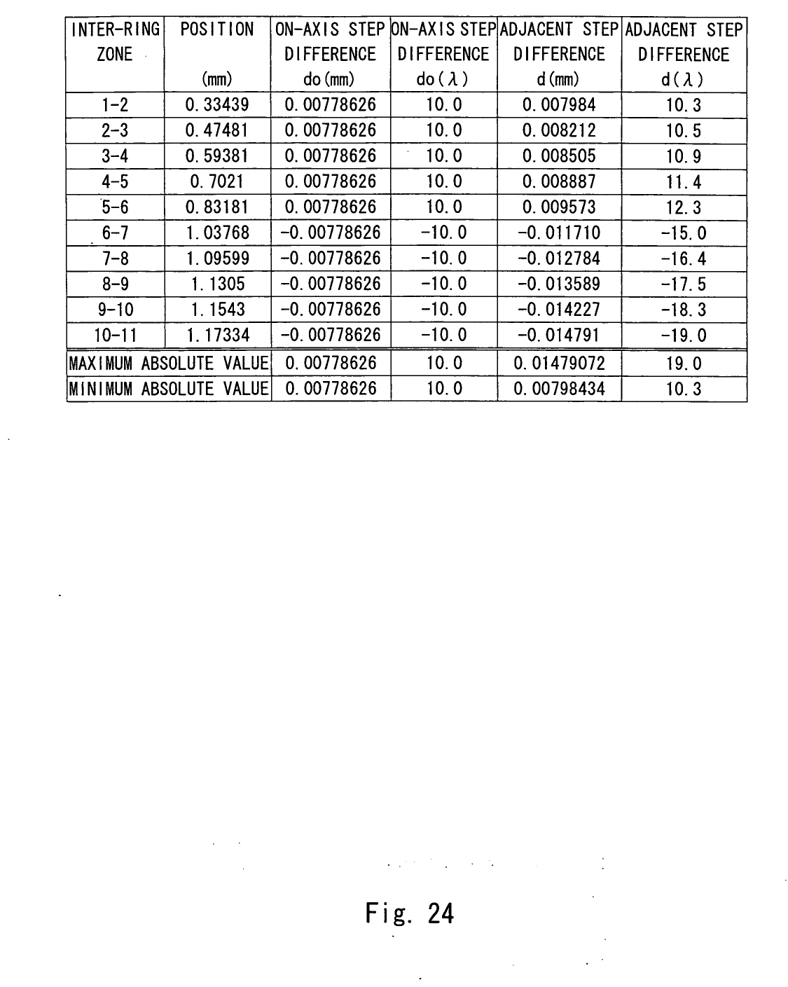

The table of FIG. 24 shows the numbers of the ring zones, the positions of the ring zones, the on-axis step differences and the adjacent step differences of the pickup lens 14 according to the example 4.

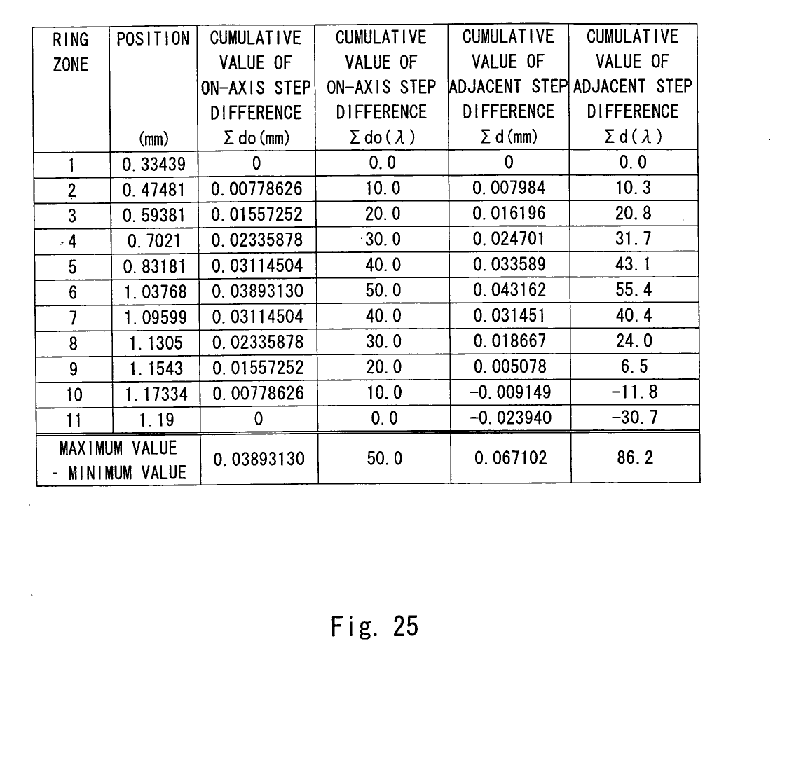

Further, the table of FIG. 25 shows the numbers of the ring zones, the positions of the ring zones, the cumulative values of on-axis step differences and the cumulative values of adjacent step differences.

As shown in FIG. 24, eleven ring zones are formed on the pickup lens 14 according to the example 4. Thus, the ring zone at the center is the sixth ring zone. The on-axis step difference increases by about 0.007786 mm each (about 10λ each) from the first ring zone to the sixth ring zone, and the on-axis step difference decreases by about 0.007786 mm each (about 10λ each) from the sixth ring zone to the eleventh ring zone. Further, the adjacent step difference increases from the first ring zone to the sixth ring zone, and the adjacent step difference decreases from the sixth ring zone to the eleventh ring zone. In other words, the steps are formed in such a way that the lens thickness of the pickup lens 14 gradually becomes thinner in the range from the first ring zone to the center ring zone, and the lens thickness of the pickup lens 14 gradually becomes thicker in the range from the center ring zone to the eleventh ring zone.

Note that about 0.007786 mm=about 10λ, where λ indicates the wavelength. Thus, the on-axis step difference formed on the pickup lens 14 according to the example 4 is about ten times the design wavelength.

As shown in FIG. 25, the maximum value of the cumulative value of the on-axis step difference is 50.0λ, and the minimum value of the cumulative value of the on-axis step difference is 0.0λ. Accordingly, a difference between the maximum value and the minimum value of the on-axis step difference is 50.0λ.

Further, as shown in FIG. 25, the maximum value of the cumulative value of the adjacent step difference is 55.4λ, and the minimum value of the cumulative value of the adjacent step difference is −30.7λ. Accordingly, a difference between the maximum value and the minimum value of the adjacent step difference is 86.2λ.

The table of FIG. 26 shows the data of the optical pickup system 1 according to the example 4. As shown in FIG. 26, a plastic lens is used as the pickup lens 14 according to the example 4. The working distance (WD) is the distance between the surface of the pickup lens 14 facing the optical disc 15 (the objective lens surface R2) and the surface of the optical disc 15 facing the light source 11 (the object-side surface), and it is about 0.46 mm. The focal length is 1.4 mm.

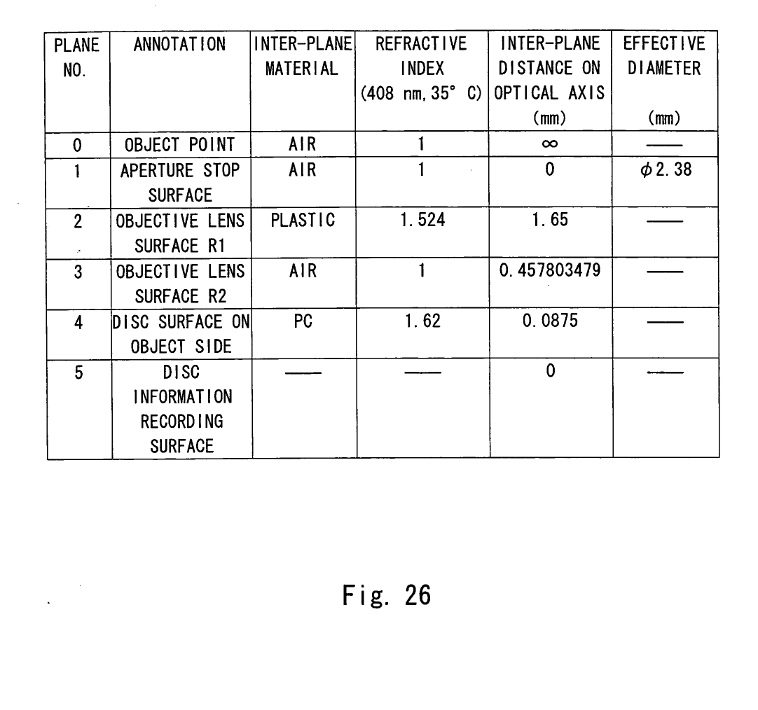

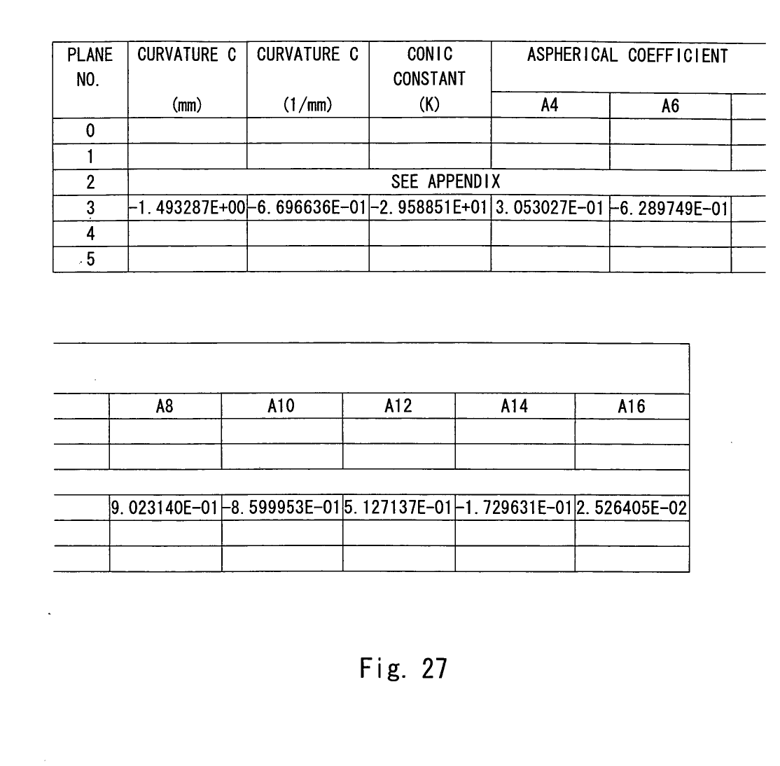

The table of FIG. 27 shows the coefficients that specify the shape of a surface (plane number 3) on the optical disc 15 side of the pickup lens 14 according to the example 4. The coefficients shown in FIG. 27 are used in the expression (14). Thus, the surface shape on the optical disc 15 side of the pickup lens 14 according to the example 4 is specified by the coefficients shown in FIG. 27 and the expression (14). As shown in FIG. 27, the surface on the optical disc 15 side of the pickup lens 14 according to the example 4 has a single aspherical shape.

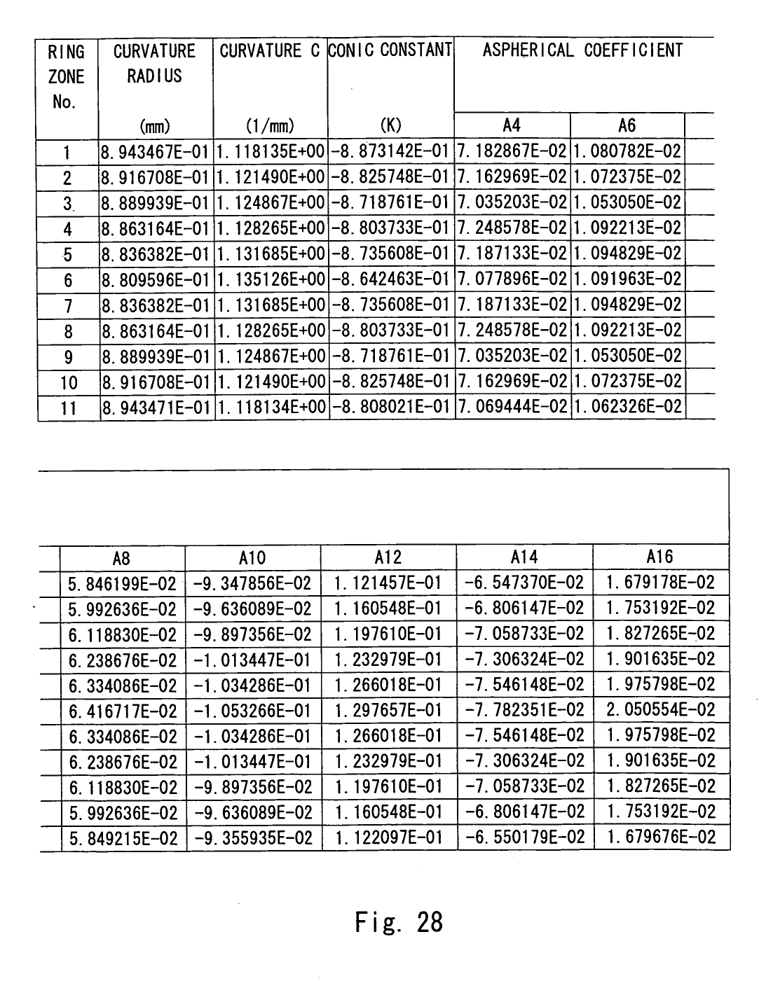

The table of FIG. 28 shows the coefficients that specify the shape of a surface (plane number 2) on the light source 11 side of the pickup lens 14 according to the example 4. The coefficients shown in FIG. 28 are used in the expression (15). Thus, the surface shape on the light source 11 side of the pickup lens 14 according to the example 4 is specified by the coefficients shown in FIG. 28 and the expression (15). As shown in FIG. 28, the surface on the light source 11 side of the pickup lens 14 according to the example 4 has different aspherical shapes in the respective ring zones.

### Example 5

An example 5 according to an embodiment of the present invention is described hereinafter. The pickup lens 14 according to the example 5 has a plurality of steps on the surface facing the light source 11 (not shown).

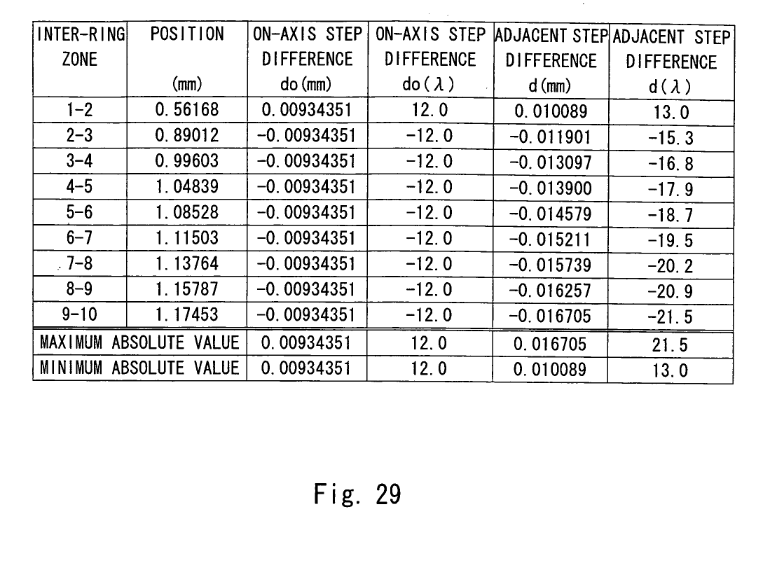

The table of FIG. 29 shows the numbers of the ring zones, the positions of the ring zones, the on-axis step differences and the adjacent step differences of the pickup lens 14 according to the example 5.

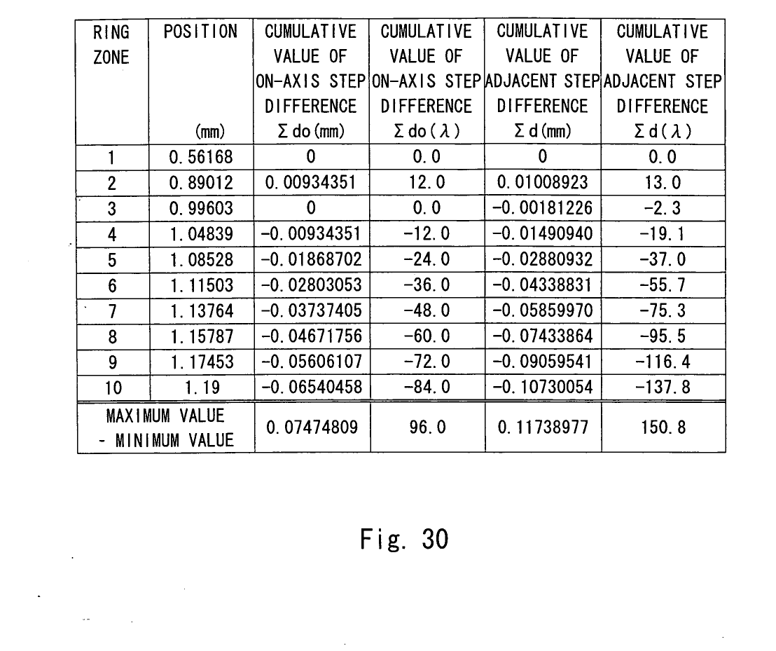

Further, the table of FIG. 30 shows the numbers of the ring zones, the positions of the ring zones, the cumulative values of on-axis step differences and the cumulative values of adjacent step differences.

As shown in FIG. 29, ten ring zones are formed on the pickup lens 14 according to the example 5. Thus, the ring zone at the center is the fifth and the sixth ring zones. The on-axis step difference increases by about 0.009343 mm each (about 12λ each) from the first ring zone to the second ring zone, and the on-axis step difference decreases by about 0.009343 mm each (about 12λ each) from the second ring zone to the tenth ring zone. Further, the adjacent step difference increases from the first ring zone to the second ring zone, and the adjacent step difference decreases from the second ring zone to the tenth ring zone. In other words, the steps are formed in such a way that the lens thickness of the pickup lens 14 gradually becomes thinner in the range from the first ring zone to the second ring zone, and the lens thickness of the pickup lens 14 gradually becomes thicker in the range from the second ring zones to the tenth ring zone.

Note that about 0.009343 mm=about 12λ, where λ indicates the wavelength. Thus, the on-axis step difference formed on the pickup lens 14 according to the example 5 is about twelve times the design wavelength.

As shown in FIG. 30, the maximum value of the cumulative value of the on-axis step difference is 12.0λ, and the minimum value of the cumulative value of the on-axis step difference is −84.0λ. Accordingly, a difference between the maximum value and the minimum value of the on-axis step difference is 96.0λ.

Further, as shown in FIG. 30, the maximum value of the cumulative value of the adjacent step difference is 13.0λ, and the minimum value of the cumulative value of the adjacent step difference is −137.8λ. Accordingly, a difference between the maximum value and the minimum value of the adjacent step difference is 150.8λ.

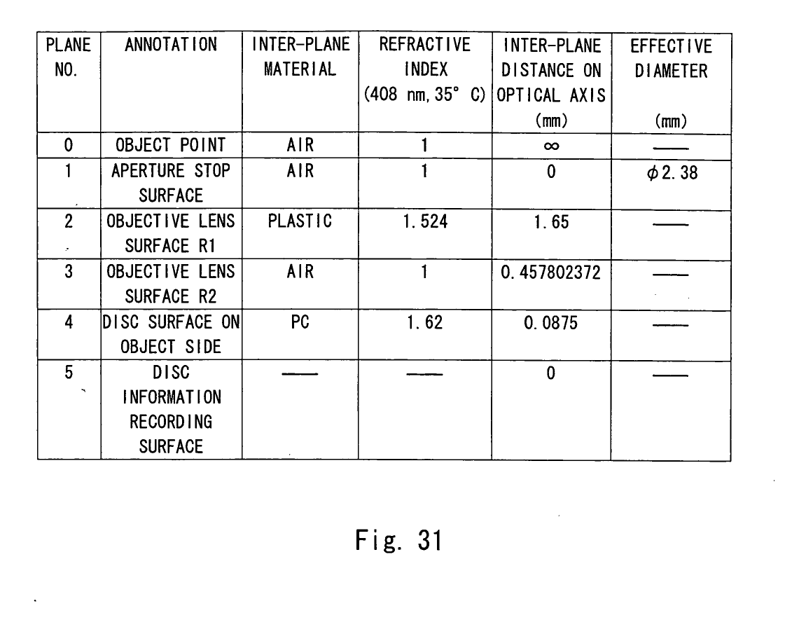

The table of FIG. 31 shows the data of the optical pickup system 1 according to the example 5. As shown in FIG. 31, a plastic lens is used as the pickup lens 14 according to the example 5. The working distance (WD) is the distance between the surface of the pickup lens 14 facing the optical disc 15 (the objective lens surface R2) and the surface of the optical disc 15 facing the light source 11 (the object-side surface), and it is about 0.46 mm. The focal length is 1.4 mm.

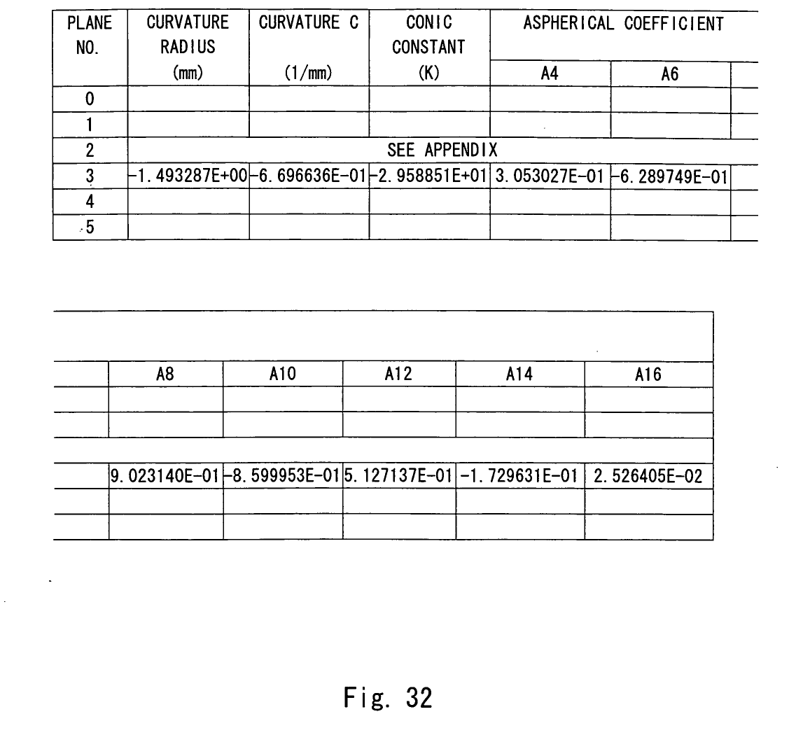

Thus, the shape of a surface (plane number 3) on the optical disc 15 side of the pickup lens 14 according to the example 5 is the same as that of the surface on the optical disc 15 side of the pickup lens 14 according to the example 4, and it is specified by the coefficients shown in FIG. 32 and the expression (14). As shown in FIG. 32, the surface on the optical disc 15 side of the pickup lens 14 according to the example 5 has a single aspherical shape.

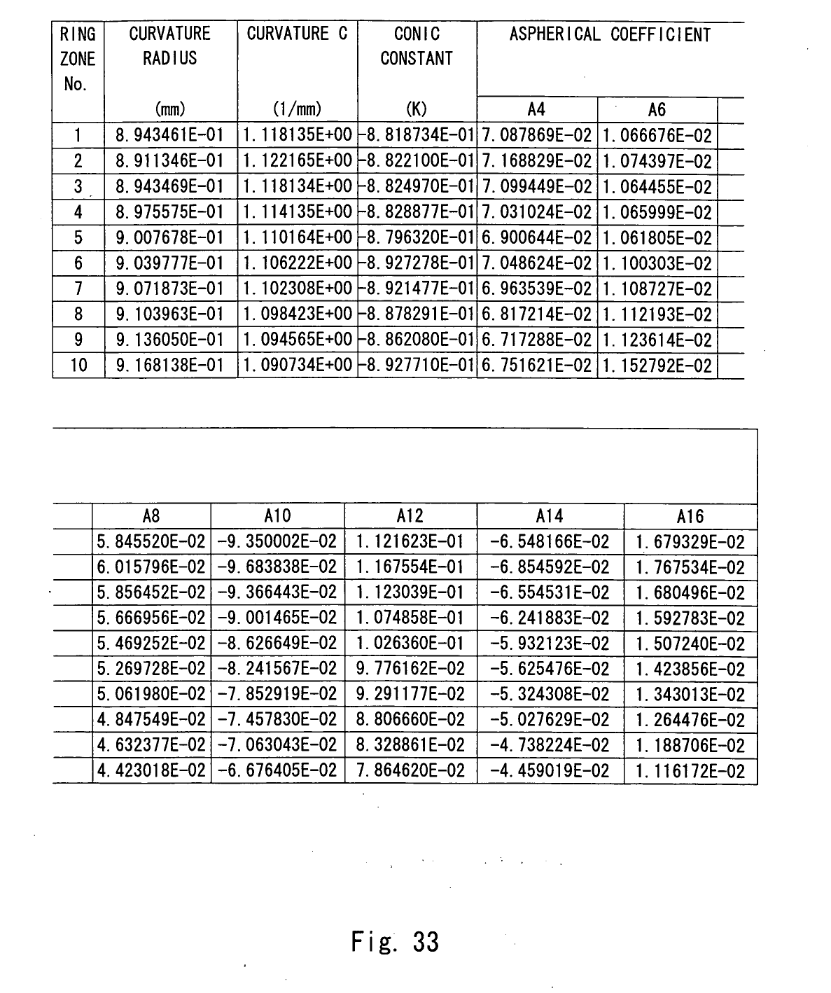

The table of FIG. 33 shows the coefficients that specify the shape of a surface (plane number 2) on the light source 11 side of the pickup lens 14 according to the example 5. The coefficients shown in FIG. 33 are used in the expression (15). Thus, the surface shape on the light source 11 side of the pickup lens 14 according to the example 5 is specified by the coefficients shown in FIG. 33 and the expression (15). As shown in FIG. 33, the surface on the light source 11 side of the pickup lens 14 according to the example 5 has different aspherical shapes in the respective ring zones.

### Example 6

An example 6 according to an embodiment of the present invention is described hereinafter. The pickup lens 14 according to the example 6 has a plurality of steps on the surface facing the light source 11 (not shown).

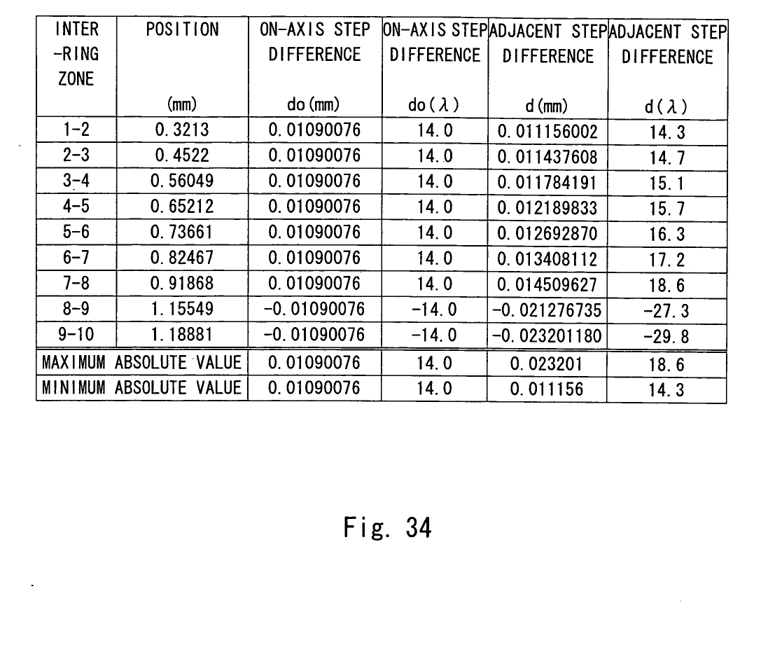

The table of FIG. 34 shows the numbers of the ring zones, the positions of the ring zones, the on-axis step differences and the adjacent step differences of the pickup lens 14 according to the example 6.

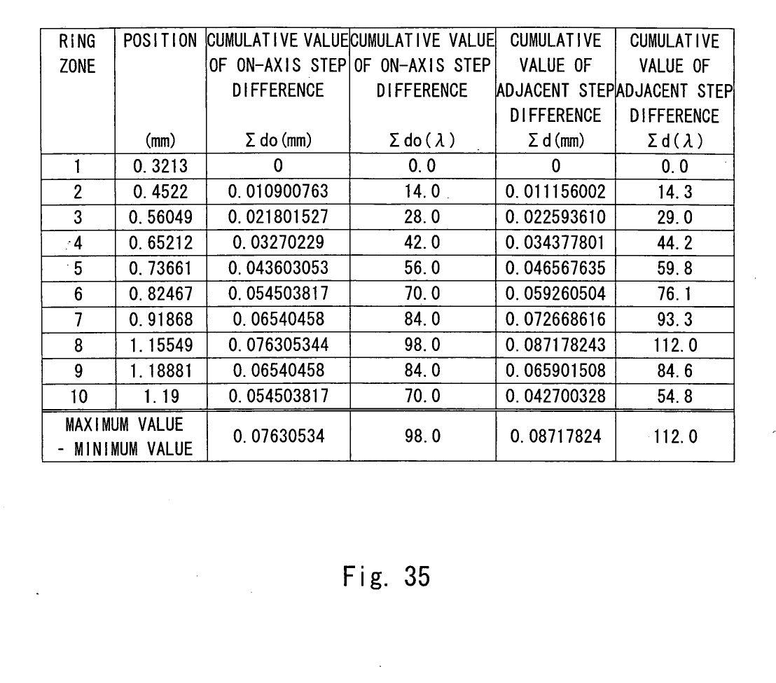

Further, the table of FIG. 35 shows the numbers of the ring zones, the positions of the ring zones, the cumulative values of on-axis step differences and the cumulative values of adjacent step differences.

As shown in FIG. 34, ten ring zones are formed on the pickup lens 14 according to the example 6. Thus, the ring zone at the center is the fifth and the sixth ring zones. The on-axis step difference increases by about 0.010900 mm each (about 14λ each) from the first ring zone to the eighth ring zone, and the on-axis step difference decreases by about 0.010900 mm each (about 14λ each) from the eighth ring zone to the tenth ring zone. Further, the adjacent step difference increases from the first ring zone to the eighth ring zone, and the adjacent step difference decreases from the eighth ring zone to the tenth ring zone. In other words, the steps are formed in such a way that the lens thickness of the pickup lens 14 gradually becomes thinner in the range from the first ring zone to the eighth ring zone, and the lens thickness of the pickup lens 14 gradually becomes thicker in the range from the eighth ring zones to the tenth ring zone.

Note that about 0.010900 mm=about 14λ, where λ indicates the wavelength. Thus, the on-axis step difference formed on the pickup lens 14 according to the example 6 is about fourteen times the design wavelength.

As shown in FIG. 35, the maximum value of the cumulative value of the on-axis step difference is 98.0λ, and the minimum value of the cumulative value of the on-axis step difference is 0.0λ. Accordingly, a difference between the maximum value and the minimum value of the on-axis step difference is 98.0λ.

Further, as shown in FIG. 35, the maximum value of the cumulative value of the adjacent step difference is 112.0λ, and the minimum value of the cumulative value of the adjacent step difference is 0.0λ. Accordingly, a difference between the maximum value and the minimum value of the adjacent step difference is 112.0λ.

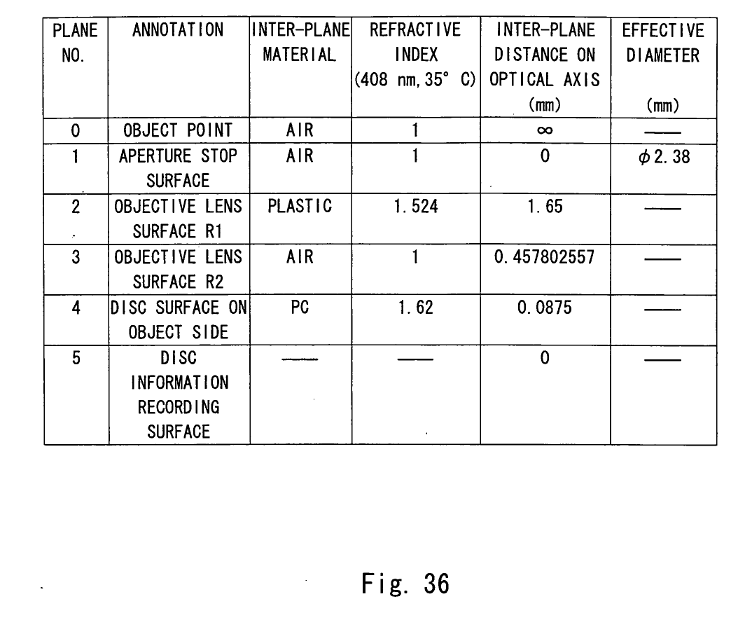

The table of FIG. 36 shows the data of the optical pickup system 1 according to the example 6. As shown in FIG. 36, a plastic lens is used as the pickup lens 14 according to the example 6. The working distance (WD) is the distance between the surface of the pickup lens 14 facing the optical disc 15 (the objective lens surface R2) and the surface of the optical disc 15 facing the light source 11 (the object-side surface), and it is about 0.46 mm. The focal length is 1.4 mm.

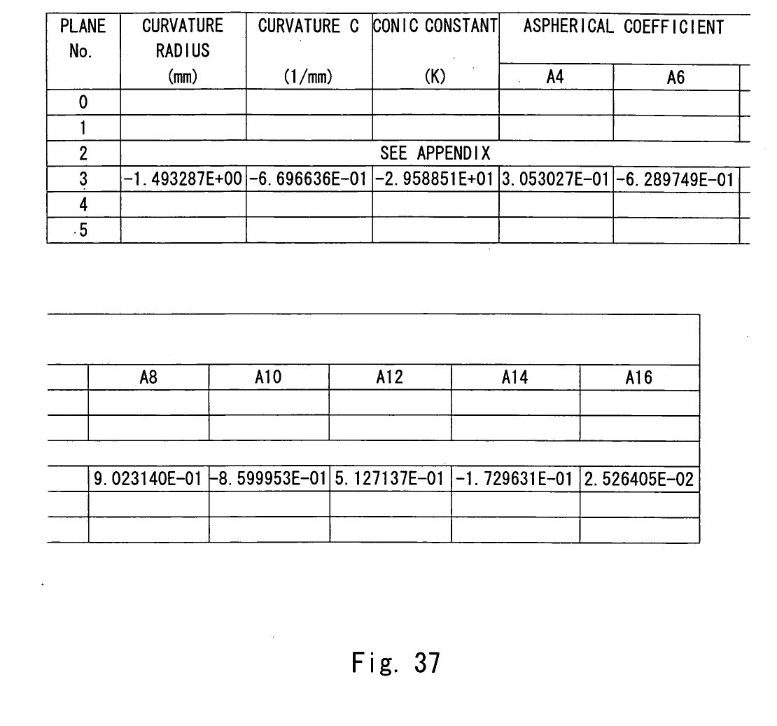

Thus, the shape of a surface (plane number 3) on the optical disc 15 side of the pickup lens 14 according to the example 6 is the same as that of the surface on the optical disc 15 side of the pickup lens 14 according to the example 4, and it is specified by the coefficients shown in FIG. 37 and the expression (14). As shown in FIG. 37, the surface on the optical disc 15 side of the pickup lens 14 according to the example 6 has a single aspherical shape.

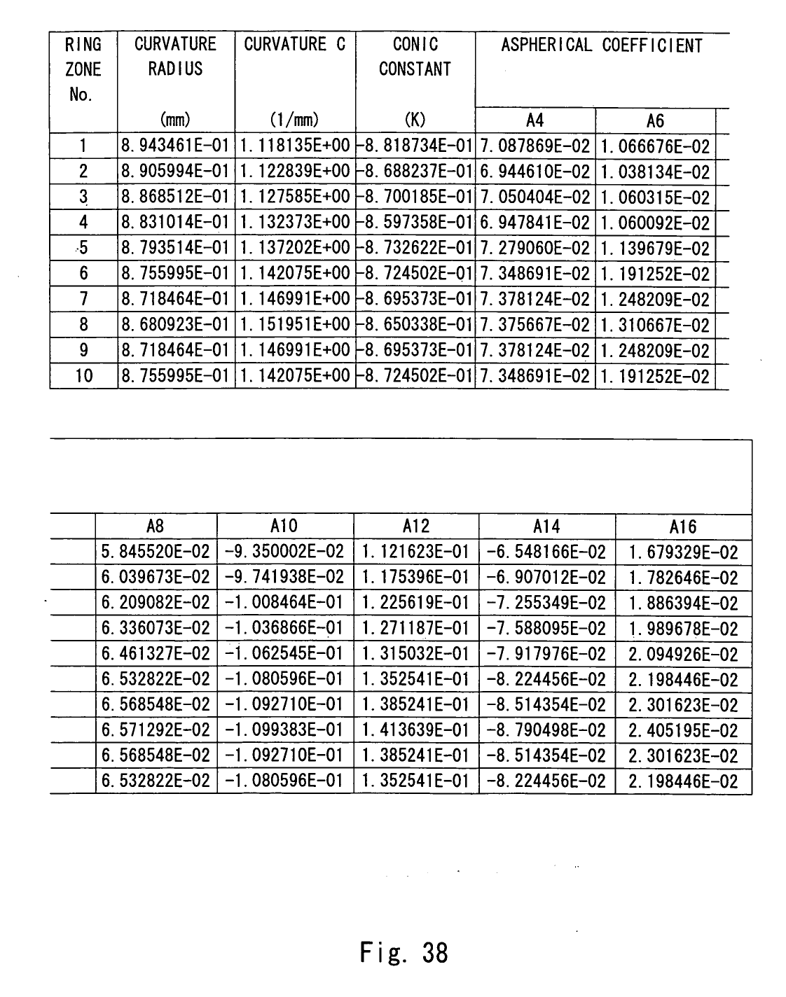

The table of FIG. 38 shows the coefficients that specify the shape of a surface (plane number 2) on the light source 11 side of the pickup lens 14 according to the example 6. The coefficients shown in FIG. 38 are used in the expression (15). Thus, the surface shape on the light source 11 side of the pickup lens 14 according to the example 6 is specified by the coefficients shown in FIG. 38 and the expression (15). As shown in FIG. 38, the surface on the light source 11 side of the pickup lens 14 according to the example 6 has different aspherical shapes in the respective ring zones.

### Comparative Example 1

A comparative example 1 is described hereinafter. A pickup lens according to the comparative example 1 does not have steps on either the surface facing the light source or the surface facing the optical disc.

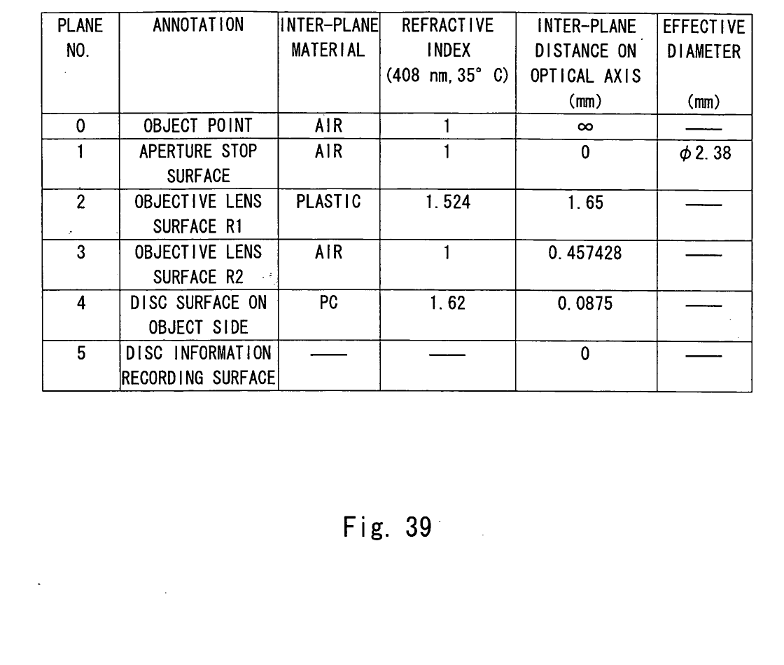

The table of FIG. 39 shows the data of an optical pickup system according to the comparative example 1. As shown in FIG. 39, a plastic lens is used as the pickup lens according to the comparative example 1. The working distance (WD) is the distance between the surface of the pickup lens facing the optical disc (the objective lens surface R2) and the surface of the optical disc facing the light source (the object-side surface), and it is about 0.46 mm. The focal length is 1.4 mm.

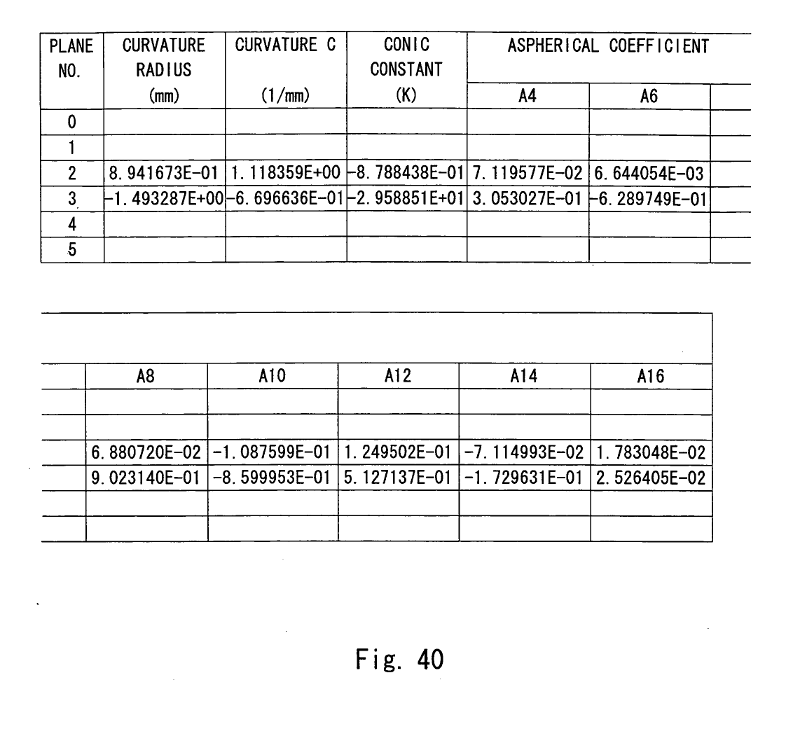

The table of FIG. 40 shows the coefficients that specify the shape of a surface (plane number 2) on the light source side and the shape of a surface (plane number 3) on the optical disc side of the pickup lens according to the comparative example 1. The coefficients shown in FIG. 40 are used in the expression (14). Thus, the surface shape on the light source side and the surface shape on the optical disc side of the pickup lens according to the comparative example 1 are specified by the coefficients shown in FIG. 40 and the expression (14). As shown in FIG. 40, the surface on the light source side and the surface on the optical disc side of the pickup lens according to the comparative example 1 have a single aspherical shape.

The aberration occurring due to a change in ambient temperature in the cases of using the pickup lens 14 according to the examples 1 to 6 and the pickup lens according to the comparative example 1 is described hereinafter. The design temperature of the pickup lens 14 according to the examples 1 to 6 and the pickup lens according to the comparative example 1 is 35° C. In this embodiment, the case where the ambient temperature changes by ±15° C. from the design temperature of 35° C. is described by way of illustration.

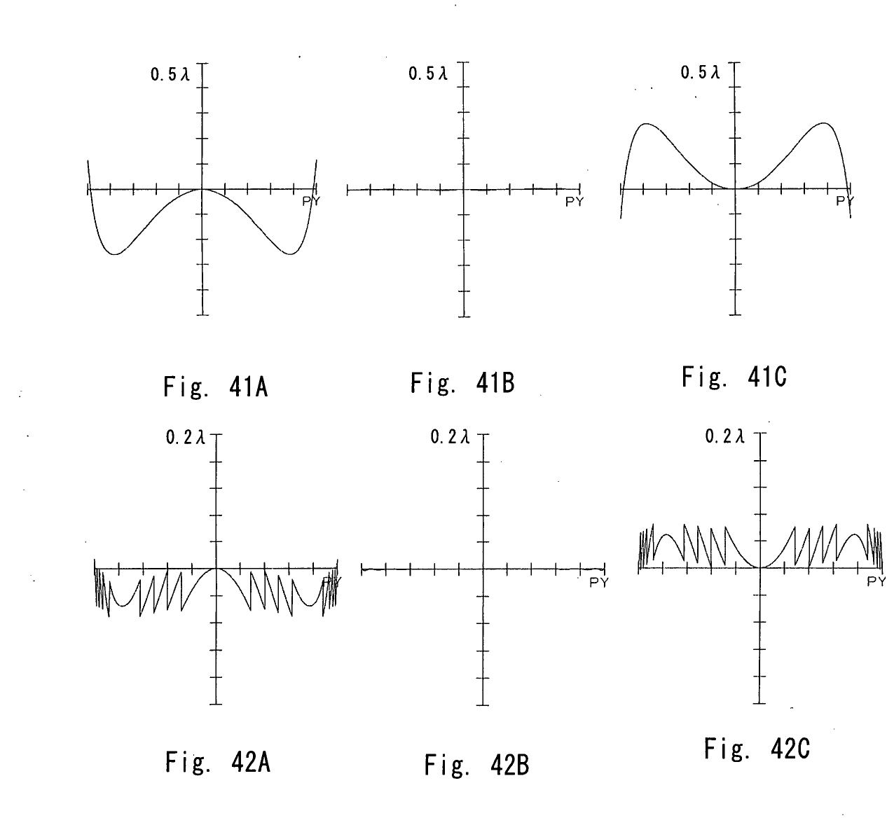

FIGS. 41A to 41C show the wavefront aberration that occurs when the ambient temperature is 20° C., 35° C. and 50° C. in the case of using the pickup lens according to the comparative example 1. As shown in FIG. 41, when using pickup lens according to the comparative example 1, the aberration exceeds the Marechal Criterion (70 mλrms) if the ambient temperature changes by ±15° C. from the design temperature of 35° C.

Specifically, when the ambient temperature changes by −15° C. from the design temperature of 35° C. and becomes 20° C., the total wavefront aberration (rms) becomes 91.0 mλ, and when the ambient temperature changes by +15° C. from the design temperature of 35° C. and becomes 50° C., the total wavefront aberration (rms) becomes 90.7 mλ, which exceeds 35 mλ. In the case of using the pickup lens according to the comparative example 1, the total wavefront aberration (rms) when the ambient temperature is 35° C. is 1.5 mλ. Further, a defocusing amount changes with temperature change, and the defocusing amount at an ambient temperature of 20° C. is −4.361 μm, and the defocusing amount at an ambient temperature of 50° C. is +4.391 μm. The design wavelength of the light source 11 at a design temperature of 35° C. is 408 nm. The wavelength of the light source 11 changes as the ambient temperature changes, and the wavelength of the light source 11 at an ambient temperature of 20° C. is 407.1 nm, and the wavelength of the light source 11 at an ambient temperature of 50° C. is 408.9 nm.

The defocusing amount is the amount of displacement from the focal position at an ambient temperature of 35° C. For example, in the case of using the pickup lens according to the comparative example 1, the defocusing amount at an ambient temperature of 20° C. and a wavelength of 407.1 nm is −4.361 μm. From the table shown in FIG. 39, the inter-plane distance (working distance (WD)) between the surface (the plane number 3) of the pickup lens 14 facing the optical disc and the surface (the object-side surface: the plane number 4) of the optical disc 15 facing the light source 11 is 0.457-428 mm at an ambient temperature of 35° C. Accordingly, the inter-plane distance between the surface with the plane number 3 and the surface with the plane number 4 at an ambient temperature of 20° C. is 0.457-428-0.004361=0.453067 mm. Thus, the inter-plane distance between the surface with the plane number 3 and the surface with the plane number 4 under each condition can be calculated based on the defocusing amount in each condition.

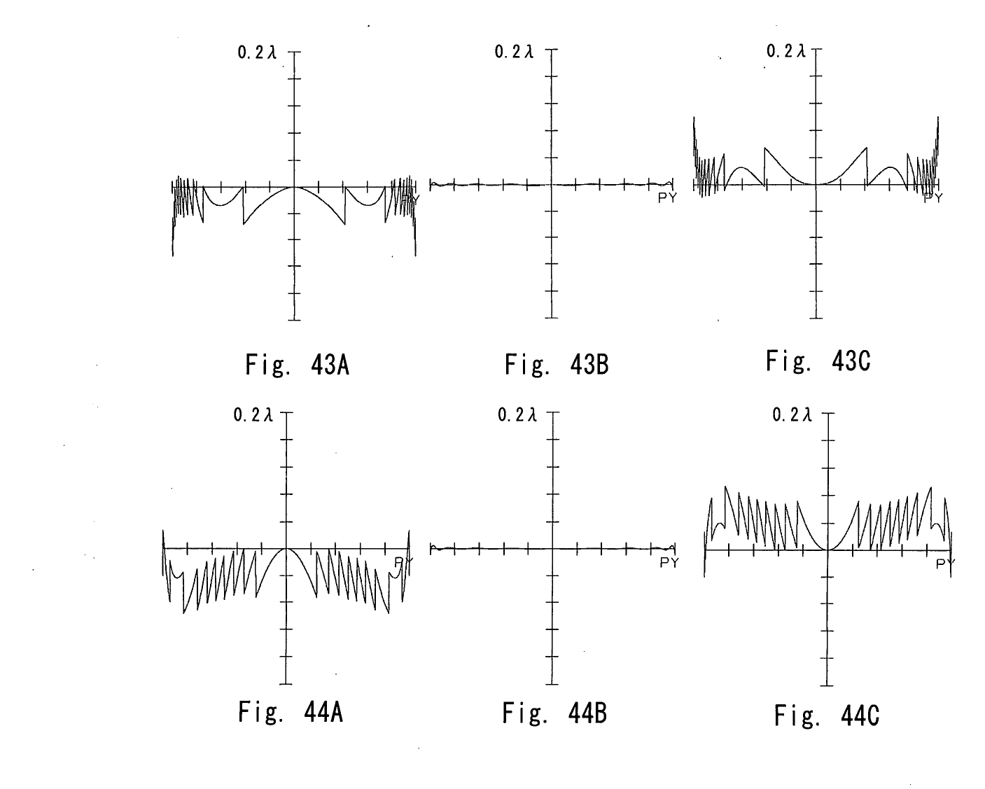

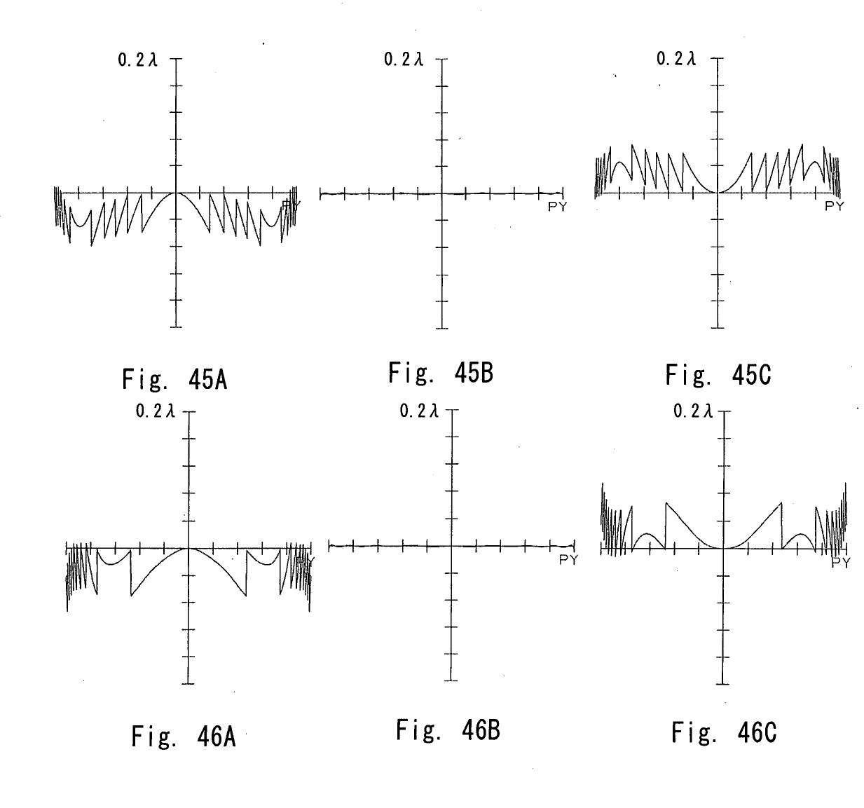

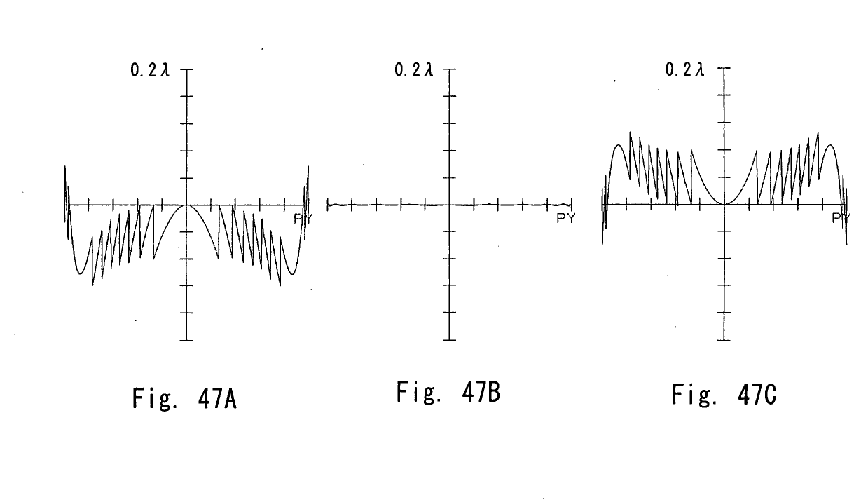

FIGS. 42A to 42C show the wavefront aberration that occurs when the ambient temperature is 20° C., 35° C. and 50° C. in the case of using the pickup lens 14 according to the example 1. FIGS. 43A to 43C show the wavefront aberration that occurs when the ambient temperature is 20° C., 35° C. and 50° C. in the case of using the pickup lens 14 according to the example 2. FIGS. 44A to 44C show the wavefront aberration that occurs when the ambient temperature is 20° C., 35° C. and 50° C. in the case of using the pickup lens 14 according to the example 3. FIGS. 45A to 45C show the wavefront aberration that occurs when the ambient temperature is 20° C., 35° C. and 50° C. in the case of using the pickup lens 14 according to the example 4. FIGS. 46A to 46C show the wavefront aberration that occurs when the ambient temperature is 20° C., 35° C. and 50° C. in the case of using the pickup lens 14 according to the example 5. FIGS. 47A to 47C show the wavefront aberration that occurs when the ambient temperature is 20° C., 35° C. and 50° C. in the case of using the pickup lens 14 according to the example 6.

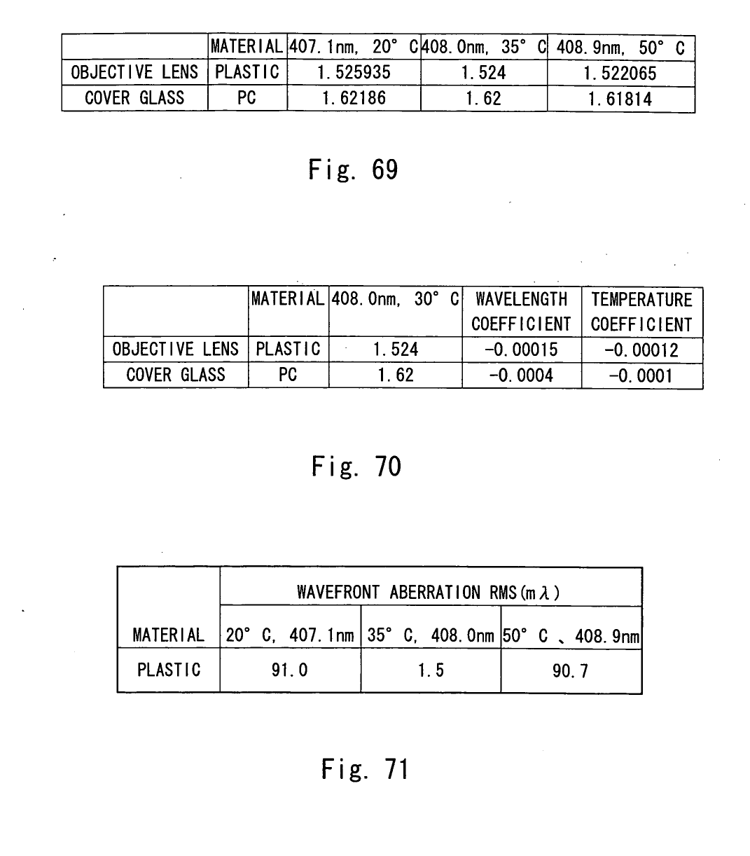

Specifically, in the case of using the pickup lens 14 according to the example 1, when the ambient temperature changes by −15° C. from the design temperature of 35° C. (when it becomes 20° C.), the total wavefront aberration (rms) becomes 16.6 mλ, and when the ambient temperature changes by +15° C. from the design temperature of 35° C. (when it becomes 50° C.), the total wavefront aberration (rms) becomes 15.7 mλ, which is below 35 mλ. In the case of using the pickup lens 14 according to the example 1, the total wavefront aberration (rms) when the ambient temperature is 35° C. is 0.6 mλ. Further, a defocusing amount changes with temperature change, and the defocusing amount at an ambient temperature of 20° C. is −4.462 μm, and the defocusing amount at an ambient temperature of 50° C. is +4.494 μm. FIG. 69 shows the refractive index of the pickup lens 14 and the optical disc 15, and FIG. 70 shows the rate of change in the refractive index of the pickup lens 14 and the optical disc 15.

In the case of using the pickup lens 14 according to the example 2, when the ambient temperature changes by −15° C. from the design temperature of 35° C. (when it becomes 20° C.), the total wavefront aberration (rms) becomes 17.7 mλ, and when the ambient temperature changes by +15° C. from the design temperature of 35° C. (when it becomes 50° C.), the total wavefront aberration (rms) becomes 19.3 mλ, which is below 35 mλ. In the case of using the pickup lens 14 according to the example 2, the total wavefront aberration (rms) when the ambient temperature is 35° C. is 1.3 mλ. Further, a defocusing amount changes with temperature change, and the defocusing amount at an ambient temperature of 20° C. is −3.991 μm, and the defocusing amount at an ambient temperature of 50° C. is +4.032 μm.

In the case of using the pickup lens 14 according to the example 3, when the ambient temperature changes by −15° C. from the design temperature of 35° C. (when it becomes 20° C.), the total wavefront aberration (rms) becomes 24.0 mλ, and when the ambient temperature changes by +15° C. from the design temperature of 35° C. (when it becomes 50° C.), the total wavefront aberration (rms) becomes 22.8 mλ, which is below 35 mλ. In the case of using the pickup lens 14 according to the example 3, the total wavefront aberration (rms) when the ambient temperature is 35° C. is 1.5 mλ. Further, a defocusing amount changes with temperature change, and the defocusing amount at an ambient temperature of 20° C. is −4.923 μm, and the defocusing amount at an ambient temperature of 50° C. is +4.961 μm.

In the case of using the pickup lens 14 according to the example 4, when the ambient temperature changes by −15° C. from the design temperature of 35° C. (when it becomes 20° C.), the total wavefront aberration (rms) becomes 17.7 mλ, and when the ambient temperature changes by +15° C. from the design temperature of 35° C. (when it becomes 50° C.), the total wavefront aberration (rms) becomes 16.5 mλ, which is below 35 mλ. In the case of using the pickup lens 14 according to the example 4, the total wavefront aberration (rms) when the ambient temperature is 35° C. is 0.8 mλ. Further, a defocusing amount changes with temperature change, and the defocusing amount at an ambient temperature of 20° C. is −4.454 μm, and the defocusing amount at an ambient temperature of 50° C. is +4.486 μm.

In the case of using the pickup lens 14 according to the example 5, when the ambient temperature changes by −15° C. from the design temperature of 35° C. (when it becomes 20° C.), the total wavefront aberration (rms) becomes 20.3 mλ, and when the ambient temperature changes by +15° C. from the design temperature of 35° C. (when it becomes 50° C.), the total wavefront aberration (rms) becomes 21.0 mλ, which is below 35 mλ. In the case of using the pickup lens 14 according to the example 5, the total wavefront aberration (rms) when the ambient temperature is 35° C. is 0.9 mλ. Further, a defocusing amount changes with temperature change, and the defocusing amount at an ambient temperature of 20° C. is −4.019 μm, and the defocusing amount at an ambient temperature of 50° C. is +4.046 μm.

In the case of using the pickup lens 14 according to the example 6, when the ambient temperature changes by −15° C. from the design temperature of 35° C. (when it becomes 20° C.), the total wavefront aberration (rms) becomes 34.3 mλ, and when the ambient temperature changes by +15° C. from the design temperature of 35° C. (when it becomes 50° C.), the total wavefront aberration (rms) becomes 31.5 mλ, which is below 35 mλ. In the case of using the pickup lens 14 according to the example 6, the total wavefront aberration (rms) when the ambient temperature is 35° C. is 0.8 mλ. Further, a defocusing amount changes with temperature change, and the defocusing amount at an ambient temperature of 20° C. is −4.848 μm, and the defocusing amount at an ambient temperature of 50° C. is +4.877 μm.

Hereinafter, the off-axis characteristics of the pickup lens 14 according to the examples 1 to 6 are described. The ambient temperature is 35° C.

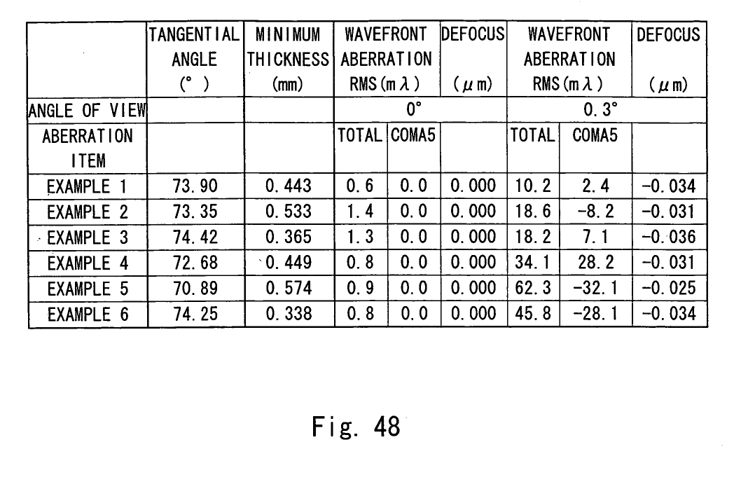

The table of FIG. 48 shows the tangential angle θ_{M}, the minimum thickness tₘ, the aberration items in the range of the angle of view of 0°, and the aberration items in the range of the angle of view of 0.3° in the examples 1 to 6. In FIG. 48, the total wavefront aberration, COMA5 and the defocusing amount are shown as the aberration items.

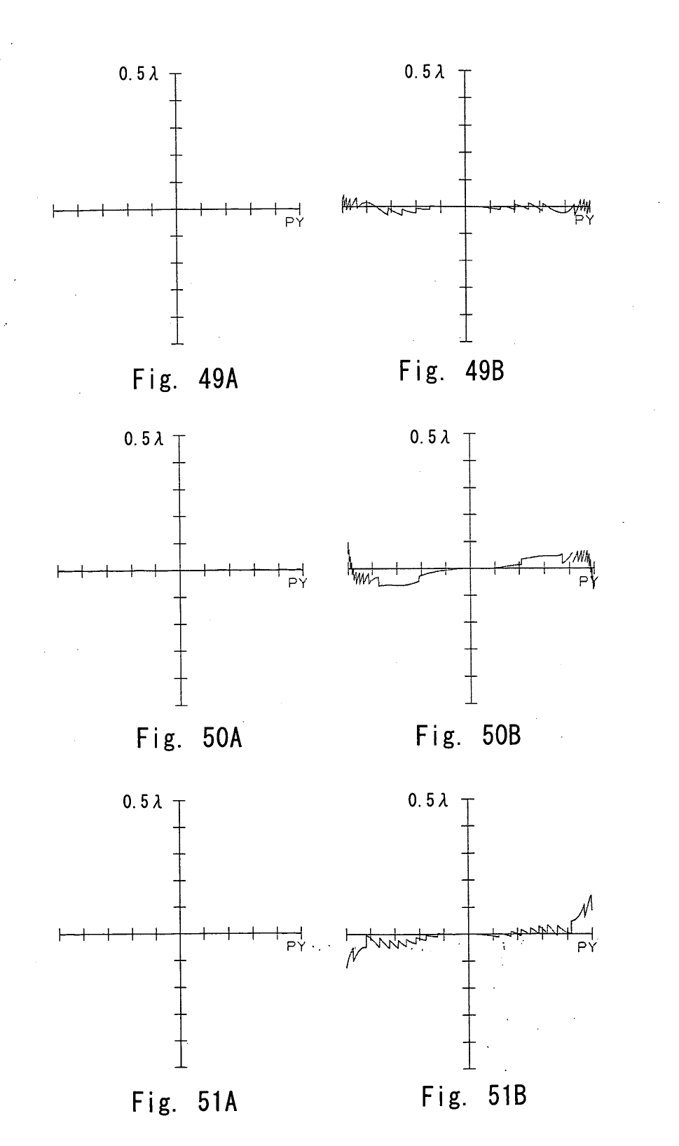

Further, the graphs of FIGS. 49 to 54 show the wavefront aberration in the range of the angle of view of 0° and in the range of the angle of view of 0.30 in the examples 1 to 6.

FIG. 49A shows the wavefront aberration in the range of the angle of view of 0° of the pickup lens 14 according to the example 1. FIG. 49B shows the wavefront aberration in the range of the angle of view of 0.3° of the pickup lens 14 according to the example 1. As shown in FIG. 49, an increase in the wavefront aberration in the range of the angle of view of 0.3° of the pickup lens 14 according to the example 1 is suppressed. Specifically, the total wavefront aberration (rms) at the angle of view of 0° is 0.6 mλ, and the total wavefront aberration (rms) at the angle of view of 0.3° is 10.2 mλ. Thus, the total wavefront aberration (rms) at the angle of view of 0.3° of the pickup lens 14 according to the example 1 is suppressed to be equal to or smaller than 35 mλ. Therefore, the off-axis characteristics of the pickup lens 14 according to the example 1 are suitable.

FIG. 50A shows the wavefront aberration in the range of the angle of view of 0° of the pickup lens 14 according to the example 2. FIG. 50B shows the wavefront aberration in the range of the angle of view of 0.3° of the pickup lens 14 according to the example 2. As shown in FIG. 50, an increase in the wavefront aberration in the range of the angle of view of 0.3° of the pickup lens 14 according to the example 2 is suppressed. Specifically, the total wavefront aberration (rms) at the angle of view of 0° is 1.4 mλ, and the total wavefront aberration (rms) at the angle of view of 0.3° is 18.6 mλ. Thus, the total wavefront aberration (rms) at the angle of view of 0.3° of the pickup lens 14 according to the example 2 is suppressed to be equal to or smaller than 35 mλ. Therefore, the off-axis characteristics of the pickup lens 14 according to the example 2 are suitable.

FIG. 51A shows the wavefront aberration in the range of the angle of view of 0° of the pickup lens 14 according to the example 3. FIG. 51B shows the wavefront aberration in the range of the angle of view of 0.3° of the pickup lens 14 according to the example 3. As shown in FIG. 51, an increase in the wavefront aberration in the range of the angle of view of 0.3° of the pickup lens 14 according to the example 3 is suppressed. Specifically, the total wavefront aberration (rms) at the angle of view of 0° is 1.3 mλ, and the total wavefront aberration (rms) at the angle of view of 0.3° is 18.2 mλ. Thus, the total wavefront aberration (rms) at the angle of view of 0.30 of the pickup lens 14 according to the example 3 is suppressed to be equal to or smaller than 35 mλ. Therefore, the off-axis characteristics of the pickup lens 14 according to the example 3 are suitable.

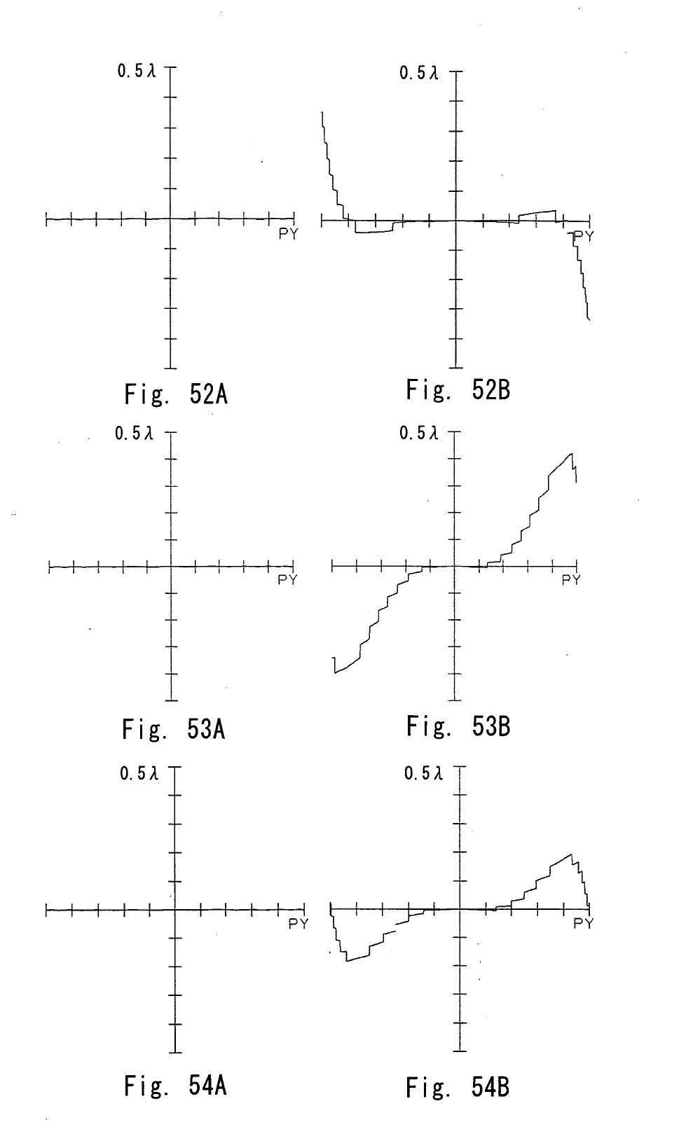

FIG. 52A shows the wavefront aberration in the range of the angle of view of 0° of the pickup lens 14 according to the example 4. FIG. 52B shows the wavefront aberration in the range of the angle of view of 0.3° of the pickup lens 14 according to the example 4. As shown in FIG. 52, an increase in the wavefront aberration in the range of the angle of view of 0.3° of the pickup lens 14 according to the example 4 is suppressed. Specifically, the total wavefront aberration (rms) at the angle of view of 0° is 0.8 mλ, and the total wavefront aberration (rms) at the angle of view of 0.3° is 34.1 mλ. Thus, the total wavefront aberration (rms) at the angle of view of 0.3° of the pickup lens 14 according to the example 4 is suppressed to be equal to or smaller than 35 mλ. Therefore, the off-axis characteristics of the pickup lens 14 according to the example 4 are suitable.

FIG. 53A shows the wavefront aberration in the range of the angle of view of 0° of the pickup lens 14 according to the example 5. FIG. 53B shows the wavefront aberration in the range of the angle of view of 0.3° of the pickup lens 14 according to the example 5. As shown in FIG. 53, the wavefront aberration in the range of the angle of view of 0.3° of the pickup lens 14 according to the example 5 increases. Specifically, the total wavefront aberration (rms) at the angle of view of 0° is 0.9 mλ, and the total wavefront aberration (rms) at the angle of view of 0.3° is 62.3 mλ. Thus, the total wavefront aberration (rms) at the angle of view of 0.3° of the pickup lens 14 according to the example 5 exceeds 35 mλ. Therefore, the off-axis characteristics of the pickup lens 14 according to the example 5 are deteriorated.

FIG. 54A shows the wavefront aberration in the range of the angle of view of 0° of the pickup lens 14 according to the example 6. FIG. 54B shows the wavefront aberration in the range of the angle of view of 0.3° of the pickup lens 14 according to the example 6. As shown in FIG. 54, the wavefront aberration in the range of the angle of view of 0.3° of the pickup lens 14 according to the example 6 increases. Specifically, the total wavefront aberration (rms) at the angle of view of 0° is 0.8 mλ, and the total wavefront aberration (rms) at the angle of view of 0.3° is 45.8 mλ. Thus, the total wavefront aberration (rms) at the angle of view of 0.3° of the pickup lens 14 according to the example 6 exceeds 35 mλ. Therefore, the off-axis characteristics of the pickup lens 14 according to the example 6 are deteriorated.

Further, as shown in FIG. 48, the absolute value of COMA5 in the range of the angle of view of 0.3° is equal to or smaller than 0.010λrms in the examples 1 to 3. On the other hand, the absolute value of COMA5 in the range of the angle of view of 0.30 is larger than 0.010 Arms in the examples 4 to 6.

The offense against sine condition of the pickup lens 14 according to the examples 1 to 6 is described hereinafter.

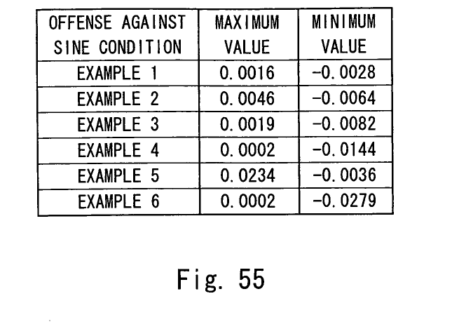

The table of FIG. 55 shows the offense against sine condition in the examples 1 to 6. The offense against sine condition is calculated by the expression (13).

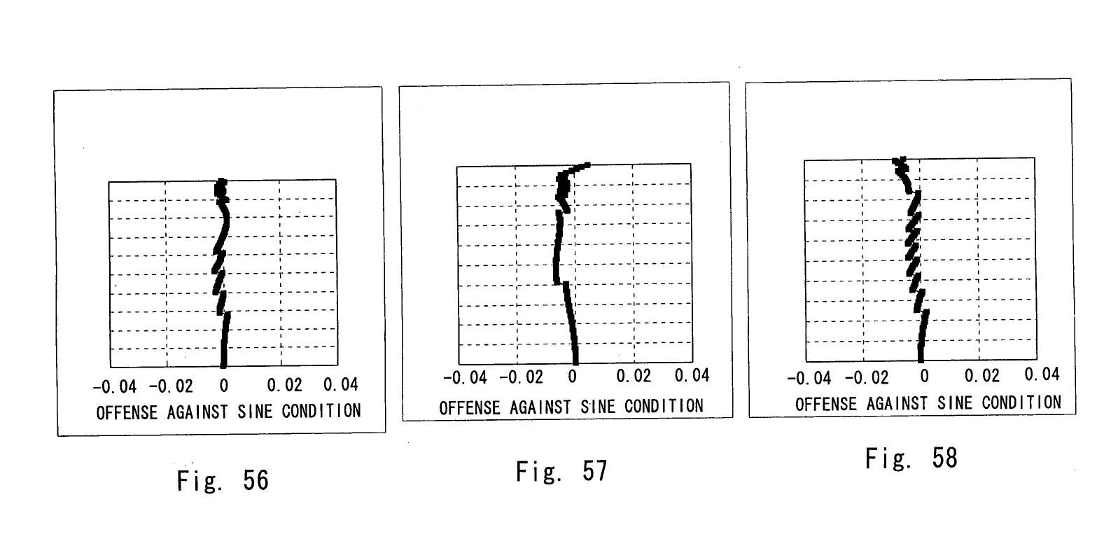

The graphs of FIGS. 56 to 61 show the offense against sine condition in the examples 1 to 6. In FIGS. 56 to 61, the horizontal axis indicates the offense against sine condition, and the vertical axis indicates the beam height.

As shown in FIGS. 56 to 58, the offense against sine condition is suppressed to be small in the examples 1 to 3. Specifically, the maximum value and the minimum value of the offense against sine condition in the example 1 are 0.0016 and −0.0028, respectively, and the absolute value of the offense against sine condition is below 0.01. Further, the maximum value and the minimum value of the offense against sine condition in the example 2 are 0.0046 and −0.0064, respectively, and the absolute value of the offense against sine condition is below 0.01. The maximum value and the minimum value of the offense against sine condition in the example 3 are 0.0019 and −0.0082, respectively, and the absolute value of the offense against sine condition is below 0.01.

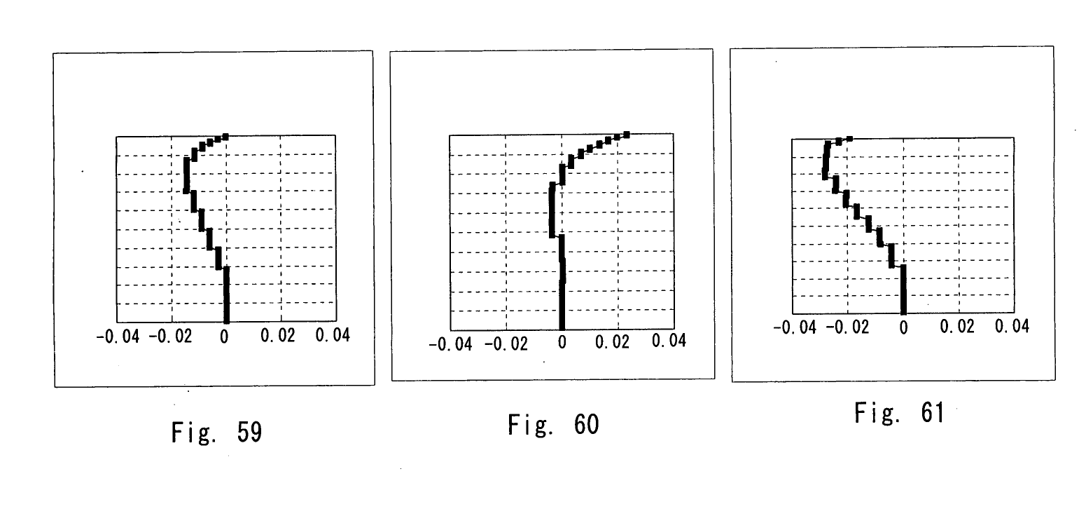

On the other hand, as shown in FIGS. 59 to 61, the offense against sine condition increases in the examples 4 to 6. Specifically, the maximum value and the minimum value of the offense against sine condition in the example 4 are 0.0002 and −0.0144, respectively, and the absolute value of the offense against sine condition exceeds 0.01. Further, the maximum value and the minimum value of the offense against sine condition in the example 5 are 0.0234 and −0.0036, respectively, and the absolute value of the offense against sine condition exceeds 0.01. The maximum value and the minimum value of the offense against sine condition in the example 6 are 0.0002 and −0.0279, respectively, and the absolute value of the offense against sine condition exceeds 0.01.

As shown in FIG. 48, the total wavefront aberration (rms) at the angle of view of 0.3° of the pickup lens 14 according to the examples 1 to 4 is equal to or smaller than 35 mλ. Particularly, in the pickup lens 14 according to the examples 1 to 3, the total wavefront aberration (rms) in the range of the angle of view of 0.3° is more suitable compared to that in the pickup lens 14 according to the example 4. As shown in FIG. 48, the pickup lens 14 according to the examples 1 to 3 is different from the pickup lens 14 according to the example 4 in that the tangential angle θ_{M} is equal to or larger than 73°. Further, the pickup lens 14 according to the examples 1 to 3 is different from the pickup lens 14 according to the example 4 in that the absolute value of COMA5 in the range of the angle of view of 0.3° is equal to or smaller than 0.010 Arms. Furthermore, as shown in FIG. 55, the pickup lens 14 according to the examples 1 to 3 is different from the pickup lens 14 according to the example 4 in that the absolute value of the offense against sine condition is equal to or smaller than 0.01. Therefore, by forming the steps in such a way that the tangential angle θ_{M} is equal to or larger than 73°, the absolute value of COMA5 in the range of the angle of view of 0.3° is equal to or smaller than 0.010λrms, and the absolute value of the offense against sine condition is equal to or smaller than 0.01, it is possible to reduce the total wavefront aberration (rms) at off-axis of the pickup lens 14 more suitably.

The total wavefront aberration (rms) in the range of the angle of view of 0.3° of the pickup lens 14 according to the example 1 is the smallest among the pickup lens 14 according to the examples 1 to 3. The pickup lens 14 according to the example 1 is different from the pickup lens 14 according to the examples 2 and 3 in that the steps are formed in such a way that the lens thickness of the pickup lens 14 gradually becomes thinner in the range from the first ring zone to the center ring zone, and the lens thickness of the pickup lens 14 gradually becomes thicker in the range from the center ring zone to the outermost ring zone. Thus, by forming the steps in such a way that the lens thickness of the pickup lens 14 is the thinnest at the center radius position, it is possible to reduce the total wavefront aberration (rms) at off-axis of the pickup lens 14 further suitably.

Further, the pickup lens 14 according to the example 4 is different from the pickup lens 14 according to the examples 5 and 6 in that the steps are formed in such a way that the lens thickness of the pickup lens 14 gradually becomes thinner in the range from the first ring zone to the center ring zone, and the lens thickness of the pickup lens 14 gradually becomes thicker in the range from the center ring zone to the outermost ring zone. Thus, by forming the steps in such a way that the lens thickness of the pickup lens 14 is the thinnest at the center radius position, it is possible to suppress the total wavefront aberration (rms) at off-axis of the pickup lens 14 to be equal to or smaller than 35 mλ. Particularly, in the example 4, the tangential angle θ_{M} is not equal to or larger than 73°, the absolute value of COMA5 in the range of the angle of view of 0.3° is not equal to or smaller than 0.010λrms, and the absolute value of the offense against sine condition is not equal to or smaller than 0.01. However, by forming the steps in such a way that the lens thickness of the pickup lens 14 is the thinnest at the center radius position, it is possible to suppress the total wavefront aberration (rms) at off-axis of the pickup lens 14 to be equal to or smaller than 35 mλ.

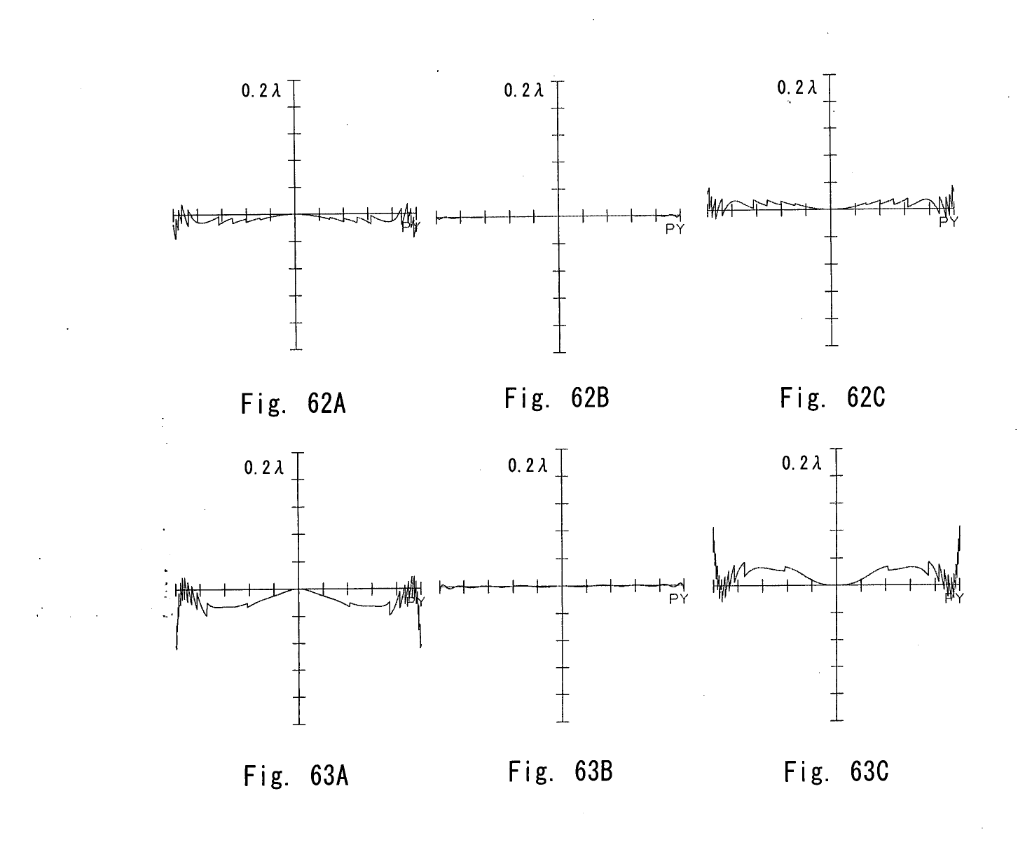

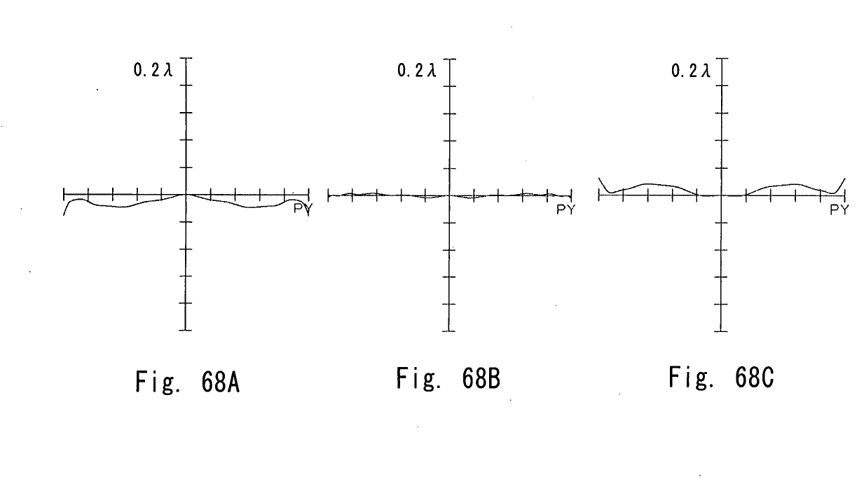

The on-axis characteristics of the pickup lens 14 according to the examples 1 to 6 are described hereinafter. The graphs of FIGS. 62 to 67 show the wavefront aberration indicating the on-axis characteristics according to the examples 1 to 6. The graph of FIG. 68 shows the wavefront aberration indicating the on-axis characteristics according to the comparative example 1. The ambient temperature is 35° C.

FIGS. 62A, 63A, . . . and 67A show the wavefront aberration that occurs when focusing laser light on the position (the recording layer) with a transparent substrate thickness of 0.075 mm by the pickup lens 14. FIGS. 62B, 63B, . . . and 67B show the wavefront aberration that occurs when focusing laser light on the position with a transparent substrate thickness of 0.0875 mm by the pickup lens 14. FIGS. 62C, 63C, . . . and 67C show the wavefront aberration that occurs when focusing laser light on the position (the recording layer) with a transparent substrate thickness of 0.100 mm by the pickup lens 14. FIGS. 68A, 68B and 68C show the wavefront aberration that occurs when focusing laser light on the positions with a transparent substrate thickness of 0.075 mm, 0.0875 mm and 0.100 mm, respectively, by the pickup lens according to the comparative example 1.

In FIGS. 62A to 68C, the spherical aberration that occurs based on a difference in transparent substrate thickness when focusing laser light on each position is corrected by shifting the collimator lens 13 along the optical axis. The correction by shifting the collimator lens 13 along the optical axis means adjusting the degree of divergence of the laser light to be incident on the pickup lens 14. This is equivalent to adjust a virtual light-emitting position (the position of an object point) of the laser light to be incident on the pickup lens 14 so that the laser light is input to the pickup lens 14 from the virtual light-emitting position without passing through the collimator lens 13. In other words, the spherical aberration is corrected by adjusting the object distance of the pickup lens 14 in FIGS. 62A to 68C.

The object distance when focusing laser light on the position with a transparent substrate thickness of 0.0875 mm by the pickup lens 14 according to the example 1 is infinite. This means that parallel light is incident on the pickup lens 14 by the collimator lens 13. The pickup lens 14 according to the embodiment is designed to suitably focus parallel light on the position with a transparent substrate thickness of 0.0875 mm.

FIG. 62B shows the wavefront aberration when focusing laser light on the position with a transparent substrate thickness of 0.0875 mm by the pickup lens 14 according to the example 1 at the above objective distance and defocusing amount. The total wavefront aberration (rms) is 0.6 mλ, and the laser light is suitably focused on the position with a transparent substrate thickness of 0.0875 mm by the pickup lens 14.

Further, SA5 (rms) when focusing laser light on the position with a transparent substrate thickness of 0.0875 mm by the pickup lens 14 according to the example 1 at the above objective distance and defocusing amount is 0.0 mλ, and the fifth-order spherical aberration does not substantially occur.

The object distance when focusing laser light on the recording layer with a transparent substrate thickness of 0.075 mm by the pickup lens 14 according to the example 1 is −311 mm. This means that convergent light is incident on the pickup lens 14 by the collimator lens 13. Specifically, the laser light to be incident on the pickup lens 14 is converted into convergent light by shifting the collimator lens 13 along the optical axis and further setting the defocusing amount to +1.569 μm. Thus, by adjusting the object distance of the pickup lens 14 and the inter-plane distance (working distance (WD)) between the surface (the plane number 3) of the pickup lens 14 facing the optical disc 15 and the surface (the object-side surface: the plane number 4) of the optical disc 15 facing the light source 11, the spherical aberration that occurs by a difference in transparent substrate thickness is corrected.

FIG. 62A shows the wavefront aberration when focusing laser light on the position with a transparent substrate thickness of 0.075 mm by the pickup lens 14 according to the example 1 at the above objective distance and defocusing amount. The total wavefront aberration (rms) is 6.7 mλ, and the laser light is suitably focused on the position with a transparent substrate thickness of 0.075 mm by the pickup lens 14.

Further, SA5 (rms) when focusing laser light on the position with a transparent substrate thickness of 0.075 mm by the pickup lens 14 according to the example 1 at the above objective distance and defocusing amount is 2.6 mλ, and the fifth-order spherical aberration is thus sufficiently reduced.

Likewise, the object distance when focusing laser light on the recording layer with a transparent substrate thickness of 0.100 mm by the pickup lens 14 according to the example 1 is +328 mm. This means that the laser light to be incident on the pickup lens 14 is converted into divergent light by shifting the collimator lens 13 along the optical axis and further setting the defocusing amount to −1.305 μm. The spherical aberration that occurs by a difference in transparent substrate thickness is thereby corrected.

FIG. 62C shows the wavefront aberration when focusing laser light on the position with a transparent substrate thickness of 0.100 mm by the pickup lens 14 according to the example 1 at the above objective distance and defocusing amount. The total wavefront aberration (rms) is 6.7 mλ, and the laser light is thus suitably focused on the position with a transparent substrate thickness of 0.100 mm by the pickup lens 14.

Further, SA5 (rms) when focusing laser light on the position with a transparent substrate thickness of 0.100 mm by the pickup lens 14 according to the example 1 at the above objective distance and defocusing amount is −3.0 mλ, and the fifth-order spherical aberration is thus also sufficiently reduced.

For the same reason, the object distance when focusing laser light on the position with a transparent substrate thickness of 0.075 mm, 0.0875 mm and 0.100 mm by the pickup lens 14 according to the example 2 is −280 mm, infinite and +295 mm, respectively. Further, the defocusing amount when focusing laser light on the position with a transparent substrate thickness of 0.075 mm, 0.0875 mm and 0.100 mm by the pickup lens 14 according to the example 2 is +1.046 μm, about 0 μm and −1.305 μm, respectively.

FIGS. 63A, 63B and 63C show the wavefront aberration when focusing laser light on the position with a transparent substrate thickness of 0.075 mm, 0.0875 mm and 0.100 mm, respectively, by the pickup lens 14 according to the example 2 at the above objective distance and defocusing amount. Further, the total wavefront aberration (rms) shown in FIGS. 63A, 63B and 63C is 3.0 mλ, 1.3 mλ and 14.7 mλ, respectively, and the laser light is thus suitably focused on the position with a transparent substrate thickness of 0.075 mm, 0.0875 mm and 0.100 mm by the pickup lens 14 according to the example 2.

Further, SA5 (rms) when focusing laser light on the position with a transparent substrate thickness of 0.075 mm, 0.0875 mm and 0.100 mm by the pickup lens 14 according to the example 2 at the above objective distance and defocusing amount is 7.1 mλ, 0.1 mλ and −8.6 mλ, respectively, and the fifth-order spherical aberration is thus also sufficiently reduced.

Further, the object distance when focusing laser light on the position with a transparent substrate thickness of 0.075 mm, 0.0875 mm and 0.100 mm by the pickup lens 14 according to the example 3 is −333 mm, infinite and +341 mm, respectively. Further, the defocusing amount when focusing laser light on the position with a transparent substrate thickness of 0.075 mm, 0.0875 mm and 0.100 mm by the pickup lens 14 according to the example 3 is +1.954 μm, about 0 μm and −2.056 μm, respectively.

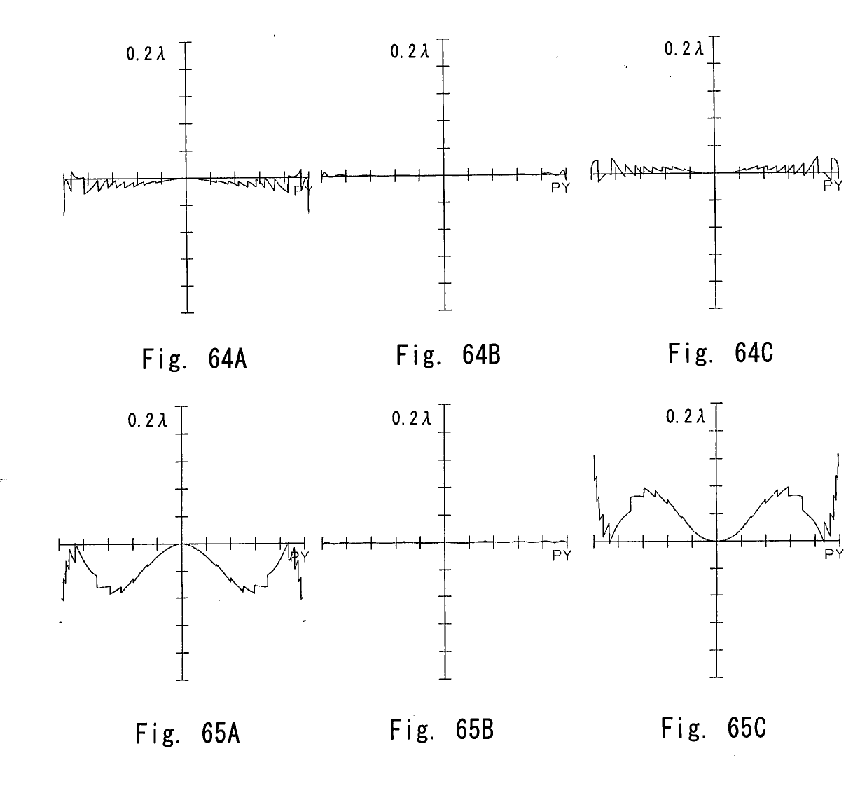

FIGS. 64A, 64B and 64C show the wavefront aberration when focusing laser light on the position with a transparent substrate thickness of 0.075 mm, 0.0875 mm and 0.100 mm by the pickup lens 14 according to the example 3 at the above objective distance and defocusing amount. Further, the total wavefront aberration (rms) shown in FIGS. 64A, 64B and 64C is 7.5 mλ, 1.5 mλ and 7.9 mλ, respectively, and the laser light is thus suitably focused on the position with a transparent substrate thickness of 0.075 mm, 0.0875 mm and 0.100 mm by the pickup lens 14 according to the example 3.

Further, SA5 (rms) when focusing laser light on the position with a transparent substrate thickness of 0.075 mm, 0.0875 mm and 0.100 mm by the pickup lens 14 according to the example 3 at the above objective distance and defocusing amount is 1.8 mλ, 0.2 mλ and −1.9 mλ, respectively, and the fifth-order spherical aberration is thus also sufficiently reduced.

Further, the object distance when focusing laser light on the position with a transparent substrate thickness of 0.075 mm, 0.0875 mm and 0.100 mm by the pickup lens 14 according to the example 4 is −254 mm, infinite and +270 mm, respectively. Further, the defocusing amount when focusing laser light on the position with a transparent substrate thickness of 0.075 mm, 0.0875 mm and 0.100 mm by the pickup lens 14 according to the example 4 is +0.583 μm, about 0 μm and −0.908 μm, respectively.

FIGS. 65A, 65B and 65C show the wavefront aberration when focusing laser light on the position with a transparent substrate thickness of 0.075 mm, 0.0875 mm and 0.100 mm by the pickup lens 14 according to the example 4 at the above objective distance and defocusing amount. Further, the total wavefront aberration (rms) shown in FIGS. 65A, 65B and 65C is 26.2 mλ, 0.8 mλ and 25.8 mλ, respectively, and the laser light is thus suitably focused on the position with a transparent substrate thickness of 0.0875 mm by the pickup lens 14 according to the example 4. However, in the pickup lens 14 according to the example 4, the total wavefront aberration (rms) when focusing laser light on the position with a transparent substrate thickness of 0.075 mm and 0.100 mm is larger than that when focusing laser light on the position with a transparent substrate thickness of 0.0875 mm, although it is still within the range of the Marechal Criterion.

Further, SA5 (rms) when focusing laser light on the position with a transparent substrate thickness of 0.075 mm, 0.0875 mm and 0.100 mm by the pickup lens 14 according to the example 4 at the above objective distance and defocusing amount is 24.8 mλ, 0.1 mλ and −24.4 mλ, respectively. Thus, the fifth-order spherical aberration when focusing laser light on the position with a transparent substrate thickness of 0.0875 mm by the pickup lens 14 according to the example 4 is sufficiently reduced. However, the fifth-order spherical aberration when focusing laser light on the position with a transparent substrate thickness of 0.075 mm and 0.100 mm by the pickup lens 14 according to the example 4 is larger than that when focusing laser light on the position with a transparent substrate thickness of 0.0875 mm, although it is still within the range of the Marechal Criterion. The increase in the total wavefront aberration (rms) when focusing laser light on the position with a transparent substrate thickness of 0.075 mm and 0.100 mm by the pickup lens 14 according to the example 4 is caused by the increase in SA5.

Further, the object distance when focusing laser light on the position with a transparent substrate thickness of 0.075 mm, 0.0875 mm and 0.100 mm by the pickup lens 14 according to the example 5 is −203 mm, infinite and +211 mm, respectively. Further, the defocusing amount when focusing laser light on the position with a transparent substrate thickness of 0.075 mm, 0.0875 mm and 0.100 mm by the pickup lens 14 according to the example 5 is −1.277 μm, about 0 μm and +0.652 μm, respectively.

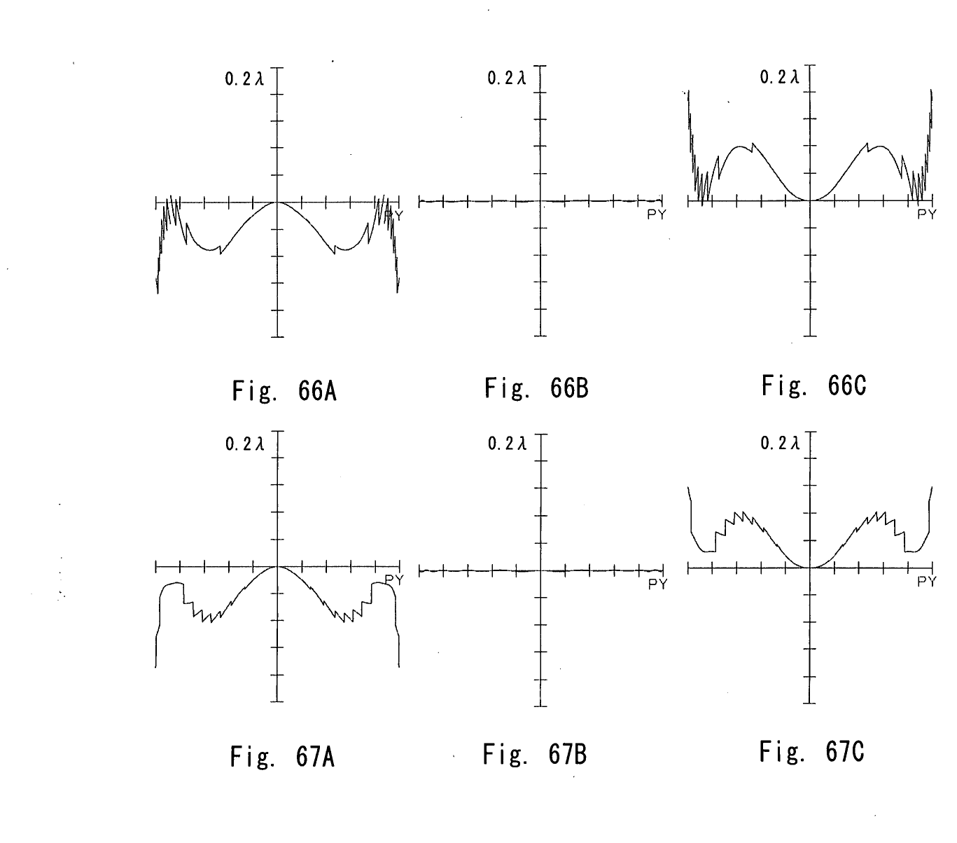

FIGS. 66A, 66B and 66C show the wavefront aberration when focusing laser light on the position with a transparent substrate thickness of 0.075 mm, 0.0875 mm and 0.100 mm by the pickup lens 14 according to the example 5 at the above objective distance and defocusing amount. Further, the total wavefront aberration (rms) shown in FIGS. 66A, 66B and 66C is 29.8 mλ, 0.9 mλ and 27.9 mλ, respectively, and the laser light is thus suitably focused on the position with a transparent substrate thickness of 0.0875 mm by the pickup lens 14 according to the example 5. However, in the pickup lens 14 according to the example 5, the total wavefront aberration (rms) when focusing laser light on the position with a transparent substrate thickness of 0.075 mm and 0.100 mm is larger than that when focusing laser light on the position with a transparent substrate thickness of 0.0875 mm, although it is still within the range of the Marechal Criterion.

Further, SA5 (rms) when focusing laser light on the position with a transparent substrate thickness of 0.075 mm, 0.0875 mm and 0.100 mm by the pickup lens 14 according to the example 5 at the above objective distance and defocusing amount is 27.1 mλ, 0.1 mλ and −25.4 mλ, respectively. Thus, the fifth-order spherical aberration when focusing laser light on the position with a transparent substrate thickness of 0.0875 mm by the pickup lens 14 according to the example 5 is sufficiently reduced. However, the fifth-order spherical aberration when focusing laser light on the position with a transparent substrate thickness of 0.075 mm and 0.100 mm by the pickup lens 14 according to the example 5 is larger than that when focusing laser light on the position with a transparent substrate thickness of 0.0875 mm, although it is still within the range of the Marechal Criterion. The increase in the total wavefront aberration (rms) when focusing laser light on the position with a transparent substrate thickness of 0.075 mm and 0.100 mm by the pickup lens 14 according to the example 5 is caused by the increase in SA5.

Further, the object distance when focusing laser light on the position with a transparent substrate thickness of 0.075 mm, 0.0875 mm and 0.100 mm by the pickup lens 14 according to the example 6 is −289 mm, infinite and +299 mm, respectively. Further, the defocusing amount when focusing laser light on the position with a transparent substrate thickness of 0.075 mm, 0.0875 mm and 0.100 mm by the pickup lens 14 according to the example 6 is +1.513 μm, about 0 μm and −1.654 μm, respectively.

FIGS. 67A, 67B and 67C show the wavefront aberration when focusing laser light on the position with a transparent substrate thickness of 0.075 mm, 0.0875 mm and 0.100 mm by the pickup lens 14 according to the example 6 at the above objective distance and defocusing amount. Further, the total wavefront aberration (rms) shown in FIGS. 67A, 67B and 67C is 23.5 mλ, 0.8 mλ and 25.3 mλ, respectively, and the laser light is thus suitably focused on the position with a transparent substrate thickness of 0.0875 mm by the pickup lens 14 according to the example 6. However, in the pickup lens 14 according to the example 6, the total wavefront aberration (rms) when focusing laser light on the position with a transparent substrate thickness of 0.075 mm and 0.100 mm is larger than that when focusing laser light on the position with a transparent substrate thickness of 0.0875 mm, although it is still within the range of the Marechal Criterion.

Further, SA5 (rms) when focusing laser light on the position with a transparent substrate thickness of 0.075 mm, 0.0875 mm and 0.100 mm by the pickup lens 14 according to the example 6 at the above objective distance and defocusing amount is 22.3 mλ, 0.0 mλ and −23.5 mλ, respectively. Thus, the fifth-order spherical aberration when focusing laser light on the position with a transparent substrate thickness of 0.0875 mm by the pickup lens 14 according to the example 6 does not substantially occur. However, the fifth-order spherical aberration when focusing laser light on the position with a transparent substrate thickness of 0.075 mm and 0.100 mm by the pickup lens 14 according to the example 6 is larger than that when focusing laser light on the position with a transparent substrate thickness of 0.0875 mm, although it is still within the range of the Marechal Criterion. The increase in the total wavefront aberration (rms) when focusing laser light on the position with a transparent substrate thickness of 0.075 mm and 0.100 mm by the pickup lens 14 according to the example 6 is caused by the increase in SA5.

Further, the object distance when focusing laser light on the position with a transparent substrate thickness of 0.075 mm, 0.0875 mm and 0.100 mm by the pickup lens according to the comparative example 1 is −314 mm, infinite and +322 mm, respectively. Further, the defocusing amount when focusing laser light on the position with a transparent substrate thickness of 0.075 mm, 0.0875 mm and 0.100 mm by the pickup lens according to the comparative example 1 is +1.625 μm, about 0 μm and −1.739 μm, respectively.

FIGS. 68A, 68B and 68C show the wavefront aberration when focusing laser light on the position with a transparent substrate thickness of 0.075 mm, 0.0875 mm and 0.100 mm by the pickup lens according to the comparative example 1 at the above objective distance and defocusing amount. Further, the total wavefront aberration (rms) shown in FIGS. 68A, 68B and 68C are 5.3 mλ, 1.5 mλ and 4.8 mλ, respectively, and the laser light is thus suitably focused on the position with a transparent substrate thickness of 0.075 mm, 0.0875 mm and 0.100 mm by the pickup lens according to the comparative example 1.

Further, SA5 (rms) when focusing laser light on the position with a transparent substrate thickness of 0.075 mm, 0.0875 mm and 0.100 mm by the pickup lens according to the comparative example 1 at the above objective distance and defocusing amount is 5.1 mλ, 0.1 mλ and −4.5 mλ, respectively, and the fifth-order spherical aberration is thus also sufficiently reduced.

The comparison between the pickup lens 14 according to the examples 4 to 6 and the pickup lens according to the comparative example 1 shows that the on-axis characteristics when focusing light on the respective recording surfaces of the multilayer optical disc 15 are deteriorated if the above-described plurality of ring zones are formed on at least one surface of the pickup lens 14. However, the on-axis characteristics are not deteriorated in the pickup lens 14 according to the examples 1 to 3 despite that it has a plurality of ring zones on the surface facing the light source 11. As shown in FIG. 48, the pickup lens 14 according to the examples 1 to 3 is different from the pickup lens 14 according to the examples 4 and 5 in that the tangential angle θ_{M} is equal to or larger than 73°. Further, the pickup lens 14 according to the examples 1 to 3 is different from the pickup lens 14 according to the examples 4 to 6 in that the absolute value of COMA5 in the range of the angle of view of 0.3° is equal to or smaller than 0.010λrms. Furthermore, as shown in FIG. 55, the pickup lens 14 according to the examples 1 to 3 is different from the pickup lens 14 according to the examples 4 to 6 in that the absolute value of the offense against sine condition is equal to or smaller than 0.01. Therefore, by forming the ring zones in such a way that the tangential angle θ_{M} is equal to or larger than 73°, the absolute value of COMA5 in the range of the angle of view of 0.3° is equal to or smaller than 0.010λrms, and the absolute value of the offense against sine condition is equal to or smaller than 0.01, it is possible to suppress an increase in the total wavefront aberration, which is an increase in the fifth-order spherical aberration, when focusing laser light on the position with a transparent substrate thickness of 0.075 mm and 0.100 mm. Specifically, by forming the ring zones in such a way that the tangential angle θ_{M} is equal to or larger than 73°, the absolute value of COMA5 in the range of the angle of view of 0.3° is equal to or smaller than 0.010λrms, and the absolute value of the offense against sine condition is equal to or smaller than 0.01, it is possible to suppress the absolute value of SA5 when focusing laser light on the position with a transparent substrate thickness of 0.075 mm and 0.100 mm to be equal to or smaller than 0.010 rms.

In other words, by satisfying the expression (5) to (7), SA5 is not deteriorated even when the third-order spherical aberration that occurs based on a difference in substrate thickness between the recording layers of the multilayer optical disc 15 is corrected in the case of focusing the light beam emitted from the laser light source on the multilayer optical disc 15 using the pickup lens 14. It is thereby possible to suppress the deterioration of the on-axis characteristics when focusing light on the respective recording layers of the multilayer optical disc 15.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical pickup objective lens made of plastic for focusing light beam emitted from a laser light source on a Blu-ray disc (BD), wherein
the optical pickup objective lens includes a plurality of ring zones on at least one surface,
a plurality of steps are formed respectively between the plurality of ring zones,
the plurality of steps have step differences causing incident light to have a phase difference to reduce aberration occurring in the optical pickup objective lens due to a change in ambient temperature, and
if a numerical aperture of the optical pickup objective lens is NA, a focal length is f (mm), a working distance is WD (mm) and fifth-order spherical aberration is SA5 (λrms), when focusing light beam emitted from the laser light source on a multilayer optical disc by the optical pickup objective lens, following expressions (1) to (3) are satisfied upon correcting third-order spherical aberration occurring based on a difference in substrate thickness between recording layers of the multilayer optical disc:
NA≧0.85 (1)
1.1≦f≦1.8 (2), and
WD≧0.3 (3).

2. The optical pickup objective lens according to claim 1, wherein
if fifth-order spherical aberration of the optical pickup objective lens is SA5 (λrms), when focusing light beam emitted from the laser light source on a multilayer optical disc by the optical pickup objective lens, following expression (4) is satisfied upon correcting third-order spherical aberration occurring based on a difference in substrate thickness between recording layers of the multilayer optical disc:

|SA5|≦0.020 (4).

3. The optical pickup objective lens according to claim 2, wherein
if a tangential angle at a portion where a marginal ray is incident is θ_{M}(°), a lens minimum thickness at a portion where a marginal ray is incident is t_{M}(mm) and a refractive index of the optical pickup objective lens is N, following expressions (5) to (7) are satisfied:
73≦θ_{M}≦75 (5)
1.5≦N≦1.55 (6), and
t_{M}≧0.35 (7).

4. The optical pickup objective lens according to claim 3, wherein
if fifth-order coma aberration is COMA5, an absolute value of COMA5 at an angle view of 0.3° is equal to or smaller than 0.025λrms.

5. The optical pickup objective lens according to claim 3, wherein
an absolute value of an offense against sine condition at all beam heights is equal to or smaller than 0.01.

6. The optical pickup objective lens according to claim 2, wherein
if the number of the ring zones formed on the optical pickup objective lens is n (n is a positive integer satisfying n≧3),
the steps are formed in such a way that a lens thickness of the optical pickup objective lens gradually decreases in a range of the first to the i-th (i=2, 3, . . . , n−1) ring zones from an optical axis of the optical pickup objective lens and a lens thickness of the optical pickup objective lens gradually increases in a range of the (i+1)th (i+1=3, 4, . . . , n) to the n-th ring zones from the optical axis of the optical pickup objective lens.

7. The optical pickup objective lens according to claim 1, wherein
a design wavelength of the optical pickup objective lens is equal to or shorter than 500 nm.

8. The optical pickup objective lens according to claim 2, wherein
a design wavelength of the optical pickup objective lens is equal to or shorter than 500 nm.

9. The optical pickup objective lens according to claim 1, wherein
the steps have step differences, where a phase of incident light is different between the ring zones at approximately an integral multiple of a wavelength, causing light beam to have a phase difference to reduce aberration occurring in the optical pickup objective lens due to a change in ambient temperature.

10. The optical pickup objective lens according to claim 2, wherein
the steps have step differences, where a phase of incident light is different between the ring zones at approximately an integral multiple of a wavelength, causing light beam to have a phase difference to reduce aberration occurring in the optical pickup objective lens due to a change in ambient temperature.

11. The optical pickup objective lens according to claim 1, wherein
if an adjacent step difference of the steps is d (mm), a wavelength is λ (mm) and a refractive index of the optical pickup objective lens is N, following expression (8) is satisfied:
4≦(N−1)*d/λ≦28 (8).

12. The optical pickup objective lens according to claim 2, wherein
if an adjacent step difference of the steps is d (mm), a wavelength is λ (mm) and a refractive index of the optical pickup objective lens is N, following expression (8) is satisfied:
4≦(N−1)*d/λ≦28 (8).

13. The optical pickup objective lens according to claim 1, wherein
if an on-axis step difference of the steps is d₀ (mm), a wavelength is λ (mm) and a refractive index of the optical pickup objective lens is N, following expression (9) is satisfied:
4≦(N−1)*d₀/λ≦14 (9).

14. The optical pickup objective lens according to claim 2, wherein
if an on-axis step difference of the steps is d₀ (mm), a wavelength is λ (mm) and a refractive index of the optical pickup objective lens is N, following expression (9) is satisfied:
4≦(N−1)*d₀/λ≦14 (9).

15. The optical pickup objective lens according to claim 2, wherein
if an adjacent step difference of the steps is d (mm), a difference between a maximum value and a minimum value of a cumulative value Σd of the adjacent step difference is equal to or larger than 60λ and equal to or smaller than 180λ.

16. The optical pickup objective lens according to claim 2, wherein
if an on-axis step difference of the steps is d₀ (mm), a difference between a maximum value and a minimum value of a cumulative value Σd₀ of the on-axis step difference is equal to or larger than 30λ and equal to or smaller than 120λ.

17. The optical pickup objective lens according to claim 2, wherein
if an adjacent step difference of the steps is d (mm), a difference between a maximum value and a minimum value of a cumulative value Σd of the adjacent step difference is equal to or larger than 70λ and equal to or smaller than 180λ.

18. The optical pickup objective lens according to claim 2, wherein
if an on-axis step difference of the steps is d₀ (mm), a difference between a maximum value and a minimum value of a cumulative value Σd₀ of the on-axis step difference is equal to or larger than 40λ and equal to or smaller than 120λ.

19. The optical pickup objective lens according to claim 1, wherein
if the number of the ring zones formed on the optical pickup objective lens is n (n is a positive integer),
when n is an even number, the steps are formed in such a way that a lens thickness of the optical pickup objective lens gradually decreases in a range of the 1st to the (n/2)th ring zones from an optical axis of the optical pickup objective lens and a lens thickness of the optical pickup objective lens gradually increases in a range of the ((n/2)+1)th to the n-th ring zones from the optical axis of the optical pickup objective lens, and
when n is an odd number, the steps are formed in such a way that a lens thickness of the optical pickup objective lens gradually decreases in a range of the 1st to the ((n+1)/2)th ring zones from the optical axis of the optical pickup objective lens and a lens thickness of the optical pickup objective lens gradually increases in a range of the ((n+1)/2)th to the n-th ring zones from the optical axis of the optical pickup objective lens.

20. The optical pickup objective lens according to claim 1, wherein
if an adjacent step difference of the steps is d (mm), a difference between a maximum value and a minimum value of a cumulative value Σd of the adjacent step difference is equal to or larger than 60λ and equal to or smaller than 90λ.

21. The optical pickup objective lens according to claim 1, wherein
if an on-axis step difference of the steps is d₀ (mm), a difference between a maximum value and a minimum value of a cumulative value Σd₀ of the on-axis step difference is equal to or larger than 30λ and equal to or smaller than 60λ.

22. The optical pickup objective lens according to claim 1, wherein
if an adjacent step difference of the steps is d (mm), a difference between a maximum value and a minimum value of a cumulative value Σd of the adjacent step difference is equal to or larger than 70λ and equal to or smaller than 90λ.

23. The optical pickup objective lens according to claim 1, wherein
if an on-axis step difference of the steps is d₀ (mm), a difference between a maximum value and a minimum value of a cumulative value Σd₀ of the on-axis step difference is equal to or larger than 40λ and equal to or smaller than 60λ.

24. An optical pickup apparatus comprising the optical pickup objective lens according to claim 2.

25. An optical disc apparatus comprising the optical pickup objective lens according to claim 2.
